(19) United States
(12) Patent Application Publication
(10) Pub. No.: US 2008/0145058 A1
(43) Pub. Date: Jun. 19, 2008

(54) COMMUNICATIONS DEVICE, COMMUNICATIONS METHOD, AND COMMUNICATIONS CIRCUIT

(76) Inventors: Fumihiro FUKAE, Sakurai-shi (JP); Hitoshi Naoe, Kitakatsuragi-gun (JP); Koji Sakai, Osaka (JP); Takashi Nakajima, Tsu-shi (JP); Kenji Mameda, Kashihara-shi (JP)

Correspondence Address: BIRCH STEWART KOLASCH & BIRCH, PO BOX 747, FALLS CHURCH, VA, 22040-0747, US

(21) Appl. No.: 11/944,096

(22) Filed: Nov. 21, 2007

(30) Foreign Application Priority Data
Nov. 29, 2006 (JP) 2006-322634

(51) Int. Cl. H04B 10/00

(52) U.S. Cl. 398/118

(57) ABSTRACT

A communications device includes: an IrDA frame detecting section 202, an IrSimple frame detecting section 201, and a transfer rate control section 230. The IrDA frame detecting section 202 detects a first predetermined frame based on pulses detected in an incoming response signal at first predetermined intervals. The IrSimple frame detecting section 201 detects a second predetermined frame based on pulses detected in the incoming response signal at second predetermined intervals. The transfer rate control section 230 determines that the transfer rate of the response is equal to the first transfer rate if the IrDA frame detecting section 202 detects the first predetermined frame and determines that the transfer rate of the response is equal to the second transfer rate if the IrSimple frame detecting section 201 detects the second predetermined frame.

This nonprovisional application claims priority under 35 U.S.C. § 119(a) on Patent Application No. 2006-322634 filed in Japan on Nov. 29, 2006, the entire contents of which are hereby incorporated by reference.

### FIELD OF THE INVENTION

The present invention relates to communications devices, communications methods, and communications circuits used for data transmission/reception.

### BACKGROUND OF THE INVENTION

### IrDA

Infrared communications schemes provide an interface between mobile phones, PDAs (personal digital assistants), digital cameras, laptop PCs (personal computers), printers, scanners, and other varieties of like devices. IrDA-D1.1 (Infrared Data Association-Data Ver. 1.1; hereinafter “IrDA®”) is an example of such a scheme. See non-patent documents 1 to 5.

IrDA and like infrared communications schemes are directional; if there is an obstacle between the communications devices, data cannot be transferred. With a line of sight between the devices, however, a high speed data transfer is possible. IrDA standards include Very Fast IR (VFIR) with a maximum transfer rate of 16 Mbps, Fast IR (FIR) with a maximum transfer rate of 4 Mbps, and Serial IR (SIR) with a transfer rate of up to 115.2 (inclusive of 115.2 kbps). Currently available IrDA standards on the market are those with a maximum transfer rate of up to 4 Mbps.

An IrDA connection routine for the IrLAP layer will be described in reference to FIG. 36. FIG. 36 shows a signal sequence for the establishment of an IrLAP layer connection as specified by IrDA.

A primary station, or device, is a station which initiates a discovery of an opposite station, that is, which requests an establishment of a data transfer state, by sending a connect request command (for example, an XID (exchange station identification) command). A secondary station, or device, is a station which receives the request. For example, IrDA specifies that it is the secondary station which sends an XID response to an XID command. A request or instruction transmitted from the primary to the secondary is termed a command. A reply to the command, transmitted the other way from the secondary to the primary, is termed a response. In addition, the opposite station is one of the stations involved in communications as seen from another station. In other words, the opposite station to the primary station is the secondary station, whilst the opposite station to the secondary station is the primary station.

The XID command is a command with which to discover a secondary station candidate within the communications range of the primary station. In FIG. 36, the numbers in parentheses are SlotNumbers in hexadecimal notation. The SlotNumbers indicate the transmission sequence of commands.

Upon receiving an XID command, the secondary station returns an XID response, informing the primary station of its presence. The primary station transmits a specified number of XID commands. The primary station then sets the SlotNumber of the last XID command to 0xFF, a number indicating that the command is the last one (XID-End).

The primary station forwards, in an SNRM (set normal response mode) command, its maximum transfer rate, maximum incoming data length, and other necessary parameters for communications to the secondary station. Receiving the command, the secondary station compares the parameters to its own settings and informs the primary station of acceptable settings in a UA response.

After establishing an IrLAP connection using IrLAP command frames, IrLMP, TinyTP, and OBEX connections are negotiated using IrLAP data frames.

An IrLMP connect request is forwarded in an IrLAP data frame from the primary station to the secondary station. An IrLMP connect response is returned in an IrLAP data frame from the secondary station to the primary station, establishing an IrLMP connection.

Next, a TinyTP connect request is forwarded to the secondary station in an IrLAP data frame. A TinyTP connect response is returned from the secondary station to the primary station in an IrLAP data frame, establishing a TinyTP connection.

Furthermore, an OBEX connect request is forwarded in an IrLAP data frame from the primary station to the secondary station. An OBEX connect response is returned in an IrLAP data frame from the secondary station to the primary station, establishing an OBEX connection. That renders the stations ready for user data transfer.

For disconnection, an OBEX disconnect request and response, a TinyTP disconnect request and response, and an IrLMP disconnect request and response are exchanged in IrLAP data frames. A DISC command (IrLAP disconnect request command frame) and a UA response (response command frame) are then exchanged. The exchanges disconnect the primary station from the secondary station.

The IrDA connection routine above takes an extended period of time before the stations are ready for user data transfer, lowering transfer efficiency. Specifically, IrDA specifies that station discovery through sensing and using XID commands, and negotiation parameter exchange using an SNRM command and a UA response are needed before the establishing of a connection. IrDA stipulates that the transfer rate be limited to 9,600 bps during the XID-based station discovery. The rate is far lower than the user data transfer rate (4 Mbps). In addition, as mentioned above, after the IrLAP layer has been connected, the IrLMP, TinyTP, and OBEX layers need to be sequentially connected so that the stations are ready for data transfer.

Transferring a large volume of data generally takes an extended period of time. The communications devices need to be kept connected over that amount of time. However, a stable connection is difficult to maintain over an extended period of time in infrared communications. For example, the connection is dropped if the line of sight between the communications devices is obstructed. IrDA provides that once the connection is dropped, the layer connections be established at as slow a rate as 9,600 bps before data transfer becomes possible. That leads to a conclusion that with a need for a large overhead for data transfer, IrDA is not suitable for efficiently transmitting/receiving a large volume of data.

### IrSimple

IrSimple® specifications were standardized in 2005 to address these problems. See non-patent documents 6 to 8 and patent document 1. The IrSimple standard was aimed at improving on convenience in infrared communications. It is a set of communications protocols which reduce the time taken to establish a connection to achieve high efficiency in communications, from the issuing of a connect request to disconnecting. IrSimple developed from IrDA with improvements in some functionality and partially compatible with IrDA. IrSimple involves no communications in relation to station discovery, taking less time to establish a connection than conventional IrDA. IrSimple reduces communications time by a factor of 4 to 10 over conventional IrDA for the same volume of data.

IrSimple provides for two communications modes: unidirectional communications and bi-directional communications. In unidirectional communications, the connect and disconnection routines are so simplified as to be complete in one frame, in other words, to reduce connect and disconnect times. The retransmission routine upon error detection in data transfer is also simplified to achieve high transfer rates.

An IrSimple connection routine for the IrLAP layer in unidirectional communications will be described in reference to FIG. 37. FIG. 37 shows an IrSimple-compliant signal sequence for the establishment of an IrLAP layer connection in unidirectional communications. As shown in FIG. 37, a primary station sends an SNRM command (connect request command) without sending an XID command with which to confirm the presence of a secondary station. That completes the establishing of a connection. The primary station, having sent the SNRM command, starts a data transfer without waiting for a UA response (response command frame) from the secondary station. Meanwhile, having received the SNRM command, the secondary station waits for the data transfer from the primary station without returning a UA response. If the incoming SNRM command includes no data for upper layers, the secondary station may dismiss it as an illegal connect request and not enter a data transfer standby state.

Next, an IrSimple connection routine for the IrLAP layer in bi-directional communications will be described in reference to FIG. 38. FIG. 38 shows an IrSimple-compliant signal sequence for the establishment of an IrLAP layer connection in bi-directional communications.

As shown in FIG. 38, a primary station sends an SNRM command (connect request command) without sending an XID command with which to confirm the presence of a secondary station. Having received the SNRM command, the secondary station sends a UA response (response command frame). As the primary station receives the UA response, the connecting of the IrLAP, IrLMP, IrSMP, and OBEX layers are all completed. In other words, the IrLMP, IrSMP, and OBEX layers do not need to be sequentially connected after the IrLAP layer is connected. After the connections, data exchange is carried out using the QoS (Quality of Service) parameters agreed upon through the exchange of the SNRM command and the UA response.

The SNRM command and the UA response are transmitted at 9,600 bps and 115.2 kbps respectively. Therefore, the primary station waits for the UA response, ready to inbound frames at 115.2 kbps after transmitting the SNRM command specified in the IrSimple protocols.

Now, the SNRM command specified in the IrSimple protocols will be described in reference to FIG. 39 which illustrates a frame containing the SNRM command.

The A (address) field is used to negotiate a connection and contains a 7-bit connection address and a 1-bit C/k (Command/Response) identifier. In FIG. 38 where a pre-connection SNRM command is shown, the connection address is 0x7F, indicating a broadcast address. The C/R bit is 1, indicating a command frame. The A field in the SNRM command in FIG. 38, a combination of the address and the C/R bit, is 0xFF.

The C (control) field is the control field for the frame, indicating the format type of the frame. Since the frame is an SNRM command, the C field is either 0x93 for bi-directional communications or 0x83 for unidirectional communications, both indicating an SNRM frame in unnumbered format (U format). The C field assumes one of the values depending on whether to pass the right to transmit. FIG. 38 shows a sequence in bi-directional communications; the C field is 0x93.

The source device address field indicates the address of the source device (primary station) and assumes a value other than 0 and 0xFFFFFFFF.

The destination device address field indicates the address of the destination device (secondary station). In FIG. 38 where a pre-connection SNRM command is shown, the destination device address is equal to 0xFFFFFFFF, indicating a broadcast address.

The connection device address contains a new 7-bit connection address used after successfully establishing a connection and a 1-bit C/R bit which is always set to 0. The connection address is set to any value by the primary station.

The requested-QoS parameters field indicates QoS parameter values, including the transfer rate and a maximum turnaround time supported by the primary station.

The upper user data field was set forth for the first time in IrSimple to describe the data used by the layers above the IrLAP layer, including IrSMP parameters and a connect command (OBEX connect request).

Next, a UA response specified in the IrSimple protocols will be described in reference to FIG. 40 which illustrates a UA response frame.

The A (address) field contains the 7-bit address specified in the connection device address field of the corresponding SNRM command. The A field also contains a 1-bit C/R bit which is set to 0, indicating a response frame.

The C (control) field is 0x73, an indication of a UA response in unnumbered format (U format), because this is a UA response frame.

The source device address is the 32-bit address determined by the secondary station and assumes a value other than 0 and 0xFFFFFFFF.

The destination device address field indicates the address of the destination device (primary station) which is equal to the address of the primary station communicated in the source device address field of the corresponding SNRM command frame.

The returned-QoS parameters field contains QoS parameters determined from the requested-QoS parameters given by the primary station and the QoS parameters of the secondary station.

The upper user data field was set forth for the first time in IrSimple to describe the data used by the layers above the IrLAP layer, including IrSMP (upper layer) parameters and a success response to the OBEX connect request.

Since IrSimple and IrDA have the same physical layer, those communications devices which strictly adhere to both the IrDA and IrSimple protocol specifics is capable of automatically identifying the protocols from the response from the secondary station and switching to them in an attempt to connect to another communications device (secondary station). See non-patent document 6. In other words, the communications devices connect to the secondary station using the IrDA protocols when the secondary station responds to the IrDA protocols and connect to the secondary station using IrSimple bi-directional communications when the secondary station responds to IrSimple bi-directional communications.

Next will be described how the communications device switches between IrSimple and IrDA in reference to FIG. 41 which shows a signal sequence followed when the communications device switches between IrSimple/IrDA.

The primary station attempts to connect to the secondary station by repeating the routine (1) to (3) described below. The SNRM command and the XID command below are transmitted at 9,600 bps.

(1) The primary station attempts to connect using the IrSimple protocols, or specifically, transmits an SNRM command as specified in the IrSimple protocols. The primary station then waits for a response from the secondary station at 115.2 kbps.

(2) If the secondary station does not respond, the primary station transmits an XID command (SlotNumber 0x00) to discover the secondary station. The primary station then waits for a response from the secondary station at 9,600 bps.

(3) If the secondary station does not respond, the primary station terminates the station discovery by transmitting an XID-End command and makes another attempt to connect by transmitting an SNRM command. The primary station then waits for a response from the secondary station at 115.2 kbps.

The secondary station receives the frames issued in the order of (1) to (3). If the secondary station determines that any of the received frames is a legal frame specified in the protocols supported by the secondary station, the secondary station responds to that frame.

More specifically, if the secondary station strictly adheres to the IrSimple protocol specifics, it returns a UA response to the SNRM command issued in either (1) or (3). If the secondary station strictly adheres to the IrDA protocol specifics, it returns an XID response to the XID command issued in (2). In addition, the IrSimple protocols stipulate that the secondary station return no XID response frame unless it receives two XID command (SlotNumber 0x00)s (see non-patent document 6). Accordingly, if the secondary station strictly adheres to both the IrSimple and IrDA protocol specifics, it returns no XID response even when it has failed to receive the SNRM frame issued in (1) and received the XID frame issued in (2) for the first time. The secondary station returns a UA response to the IrSimple SNRM command issued next in (3).

The SNRM commands issued in (1) and (3) have the frame format shown in FIG. 39.

Next will be described an IrDA XID command in reference to FIG. 42 which illustrates a frame containing the XID command issued in (2).

The A field is the same as the one described above; its value is 0xFF.

The C field is the same as the one described above; its value is 0x3F, indicating an XID command frame.

The format identifier field is an extension identifier, typically equal to 0x01.

The source device address field is the same as the one described above.

The destination device address field is the same as the one described above.

The discovery flags field indicates the number of slots of an XID command (the number of opposite stations simultaneously searched for). In the example in FIG. 41, the XID command has 1 slot; the discovery flags field contains a value 0x00.

The slot number field indicates the current slot number. The numbers are assigned sequentially. The slot number of the first XID command frame in FIG. 41 is 0x00. For the XID-End command frame which is the last XID command frame, the slot number is 0xFF, indicating a last XID command frame.

The version number field indicates the version number of IrLAP. For version 1.1, the version number is 0x00.

The discovery information field is appended only to the XID-End command frame which is the last command and contains any information obtained in the station discovery, including station information such as the device name of the primary station.

### Signal Sequence Followed when Secondary Station Strictly Adhering to IrSimple Bi-Directional Communications Connects to Primary Station Strictly Adhering to Both IrDA And IrSimple Protocol Specifics

The signal sequence followed when the secondary station strictly adhering to IrSimple bi-directional communications connects to the particular primary station above strictly adhering to both the IrDA and IrSimple protocol specifics is the same as the one shown in FIG. 38. More specifically, the primary station sends an SNRM command (connect request command) without sending an XID command with which to confirm the presence of the secondary station. Having received the SNRM command, the secondary station sends a UA response (response command frame). As the primary station receives the UA response, the connecting of the IrLAP, IrLMP, IrSMP, and OBEX layers are all completed. After the connections, data exchange is carried out using the QoS parameters agreed upon through the exchange of the SNRM command and the UA response.

The SNRM command and the UA response are transmitted at 9,600 bps and 115.2 kbps respectively. Therefore, the primary station waits for the UA response, ready to inbound frames at 115.2 kbps, after transmitting the SNRM command.

### Signal Sequence Followed when Secondary Station Strictly Adhering Only to IrDA Protocol Specifics Connects to Primary Station Strictly Adhering to Both IrDA and IrSimple Protocol Specifics

Next will be described a connection routine for a communications device which strictly adheres to both the IrDA and IrSimple protocol specifics and another communications device which strictly adheres only to the IrDA protocol specifics in reference to FIG. 43. FIG. 43 shows a signal sequence followed when the primary station strictly adhering to both the IrDA and IrSimple protocol specifics connects to the secondary station strictly adhering only to the IrDA protocol specifics.

As shown in FIG. 43, the primary station transmits an SNRM command (connect request). The secondary station however does not respond to this frame for the following reason. A frame in which both the A field and the destination device address field contain a broadcast address (hereinafter, a “broadcast frame”) is not a legal frame specified in the IrDA protocols. IrDA stipulates that a device return no response to such an illegal frame. See non-patent document 1.

The SNRM command issued by the primary station in FIG. 43 is a broadcast frame; the secondary station, strictly adhering to the IrDA protocol specifics, does not respond to the SNRM command.

Receiving no response to the SNRM command issued, the primary station switches to the IrDA protocols to negotiate a connection and transmits an XID (0x00) command (IrDA station discovery frame). The secondary station responds to the XID (0x00) command by sending an XID response, informing the primary station of its presence.

An IrDA XID response will be described in reference to FIG. 44 which illustrates the format of an XID response frame.

The A field is the same as the one described above. The C/R bit is 0, indicating a response frame. The A field, a combination of the address and the C/R bit, is 0xFE.

The C field is the same as the one described above; its value is 0xBF, indicating an XID response frame.

The format identifier field is the same as the one described above; its value is 0x01.

The source device address field indicates the address of the source device (secondary station) and assumes a value other than 0 and 0xFFFFFFFF.

The destination device address field indicates the address of the destination device (primary station). In the current case, the destination device address is equal to the address of the primary station communicated in the source device address field of the XID command frame.

The discovery flags field is the same as the one described above and contains the same value as the discovery flags field in the XID command frame. For example, if the discovery flags of the XID command frame are 0x00, the discovery flags of the XID response are also 0x00.

The slot number field is the same as the one described above and contains the same value as the slot number field in the corresponding XID command frame. For example, if the slot number of the XID command is 0x00, the response has a slot number 0x00.

The version number field is the same as the one described above.

The discovery information field is the same as the one described above and contains, for example, station information such as the device name of the secondary station.

After receiving the XID response, the primary station transmits an XID-End command, thereby terminating the station discovery.

Next, the primary station transmits an SNRM command (IrDA connect request). An IrDA SNRM command will be described in reference to FIG. 45 which illustrates the format of an SNRM command frame.

The frame has a very similar format to the one shown in FIG. 39. Its destination device address however has the same value as the source device address in the XID response frame during the station discovery. No upper user data is contained.

In the SNRM command, neither the A field nor the destination device address field contains a broadcast address; the secondary station receives the SNRM command as a legal frame specified in the IrDA protocols and transmits a UA response.

An IrDA UA response will be described in reference to FIG. 46 which illustrates the format of an IrDA UA response frame. The frame has a very similar format to the one shown in FIG. 40. However, no upper user data is contained.

The primary station receives the UA response, thereby successfully establishing an IrLAP layer connection. Following the establishing, the layers above the IrLAP layer are connected using the QoS parameters agreed upon through the exchange of the SNRM command and the UA response.

The XID command frame, XID response frame, SNRM command frame, and UA response frame are all transmitted at 9,600 bps in the station discovery and connecting using the IrDA protocols. Therefore, after transmitting an XID command frame or an SNRM command frame, the primary station waits for an XID response frame or a UA response frame, ready to inbound frames at 9,600 bps.

### Transfer Format for Physical Layer in IrDA SIR

Next, a transfer format for the physical layer in IrDA SIR will be described in reference to FIGS. 47(a) and 47(b) which illustrate an exemplary transfer format for the physical layer in IrDA SIR. The frames discussed above are transmitted at either 9,600 bps or 115.2 kbps in the following format.

In SIR, data is transmitted by a UART (universal asynchronous receiver transmitter). A 1-bit start bit is prefixed to every one byte of outbound data to indicate the start of that piece of outbound data. The start bit is 0. Also, a 1-bit stop bit is suffixed to the piece of outbound data to indicate its end. The stop bit is 1. FIG. 47(a) shows an example of a UART frame in which the bit string, 01100101, will be transmitted. In actuality, the data is transmitted starting with the last bit. Thus, the sequence actually transmitted is 10100110. With the start bit 0 prefixed and the stop bit 1 suffixed to the outbound data, the UART frame is 0101001101.

Each bit of the UART frame is inverted using RZ coding and output on pulses. Specifically, a pulse is output for a 0 bit in the UART frame, and no pulse is output for a 1 bit. FIG. 47(b) shows an example of an inverted UART frame obtained from FIG. 47(a). In the UART frame 0101001101, the first, third, fifth, sixth, and ninth bits are 1 and output as pulses.

### Pulse Width Tolerance

Next will be described acceptable pulse widths in reference to FIG. 48 which shows an acceptable minimum value, an acceptable maximum value, and a typical value of pulse width for each transfer rate. For example, at 9,600 bps, the acceptable minimum pulse width, the typical pulse width, and the acceptable maximum pulse width are specified to be 1.41 μs (microseconds), 19.53 μs, and 22.13 μs respectively.

### Frame Format in IrDA SIR

Next will be described the format of an IrDA SIR frame in reference to FIG. 49 which illustrates the format of an IrDA SIR frame.

The Additional_BOF (additional beginning of frame) field is prefixed to the beginning if necessary. The recommended value is 0xFF. See non-patent document 1. Two or more successive Additional_BOF fields may be prefixed.

The BOF (beginning of frame) field indicates the beginning of the frame. Its value is 0xC0 for SIR.

The IrLAP data field contains payload data for the IrLAP layer: for example, the SNRM command frame and the UA response frame.

The FCS (frame check sequence) field is provided for error detection. It is a 16-bit CRC (cyclic redundancy check) in SIR.

The EOF (end of frame) field indicates the end of the frame. Its value is 0xC1 for SIR.

### Conversion to UART Signals

Next will be described a conversion from a pulsed wave to a UART frame at the receiving end in reference to FIGS. 50(a) to 50(c) which illustrate how the SIR receiver circuit and the UART receiver circuit converts an inbound pulsed wave to a UART frame.

As mentioned earlier, the physical layer in IrDA SIR has a UART format. The SIR receiver circuit first broadens the received pulses (FIG. 50(a)) to a width corresponding to a predetermined transfer rate (about 19.53 μs at 9,600 bps; see FIG. 50(b)). The circuit then inverts the pulses (FIG. 50(c)). Next, the UART receiver circuit detects start bits to sample at predetermined intervals (about 19.53 μs at 9,600 bps). Finally, the circuit verifies that the stop bits are 1.

### Method for Automatic Identification of 9,600-bps Frames and 115.2-kbps Frames

Non-patent document 5 describes a method whereby the primary station automatic identifies response frames transferred at 9,600 bps and those transferred at 115.2 kbps from the secondary station and receives them at either rate (hereinafter, “automatic transfer rate detection method”). The method will be described in the following in reference to FIG. 51 which illustrates the method.

In the automatic transfer rate detection method, a frame is received first at 115.2 kbps. However, if the frame turns out to have been transmitted at 9,600 bps while the frame is being received at 115.2 kbps, a switching occurs so that the frame can be received at 9,600 bps. A 9,600-bps frame generally has 10 successive Additional_BOF fields added to its head. Suppose that all the Additional_BOF fields are 0xFF as recommended by non-patent document 5. Each Additional_BOF is sent in the format shown in FIG. 47. The first bit is a start bit prefix containing 0. That is followed by the outbound data 0xFF and a stop bit suffix containing 1. Thus, the Additional_BOF contains a bit string 0111111111 when transmitted. Each bit is inverted to 1000000000 which provides the frame actually transmitted. Therefore, only the first bit is output as pulsed light in this case.

Now, a comparison will be made between bit transfer intervals at 9,600 bps and the transfer interval for 10 bits at 115.2 kbps in reference to FIG. 52 which illustrates the comparison. FIG. 52 depicts an outbound 9,600-bps bit string 1000000000 and the same bit string as recognized when it is received at 115.2 kbps.

The transfer interval is about 100 μs at the 9,600-bps transfer rate. That translates into the 1 in the first bit of the Additional_BOF (1000000000) being separated from the 0 in the second bit by about 100 μs. At the 115.2-kbps transfer rate, the transfer interval for 10 bits is about 86.8 μs. Therefore, the interval between the 1 in the first bit and the 0 in the second bit of the Additional_BOF is greater than the interval for 10 bits (that is, the outbound data plus the start bit and the stop bit) at 115.2 kbps. For these reasons, if the 1 in the first bit of the Additional_BOF for a transfer at 9,600 bps is received at 115.2 kbps, the 1 is interpreted as the bit string 0xFF having been received.

In the automatic transfer rate detection method, if the bit string (interpreted as) 0xFF is received seven times successively, they are interpreted as the Additional BOF fields of a 9,600-bps frame being received. See non-patent document 5. Starting with the eighth Additional_BOF field and onwards, the frame is received at 9,600 bps. The switching enables detection of a subsequent BOF (0xC0).

With the Additional_BOF fields being set to 0xFF as above, the response frames transferred at 9,600 bps and those transferred at 115.2 kbps can be automatically identified and received by the automatic transfer rate detection method.
[Non-patent document 1] Infrared Data Association Serial Infrared Link Access Protocol (IrLAP) Version 1.1 (Jun. 16, 1996)
[Non-patent document 2] Infrared Data Association Serial Infrared Link Management Protocol (IrLMP) Version 1.1 (Jan. 23, 1996)
[Non-patent document 3] Infrared Data Association ‘Tiny TP’: A Flow-Control Mechanism for use with IrLMP Version 1.1 (Oct. 20, 1996)
[Non-patent document 4] Infrared Data Association Object Exchange Protocol Version 1.3 (Jan. 3, 2003)
[Non-patent document 5] Infrared Data Association IrLAP Fast Connect (Application Note) Version 1.0 (Nov. 27, 2002)
[Non-patent document 6] IrDA Serial Infrared Link Access Protocol Specification for IrSimple Addition Version 1.0 (Oct. 14, 2005)
[Non-patent document 7] IrDA Serial Infrared Link Management Protocol Specification for IrSimple Addition Version 1.0 (Oct. 14, 2005)
[Non-patent document 8] IrDA Serial Infrared Sequence Management Protocol for IrSimple Version 1.0 (Oct. 14, 2005)
[Non-patent document 9] Infrared Data Association Serial Infrared Physical Layer Specification Version 1.4 (May 30, 2001)
[Patent document 1] International Application Published under PCT WO2006/080330 (published Aug. 3, 2006)

As described above, the communications device which strictly adheres to both the IrDA and IrSimple protocol specifics is capable of connecting to and communicating with a secondary station which strictly adheres to either the IrDA or IrSimple protocol specifics.

Nevertheless, some communications devices do not strictly adhere to the IrDA protocol specifics; they return an IrDA UA response when they receive a broadcast frame. Such a device will be hereinafter referred to as an illegal response sender device. The communications device which strictly adheres to both the IrDA and IrSimple protocol specifics cannot communicate with the illegal response sender device.

### Exemplary Signal Sequence in Unsuccessful Connection Attempt; Primary Station which Strictly Adheres to Both IrDA and IrSimple Protocol Specifics Fails to Connect to Secondary Station which is Illegal Response Sender Device

Referring to FIG. 53, the following will describe how a communications device which strictly adheres to both the IrDA and IrSimple protocol specifics fails in an attempt to connect to an illegal response sender device. FIG. 53 shows a signal sequence followed when a primary station, or a communications device which strictly adheres to both the IrDA and IrSimple protocol specifics, attempts to connect to another station, or an illegal response sender device.

As depicted in FIG. 38, the primary station first sends an SNRM command (IrSimple connect request) and then waits for a UA response from the secondary station at 115.2 kbps.

The A field and the destination device address field of the SNRM command both contain a broadcast address. Again as described earlier, secondary stations which strictly adhere to the IrDA protocol specifics regard the SNRM command as a broadcast frame and do not return a UA response. The illegal response sender device however recognizes the SNRM command as an IrDA SNRM frame in the violation of the protocols and returns an IrDA UA response at 9,600 bps.

Meanwhile, the primary station is waiting for an IrSimple UA response frame at 115.2 kbps; it fails to detect the IrDA UA response transmitted at 9,600 bps. Due to lack of a response from the secondary station, the primary station transmits an XID command at 9,600 bps as shown in FIG. 41.

The secondary station completed its part of the connection routine when it sent the UA response. It is waiting for a next frame (i.e., a connect request frame from the layer above the IrLAP layer) at the negotiated rate. The secondary station therefore cannot detect the XID command transmitted by the primary station at 9,600 bps and continues to wait for a frame.

Due to lack of response to the XID command, the primary station transmits another SNRM command (IrSimple connect request) as shown in FIG. 41, to which the secondary station cannot respond because it is still waiting for a connect request frame from the layer above the IrLAP layer.

Hence, neither the primary station nor the secondary station can receive a frame from the opposite station. In due course, a timeout occurs in the stations. The connection attempt thus fails and terminates.

That explains how the communications device which strictly adheres to both the IrDA and IrSimple protocol specifics may fail to communicate with the illegal response sender device.

### Exemplary Signal Sequence in Successful Connection Attempt; Primary Station which Strictly Adheres Only to IrDA Protocol Specifics Successfully Connects to Secondary Station which is Illegal Response Sender Device

Note that the Primary Stations which Strictly Adhere only to the IrDA protocol specifics can connect to the secondary station which is an illegal response sender device. Referring to FIG. 54, the following will describe how a communications device which strictly adheres only to the IrDA protocol specifics connects to an illegal response sender device. FIG. 54 shows a signal sequence followed when a primary station, or a communications device which strictly adheres only to the IrDA protocol specifics, attempts to connect to another device, or an illegal response sender device.

As depicted in FIG. 36, the primary station first sends an IrDA XID command and then waits for an XID response from the secondary station at 9,600 bps. The secondary station returns an XID response at 9,600 bps, which wraps up the station discovery routine. Next, receiving the XID response from the secondary station, the primary station sends an SNRM command (IrDA connect request command) to initiate a connection routine. IrDA differs from IrSimple where the former stipulates that after transmitting an SNRM command, the primary wait for a response from the secondary at 9,600 bps, not at 115.2 kbps. Since the secondary station returns a UA response to the SNRM command at 9,600 bps, the primary station can receive the UA response. That successfully establishes a connection up to the IrLAP layer. Following the establishing, the layers above the IrLAP layer are connected using the QoS parameters agreed upon through the exchange of the SNRM command and the UA response.

As described in the foregoing, the communications device which strictly adheres only to the IrDA protocol specifics can communicate with the illegal response sender device. In contrast, the communications device which strictly adheres to both the IrDA and IrSimple protocol specifics cannot communicate with the illegal response sender device because that communications device, after transmitting the SNRM command specified in the IrSimple protocols, waits for an IrSimple UA response frame at 115.2 kbps, whereas the illegal response sender device returns an IrDA UA response at 9,600 bps.

### Automatic Transfer Rate Detection Method Fails to Establish Legal Communications; an Example

As described above, the primary station which strictly adheres to both the IrDA and IrSimple protocol specifics fails to receive the 9,600-bps UA response because it is waiting for a 115.2-kbps UA response from the secondary station. The problem may be addressed by the automatic transfer rate detection method illustrated in FIG. 51 whereby the primary station automatically identifies the response frames transferred at 9,600 bps and those transferred at 115.2 kbps from the secondary station and receives them at either rate. If the Additional_BOF is 0xFF, as described in reference to FIG. 51, the automatic transfer rate detection method is capable of automatically discriminating between the 9,600-bps UA response and the 115.2-kbps UA response and receiving the incoming UA response correctly. However, it is nothing more than a recommendation to set the Additional_BOF to 0xFF. See non-patent document 1. Many communications devices currently available on the market transmit a frame with the Additional_BOF being set otherwise. The automatic transfer rate detection method may fail to correctly detect the 9,600-bps BOF if the Additional_BOF is set to a value other than 0xFF.

Referring to FIG. 55, an example will be described of the method failing to correctly detect a 9,600-bps BOF. FIG. 55 illustrates the automatic transfer rate detection method of non-patent document 5 failing to correctly detect a BOF transferred at 9,600 bps. In the example in FIG. 55, an Additional_BOF (0x00), a BOF (0xC0), and IrLAP data (0x01) are sequentially transmitted at 9,600 bps.

As illustrated in FIG. 52, the transfer interval between each bit at 9,600 bps is greater than the transfer interval for 10 bits at 115.2 kbps. Therefore, if a receiving-end device receives at 115.2 kbps an Additional_BOF (0x00) which was transmitted at 9,600 bps, it interprets each pulse as a bit string 0xFF. Since seven successive pulses are transmitted in this case, the device considers that it has received the bit string 0xFF seven times in a row. Therefore, according to the automatic transfer rate detection method, the device determines, upon receiving the seventh bit of the first Additional_BOF, that it is receiving 9,600-bps frames. From that moment on, the device receives frames at 9,600 bps. For example, to receive and sample data at 9,600 bps from the pulse corresponding to the ninth bit of the Additional_BOF, the device interprets the eighth bit of the incoming BOF as a bit string 1011111110, that is, 0x01. Thus, the device fails to recognize the incoming BOF. Therefore, the device fails to correctly detect the starts of frames, much less to correctly recognize the data that follows.

As discussed here, with the automatic transfer rate detection method being implemented, the primary station may still fail to correctly recognize incoming data if the Additional_BOF transmitted from the secondary station at 9,600 bps is not 0xFF. As a result, the primary station sometimes cannot normally communicate with the illegal response sender device.

There are also other situations where the same problem can occur in a communications system which supports a plurality of communications protocols. The problem, put in more general terms, may be defined as follows: A communications device strictly adheres to both a first protocol and a second protocol which specify different transfer rates for a response from a secondary station. That particular device first transmits a connect request command using the second protocol. Another communications device (secondary station) which supports only the first protocol returns a response to the request using the first protocol by mistake. The secondary station does so at a different transfer rate from the one which the primary station is expecting. The two devices thus fail to establish a connection.

### SUMMARY OF THE INVENTION

The present invention, conceived to address the problems, has an objective of providing a communications device, communications method, and communications circuit which automatically identifies the transfer rate of an incoming signal. It has another objective of providing a communications device capable of communicating with a communications device which supports one of two sets of communications protocols and which returns a response compliant with that one of protocol sets when it receives a connect request command compliant with another one of the protocol sets. It is also part of the objective to provide an associated communications method, and communications circuit.

To achieve the objective, the communications device in accordance with the present invention is characterized in that it includes: first pulse detecting means for detecting a pulse in an incoming signal at a first interval which is associated with a first transfer rate; first transfer rate detecting means for detecting a first predetermined frame based on the pulses detected by the first pulse detecting means; second pulse detecting means for detecting a pulse in the incoming signal at a second interval which is associated with a second transfer rate that is different from the first transfer rate; second transfer rate detecting means for detecting a second predetermined frame based on the pulses detected by the second pulse detecting means; and transfer rate identifying means for determining that the incoming signal has a transfer rate equal to the first transfer rate if the first transfer rate detecting means detects a first predetermined frame and that the incoming signal has a transfer rate equal to the second transfer rate if the second transfer rate detecting means detects a second predetermined frame.

The communications method in accordance with the present invention is characterized in that includes: the first pulse detecting step of detecting a pulse in an incoming signal at a first interval which is associated with a first transfer rate; the first transfer rate detecting step of detecting a first predetermined frame based on the pulses detected in the first pulse detecting step; the second pulse detecting step of detecting a pulse in the incoming signal at a second interval which is associated with a second transfer rate that is different from the first transfer rate; the second transfer rate detecting step of detecting a second predetermined frame based on the pulses detected in the second pulse detecting step; and the transfer rate identifying step of determining that the incoming signal has a transfer rate equal to the first transfer rate if the first transfer rate detecting step detects a first predetermined frame and that the incoming signal has a transfer rate equal to the second transfer rate if the second transfer rate detecting step detects a second predetermined frame.

According to the configurations above, the device/method simultaneously waits for a signal transmitted at the first transfer rate from the opposite station and a signal transmitted at the second transfer rate from the opposite station so that the signal from the opposite station can be received at no matter which transfer rate (first or second) the signal is transmitted. The device/method detects pulses from the received signal at both the transfer rates to try to detect a predetermined frame from the detected pulses.

If the first predetermined frame is detected, the incoming signal is determined to have been transmitted at the first transfer rate. In contrast, if the second predetermined frame is detected, the incoming signal is determined to have been transmitted at the second transfer rate.

Even when the first transfer rate differs from the second transfer rate, the transfer rate of the incoming signal can be reliably identified at no matter which transfer rate (first or second) the incoming signal was transmitted.

Therefore, the communications device/method can reliably identify the transfer rate of a signal transmitted from the opposite station.

The communications device may be implemented on a computer. When this is the case, the present invention encompasses the communications device control program which realizes the communications device on a computer by operating the computer as each of the means and also encompasses the computer-readable storage medium containing the program.

The communications device may be implemented by a communications circuit which functions as each of said means.

The present invention is applicable to a wide range of communications devices, in particular, those with optical space communications functionality, for example, mobile wireless communications devices including laptop PCs, PDAs, mobile phones, and digital cameras.

Additional objects, advantages and novel features of the invention will be set forth in part in the description which follows, and in part will become apparent to those skilled in the art upon examination of the following or may be learned by practice of the invention.

### BRIEF DESCRIPTION OF THE DRAWINGS

FIG. 1 is a block diagram illustrating the configuration of the major part of a communications device which is an embodiment of the present invention.

FIG. 2 is a block diagram illustrating the configuration of the major part of a communications system using a communications device which is an embodiment of the present invention.

FIG. 3 is a block diagram illustrating the configuration of the major part of a communications protocol analyzing section in a communications device which is an embodiment of the present invention.

FIG. 4 is a flow chart illustrating a process of a communications device which is an embodiment of the present invention switching between connection routines in accordance with a response from the secondary station.

FIG. 5 is a diagram showing a signal sequence followed when a communications device which is an embodiment of the present invention connects to a communications device which returns an IrDA UA response upon receiving a broadcast frame due to lack of strict adherence to the IrDA protocol specifics.

FIG. 6 is a block diagram illustrating the configuration of the major part of a communications system using a communications device which is an embodiment of the present invention.

FIG. 7 is a block diagram illustrating the configuration of the major part of a communications device which is an embodiment of the present invention.

FIG. 8 is a block diagram illustrating the configuration of the major part of a communications protocol analyzing section in a communications device which is an embodiment of the present invention.

FIG. 9 is a block diagram illustrating the configuration of the major part of a communications system using a communications device which is an embodiment of the present invention.

FIG. 10 is a block diagram illustrating the configuration of the major part of a communications device which is an embodiment of the present invention.

FIG. 11 is a block diagram illustrating the configuration of the major part of a communications protocol analyzing section in a communications device which is an embodiment of the present invention.

FIG. 12 is a block diagram illustrating the configuration of the major part of a communications system using a communications device which is an embodiment of the present invention.

FIG. 13 is a block diagram illustrating the configuration of the major part of a communications device which is an embodiment of the present invention.

FIG. 14 is a block diagram illustrating the configuration of the major part of a communications protocol analyzing section in a communications device which is an embodiment of the present invention.

FIG. 15 is a block diagram illustrating the configuration of the major part of a pulse detecting section in a communications device which is an embodiment of the present invention.

FIG. 16 is a timing chart illustrating a pulse detecting section in a communications device which is an embodiment of the present invention detecting a pulse in each slot.

FIG. 17 is a block diagram illustrating the configuration of the major part of a communications system using a communications device which is an embodiment of the present invention.

FIG. 18 is a block diagram illustrating the configuration of the major part of a communications device which is an embodiment of the present invention.

FIG. 19 is a block diagram illustrating the configuration of the major part of a communications protocol analyzing section in a communications device which is an embodiment of the present invention.

FIG. 20 is a block diagram illustrating the configuration of the major part of a pulse detecting section in a communications device which is an embodiment of the present invention.

FIG. 21 is a block diagram illustrating the configuration of the major part of a short pulse removing section in a communications device which is an embodiment of the present invention.

FIG. 22 is a timing chart illustrating a short pulse removing section in a communications device which is an embodiment of the present invention removing short pulses (less than 1.2 μs).

FIG. 23 is a timing chart illustrating an IrDA frame detecting section in a communications device which is an embodiment of the present invention receiving signals being transferred at 19,200 bps.

FIG. 24 is a block diagram illustrating the configuration of the major part of a communications system using a communications device which is an embodiment of the present invention.

FIG. 25 is a block diagram illustrating the configuration of the major part of a communications device which is an embodiment of the present invention.

FIG. 26 is a block diagram illustrating the configuration of the major part of a communications protocol analyzing section in a communications device which is an embodiment of the present invention.

FIG. 27 is a block diagram illustrating the configuration of the major part of a frequency detecting section in a communications device which is an embodiment of the present invention.

FIG. 28 is a timing chart illustrating a frequency detecting section in a communications device which is an embodiment of the present invention detecting reception at a higher frequency than the frequency given by an expected transfer rate when there are two pulses in each slot.

FIG. 29 illustrates an IrDA frame detecting section in a communications device which is an embodiment of the present invention receiving a signal being transferred at 115.2 kbps, but detecting a 9,600-bps BOF by error.

FIG. 30 is a block diagram illustrating the configuration of the major part of a communications system using a communications device which is an embodiment of the present invention.

FIG. 31 is a block diagram illustrating the configuration of the major part of a communications device which is an embodiment of the present invention.

FIG. 32 is a block diagram illustrating the configuration of the major part of a communications protocol analyzing section in a communications device which is an embodiment of the present invention.

FIG. 33 is a block diagram illustrating the configuration of the major part of a communications system using a communications device which is an embodiment of the present invention.

FIG. 34 is a block diagram illustrating the configuration of the major part of a communications device which is an embodiment of the present invention.

FIG. 35 is a block diagram illustrating the configuration of the major part of a communications protocol analyzing section in a communications device which is an embodiment of the present invention.

FIG. 36 is a signal sequence diagram for the establishment of an IrLAP layer connection using IrDA.

FIG. 37 is a signal sequence diagram for the establishment of an IrLAP layer connection in unidirectional communications using IrSimple.

FIG. 38 is a signal sequence diagram for the establishment of an IrLAP layer connection in bi-directional communications using IrSimple.

FIG. 39 illustrates the SNRM command format specified in the IrSimple protocols.

FIG. 40 illustrates the UA response format specified in the IrSimple protocols.

FIG. 41 is a diagram showing a signal sequence followed when a communications device which strictly adheres to both the IrDA and IrSimple protocol specifics switches between IrSimple and IrDA.

FIG. 42 illustrates the XID command format specified in the IrDA protocols.

FIG. 43 is a diagram showing a signal sequence followed when a communications device which strictly adheres to both the IrDA and IrSimple protocol specifics connects to a secondary station which strictly adheres only to the IrDA protocol specifics.

FIG. 44 illustrates the XID response format specified in the IrDA protocols.

FIG. 45 illustrates the SNRM command format specified in the IrDA protocols.

FIG. 46 illustrates the UA response format specified in the IrDA protocols.

FIG. 47(a) illustrates an example of a UART frame as a transfer format for the physical layer in IrDA SIR.

FIG. 47(b) illustrates an example of an inverted UART frame obtained from the UART frame shown in FIG. 47(a).

FIG. 48 lists an acceptable minimum value, an acceptable maximum value, and a typical value of pulse width for each transfer rate.

FIG. 49 illustrates an IrDA SIR frame.

FIG. 50(a) illustrates a pulsed wave received by an SIR receiver circuit.

FIG. 50(b) illustrates the inbound pulsed wave shown in FIG. 50(a) having been broadened to a width corresponding to a predetermined transfer rate.

FIG. 50(c) illustrates the broadened pulses (FIG. 50(b)) after they are inverted.

FIG. 51 illustrates a conventional method of automatically identifying and receiving response frames transferred at 9,600 bps and those transferred at 115.2 kbps.

FIG. 52 illustrates a comparison between bit transfer intervals at the 9,600-bps transfer rate and the transfer interval for 10 bits at the 115.2-kbps transfer rate.

FIG. 53 is a diagram showing a signal sequence followed when a communications device which strictly adheres to both the IrDA and IrSimple protocol specifics, as a primary station, attempts to connect to another communications device which returns an IrDA UA response to an IrSimple SNRM command.

FIG. 54 is a diagram showing a signal sequence followed when a communications device which strictly adheres only to the IrDA protocol specifics, as a primary station, attempts to connect to another communications device which returns an IrDA UA response to an IrSimple SNRM command.

FIG. 55 illustrates a problem with a method described in non-patent document 5. According to the method, a primary station automatically identifies response frames transferred at 9,600 bps and those transferred at 115.2 kbps from a secondary station and receives them at either rate. The primary however fails to correctly detect a BOF transferred at 9,600 bps.

### DESCRIPTION OF THE EMBODIMENTS

In concrete examples in the embodiments, the communications device will be described assuming that it is acting as a primary station. Needless to say, the communications device may act as a secondary station.

Again in concrete examples in the embodiments, the communications device will be described assuming that it decides on communications protocol by detecting the transfer rate of an incoming frame from a secondary station, to connect to the secondary station. Needless to say, this is not intended to limit the scope of the communications device in accordance with the present invention. Alternatively, the communications device may, for example, switch between different sets of protocols without being subjected to any external control on the transfer rate at which the device is expecting to receive a frame after having transmitted an SNRM command (115.2 kbps) and the transfer rate at which the device is expecting to receive a frame after having transmitted an XID command (9,600 bps) as illustrated in FIG. 41.

Again in concrete examples in the embodiments, the first protocol will be described assuming that it is IrDA, and the second protocol assuming that it is IrSimple. Needless to say, the first protocol is by no means limited to IrDA, nor the second protocol to IrSimple. The first and second protocols need only to be distinguishable by the frames transmitted using the individual protocols. Take, as an example, response frames transmitted from the secondary station to the primary station; the first and second protocols need only to specify different transfer rates for such responses. Alternatively, the protocols may specify different formats for the responses. A further alternative is for the protocols to include identifiably different data in the same frame format.

Again in concrete examples in the embodiments, the frame received by the communications device will be described assuming that it is a response (UA response) to a connect request command. Needless to say, the frame received by the communications device is by no means limited to a response (UA response); the frame may be a connect request command, as an example.

Again in concrete examples in the embodiments, the first predetermined frame will be described assuming that it is a BOF field, and the second predetermined frame assuming that it is an EOF field. Needless to say, the first predetermined frame is by no means limited to a BOF field, nor the second predetermined frame to an EOF field.

In the embodiments, the physical layer, the data link layer, the network layer, the transport layer, and the session & presentation layer may be denoted respectively by PHY, IrLAP, IrLMP, IrSMP, and OBEX.

### Embodiment 1

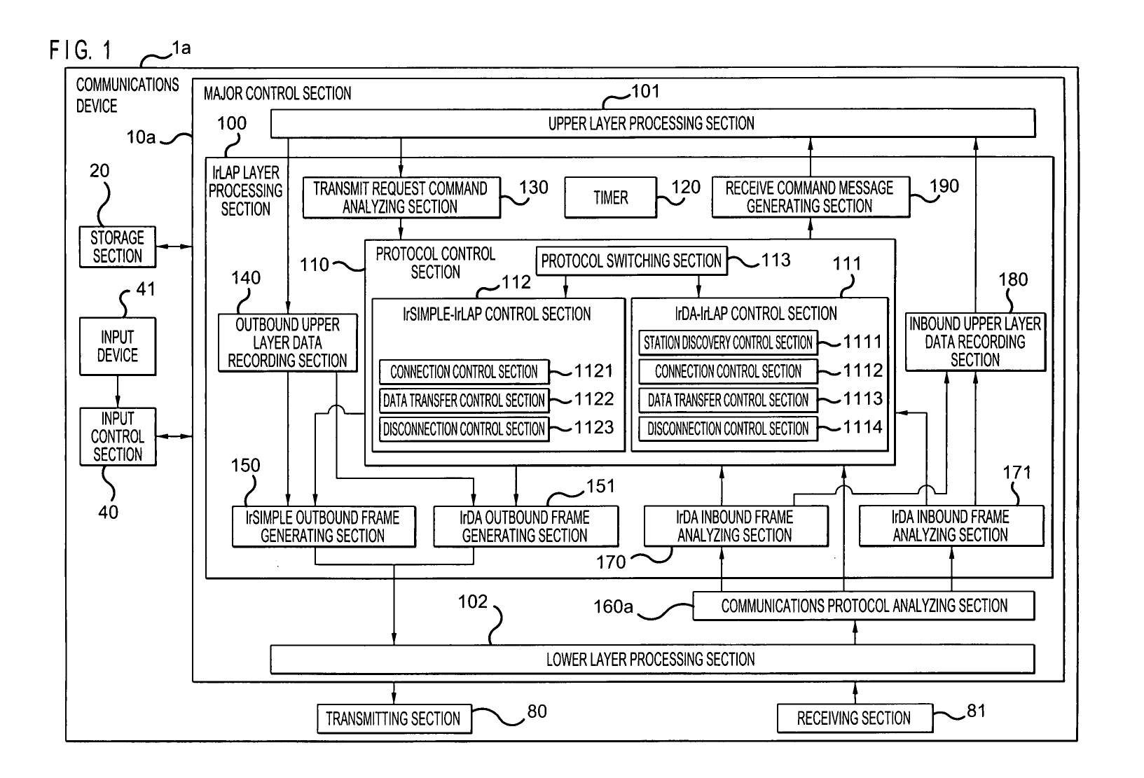

The following will describe a communications device in accordance with an embodiment of the present invention in reference to FIGS. 1 to 5.

### Overall Structure of Communications System

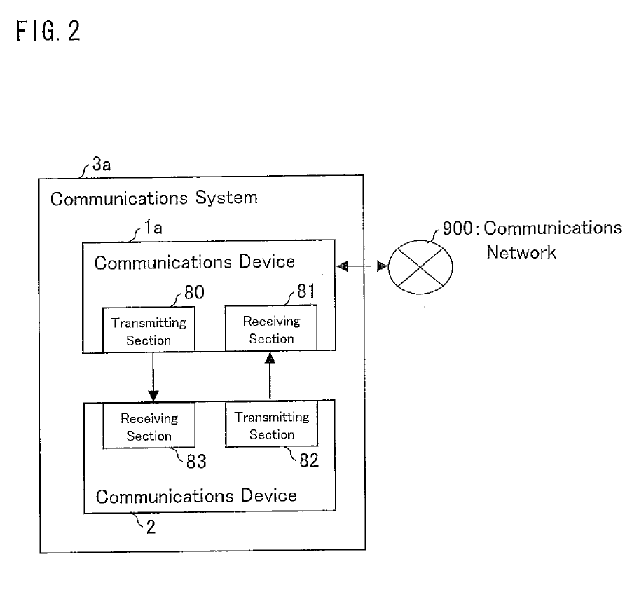

A communications system 3a of the present embodiment will be described in reference to FIG. 2 which is a block diagram illustrating the configuration of the communications system 3a. The system 3a includes a communications device 1a of the present embodiment and a communications device 2.

The communications device 1a may be, for example, a digital camera which transfers captured image data to the communications device 2 or the mobile phone which transfers email data, address book data, schedule note data, etc. to the communications device 2. The communications device 2 may be, for example, a television which produces an image display from data supplied from the communications device 1a or a PC (personal computer) which stores email data, address book data, schedule note data, etc. received from the communications device 1a.

The communications device 2 may fall in one of the four categories: It: (1) supports IrDA, but does not strictly adhere to the IrDA protocol specifics and therefore returns a UA response to a frame in which both the A field and the destination device address field contain a broadcast address (hereinafter, a “broadcast frame”); (2) strictly adheres only to the IrDA protocol specifics; (3) strictly adheres only to the IrSimple protocol specifics; or (4) strictly adheres to both the IrDA and IrSimple protocol specifics. The communications device in category 1 will be hereinafter called the illegal response sender device.

As illustrated in FIG. 2, the communications device 1a and the communications device 2 can communicate with each other by transferring data from a transmitting section 80 to a receiving section 83 and from a transmitting section 82 to a receiving section 81 by infrared wireless communications.

The transmitting sections 80, 82 are capable of external transmission of data by, for example, infrared wireless communications. When infrared is used as the communications medium, the transmitting sections 80, 82 are constructed based on an LED (light-emitting diode), an LD (laser diode), or other similar technology. Infrared was noted above as a wireless communications scheme, which is by no means limiting at all.

The receiving sections 81, 83 are capable of external reception of data by, for example, infrared wireless communications. When infrared is used as the communications medium, the receiving sections 81, 83 are constructed based on a PD (photo diode) or other similar technology. Infrared was noted above as a wireless communications scheme, which is by no means limiting at all.

The communications device 1a may be connected to a communications network 900 so that it can communicate with an external communications device (not shown) over the communications network 900. When this is the case, the communications device 1a can transmit/receive audio data, email data, image data, etc. to/from the external communications device (not shown).

The communications network 900 is not limited in any particular manner; it may be, for example, the Internet, an Intranet, an Extranet, an LAN, an ISDN, a VAN, a CATV network, a virtual private network, a telephone line network, a mobile communications network, or a satellite communications network. The communications network 900 may be provided based on any transfer medium: it may be wired (ex. an IEEE 1394 cable, a USB cable, an electric power line, a cable TV line, a telephone line, or an ADSL line) or wireless (ex. IrDA or otherwise specified infrared, Bluetooth®, 802.11 wireless, HDR, mobile radio, a satellite line, or a terrestrial digital network).

### Configuration of Communications Device

Next will be described the configuration of the communications device 1a in reference to FIG. 1 which is a block diagram illustrating the configuration of the communications device 1a of the present embodiment. The communications device 1a includes a major control section 10a, a storage section 20, an input control section 40, an input device 41, the transmitting section 80, and the receiving section 81 as shown in FIG. 1.

The major control section 10a controls the input control section 40, the transmitting section 80, and the receiving section 81. The major control section 10a implements the control and also performs predetermined computing, by executing computer programs stored in the storage section 20. The predetermined computing is, for example, the making of a connect request to another communications device. The major control section 10a is constructed of, for example, a memory (for example, RAM (random access memory); not shown) into which the programs are loaded from the storage section 20 and a CPU (central processing unit; not shown) which executes the programs loaded into the memory. The memory is, for example, a semiconductor memory and holds data, for instance, the data required in processing by the input control section 40, the transmitting section 80, the receiving section 81, and the CPU. The structure of the major control section 10a will be discussed later in more detail.

The storage section 20 stores, among other things, the computer programs executed by the CPU of the major control section 10a, the settings and input data used by the programs, the data derived in the execution of the programs, and the data to be transmitted to the communications device 2. The storage section 20 is a non-volatile memory, such as a ROM (read-only memory) or a flash memory. The storage section 20 also stores the data to be transmitted to another communications apparatus through the transmitting section 80. Some examples of such data are image data supplied from an image capturing device (not shown): email data, address book data, schedule note data, etc. fed from the input device 41; and email data and image data received by an email receiving section (not shown). The storage section 20 is not necessarily built in as part of the communications device 1a; it may be provided as an external storage device to be connected to the communications device 1a.

The input device 41 provides a user interface through which the operator of the communications device 1a can make inputs. The device 41 sends input signals to the input control section 40 in accordance with the operator inputs. The input device 41 may include buttons (keys), switches, a touch panel, and/or other forms of input devices provided on the front of the communications device 1a. The operator can enter inputs on the input device 41 to create email data, address book data, and schedule note data as an example. The created data is sent via the major control section 10a and stored in the storage section 20. Some examples of the inputs that can be entered on the input device 41 are a selection of image data the operator of the communications device 1a wants to transmit and an infrared communications initiate command for the initiation of infrared communications with communications device 2.

The input control section 40 controls the input device 41 which enables the operator of the communications device 1a to make inputs and transmits input signals to the major control section 10a in accordance with the operator inputs.

The communications device 1a may further include, for example, a display device, an image capturing device, an audio input device, and/or an audio output device (not shown) suitably and selectively depending on the functionality of the communications device 1a. For example, to apply the communications device 1a to a digital camera, there will be provided an image capturing device; the captured image will be transmitted to the communications device 2 using the communications function of the major control section 10a, the transmitting section 80, and the receiving section 81. Another example will be application of the communications device 1a to a mobile phone. There will be provided an audio input device, an audio output device, and an external communications control section which enables connection to the communications network 900; the received audio data and/or email data will be transmitted to the communications device 2 using the communications function of the major control section 10a, the transmitting section 80, and the receiving section 81.

Next, the major control section 10a will be described in detail. The major control section 10a includes an IrLAP layer processing section 100, an upper layer processing section 101, a lower layer processing section 102, and a communications protocol analyzing section 160a.

The IrLAP layer processing section 100 includes a protocol control section 110, a timer 120, a transmit request command analyzing section 130, an outbound upper layer data recording section 140, an IrSimple outbound frame generating section 150, an IrDA outbound frame generating section 151, an IrSimple inbound frame analyzing section 170, an IrDA inbound frame analyzing section 171, an inbound upper layer data recording section 180, and a receive command message generating section 190.

The protocol control section (protocol control means) 110 controls the protocol for the IrLAP layer and to this end, includes an IrDA-IrLAP control section (first-protocol control section; first-protocol control means) 111, IrSimple-IrLAP control section (second-protocol control section; second-protocol control means) 112, and a protocol switching section 113.

The IrDA-IrLAP control section 111 performs communications using IrDA-IrLAP protocols and to this end, includes a station discovery control section 1111, a connection control section 1112, a data transfer control section 1113, and a disconnection control section 1114. The station discovery control section 1111 implements a station discovery using IrDA-IrLAP protocols. The connection control section 1112 implements a connection routine using IrDA-IrLAP protocols. The data transfer control section 1113 implements a data transfer using IrDA-IrLAP protocols. The disconnection control section 1114 implements a disconnection routine using IrDA-IrLAP protocols. In the IrDA-IrLAP control section 111, the station discovery control section 1111 implements a station discovery, followed by a connection routine implemented by the connection control section 1112, to connect. To transfer data, the data transfer control section 1113 implements a data transfer. To disconnect, the disconnection control section 1114 implements a disconnection routine.

The IrSimple-IrLAP control section 112 performs communications using IrSimple-IrLAP protocols and to this end, includes a connection control section 1121, a data transfer control section 1122, and a disconnection control section 1123. The connection control section 1121 implements a connection routine using IrSimple-IrLAP protocols. The data transfer control section 1122 implements a data transfer using IrSimple-IrLAP protocols. The disconnection control section 1123 implements a disconnection routine using IrSimple-IrLAP protocols. In the IrSimple-IrLAP control section 112, the connection control section 1121 implements a connection routine to connect. To transfer data, the data transfer control section 1122 implements a data transfer. To disconnect, the disconnection control section 1123 implements a disconnection routine.

The protocol switching section 113 switches between the IrDA-IrLAP control section 111 and the IrSimple-IrLAP control section 112. Specifically, in an attempt to establish a connection to the communications device 2, the switching function of the protocol switching section 113 enables the IrLAP layer processing section 100 to behave as follows. The section 100 first attempts to connect using IrSimple and if the communications device 2 does not respond, attempts to connect using IrDA. If the communications device 2 does not respond again, the section 100 attempts again to connect using IrSimple. The process is repeated.

The timer 120 works under the control of the protocol control section 110. The timer 120 is used, for example, for the protocol control section 110 to determine a timeout in the connection routine.

When the protocol control section 110 is informed by the communications protocol analyzing section 160a (will be detailed later) of a reception of an IrDA-compliant UA response while the IrSimple-IrLAP control section 112 is carrying out the connection routine, the section 110 terminates the connection routine being carried out by the IrSimple-IrLAP control section 112 and completes connecting up to the LAP layer, to establish a connection using IrDA.

Likewise, when the protocol control section 110 is informed by the communications protocol analyzing section 160a of a reception of an IrSimple-compliant UA response while the IrDA-IrLAP control section 111 is carrying out the connection routine, the section 110 may terminate the connection routine being carried out by the IrDA-IrLAP control section 111 and complete the connection routine, to establish a connection using IrSimple.

The transmit request command analyzing section 130 analyzes a transmit request command from the upper layer (IrLMP layer). The transmit request command here is a connect request, a data transfer request, and a disconnect request. The result of the analysis is forwarded to the protocol control section 130.

The outbound upper layer data recording section 140 records outbound data from the upper layer (IrLMP layer). The recorded data is supplied to the IrSimple outbound frame generating section 150 or the IrDA outbound frame generating section 151 where it is incorporated into an outbound frame.

The IrSimple outbound frame generating section 150 generates an outbound frame which will be passed down to the lower layer (PHY layer) in accordance with the frame format specified by IrSimple. The section 150 does so by arranging the data fed from the outbound upper layer data recording section 140 as instructed by the protocol control section 110 so that the resultant data can fit into the predetermined IrSimple frame format. An error detection code (ex. CRC) is also added to the outbound frame so that the secondary station can perform error detection. An error correction code may also added to the outbound frame.

The IrDA outbound frame generating section 151 generates an outbound frame which will be passed down to the lower layer (PHY layer) in accordance with the frame format specified by IrDA. The section 151 does so by arranging the data fed from the outbound upper layer data recording section 140 as instructed by the protocol control section 110 so that the resultant data can fit into the predetermined IrDA frame format. An error detection code (ex. CRC) is also added to the outbound frame so that the secondary station can perform error detection. An error correction code may also added to the outbound frame.

FIG. 1 shows two outbound frame generating sections (IrSimple outbound frame generating section 150 and IrDA outbound frame generating section 151) for different sets of protocols. The device generally can perform communications using different sets of protocols if it is provided with outbound frame generating sections which are compatible with those sets of protocols.

The IrSimple inbound frame analyzing section 170 analyzes an inbound frame fed from the communications protocol analyzing section 160a according to the IrSimple frame format and forwards the result of the analysis to the protocol control section 110. The section 170 also records the upper layer data extracted from the inbound frame into the inbound upper layer data recording section 180. The upper layer data may be recorded into the inbound upper layer data recording section 180 via the protocol control section 110.

The IrDA inbound frame analyzing section 171 analyzes the inbound frame fed from the communications protocol analyzing section 160a according to the IrDA frame format and forwards the result of the analysis to the protocol control section 110. The section 171 also records the upper layer data extracted from the inbound frame into the inbound upper layer data recording section 180. The upper layer data may be recorded into the inbound upper layer data recording section 180 via the protocol control section 110.

FIG. 1 shows two inbound frame analyzing sections (IrSimple inbound frame analyzing section 170 and IrDA inbound frame analyzing section 171) for different sets of protocols. The device generally can perform communications using different sets of protocols if it is provided with inbound frame analyzing sections which are compatible with those sets of protocols.

The inbound upper layer data recording section 180 records the upper layer data extracted by either the IrSimple inbound frame analyzing section 170 or the IrDA inbound frame analyzing section 171. The recorded data is passed on to the upper layer (IrLMP layer).

The receive command message generating section 190 generates a receive command in response to a receive command message generate request from the protocol control section 110 and passes the command to the upper layer (IrLMP layer). The receive command here is a connect request receive command, a data transfer request receive command, or a disconnect request receive command.

The upper layer processing section 101 carries out processes in the layers above the IrLAP layer based on the data from the inbound upper layer data recording section 180 and the receive command from the receive command message generating section 190.

The lower layer processing section 102 carries out processes in the layers below the IrLAP layer based on the outbound frame from the IrSimple outbound frame generating section 150 and the IrDA outbound frame generating section 151.

The communications protocol analyzing section 160a analyzes the incoming frame from the lower layer processing section 102 to determine whether the frame complies with IrSimple or IrDA, and communicates a result to the protocol control section 110. The communications protocol analyzing section 160a sends the inbound frame to the IrSimple inbound frame analyzing section 170 if the inbound frame complies with IrSimple and to the IrDA inbound frame analyzing section 171 if the inbound frame complies with IrDA.

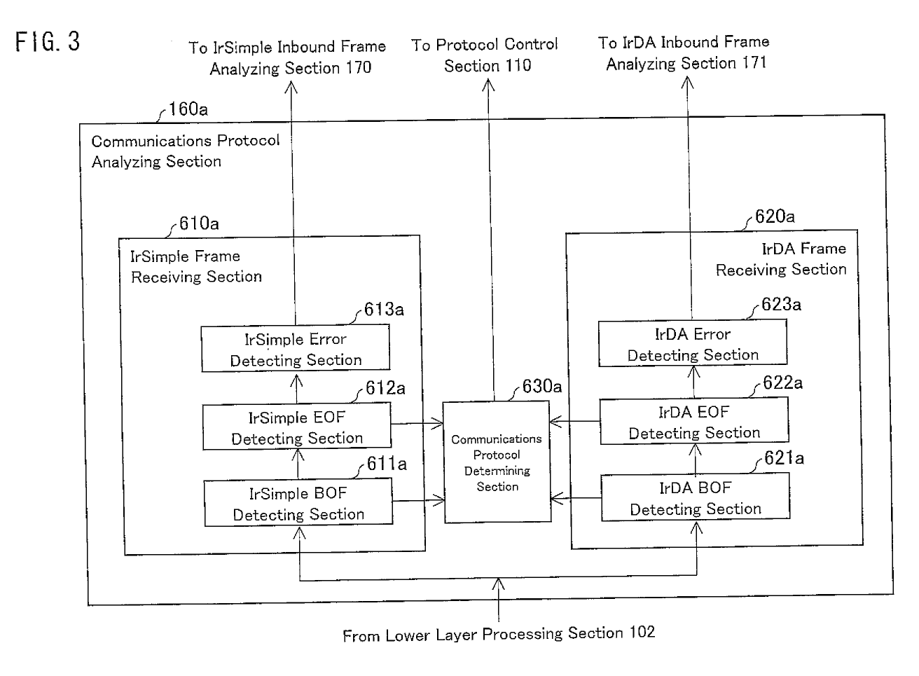

The communications protocol analyzing section 160a will be described in detail in reference to FIG. 3 which is a block diagram illustrating the configuration of the communications protocol analyzing section 160a. The communications protocol analyzing section 160a includes, as shown in FIG. 3, an IrSimple frame receiving section 610a, an IrDA frame receiving section 620a, and a communications protocol determining section 630a.

After the IrSimple-IrLAP control section 112 transmits an SNRM command (connect request command), the IrSimple frame receiving section 610a becomes ready to receive a response returned at 115.2 kbps. The section 610a then receives an IrSimple frame returned at 115.2 kbps and analyzes it. The frame received by the IrSimple frame receiving section 610a has the format shown in FIG. 49 as described earlier in the Background of the Invention section. In other words, the inbound frame includes a BOF, an IrLAP data, an FCS, and an EOF field. To handle these fields, the IrSimple frame receiving section 610a includes an IrSimple BOF detecting section 611a, an IrSimple EOF detecting section 612a, and an IrSimple error detecting section 613a.

The IrSimple BOF detecting section 611a detects and removes the BOF field from the received frame. If the BOF field is detected, the section 611a sends a flag detection signal to the communications protocol determining section 630a. Likewise, the IrSimple EOF detecting section 612a detects and removes the EOF field from the received frame. If the EOF field is detected, the section 612a sends a flag detection signal to the communications protocol determining section 630a.

If the BOF field and the EOF field are detected, the IrSimple error detecting section 613a determines from the value in the FCS field of the received frame whether or not the received data contains a transmission error. If no error is detected, the IrSimple error detecting section 613a reads the IrLAP data field and outputs the data readout to the IrSimple inbound frame analyzing section 170. It may be only one of the IrSimple BOF detecting section 611a and the IrSimple EOF detecting section 612a that sends the flag detection signal to the communications protocol determining section 630a.

Likewise, after the IrSimple-IrLAP control section 112 transmits an SNRM command (connect request command), the IrDA frame receiving section 620a becomes ready to receive a response returned at 9,600 bps. The section 620a then receives an IrDA frame returned at 9,600 bps and analyzes it. The frame received by the IrDA frame receiving section 620a has the frame format shown in FIG. 49 as described earlier in the Background of the Invention section. In other words, the inbound frame includes a BOF, an IrLAP data, an FCS, and an EOF field. To handle these fields, the IrDA frame receiving section 620a includes an IrDA BOF detecting section 621a, an IrDA EOF detecting section 622a, and an IrDA error detecting section 623a.

The IrDA BOF detecting section 621a detects and removes the BOF field from the received frame. If the BOF field is detected, the section 621a sends a flag detection signal to the communications protocol determining section 630a. Likewise, the IrDA EOF detecting section 622a detects and removes the EOF field from the received frame. If the EOF field is detected, the section 622a sends a flag detection signal to the communications protocol determining section 630a. If the BOP field and the EOF field are detected, the IrDA error detecting section 623a determines from the value in the FCS field of the received frame whether or not the received data contains a transmission error.

If no error is detected, the IrDA error detecting section 623a reads the IrLAP data field and outputs the data readout to the IrDA inbound frame analyzing section 171. It may be only one of the IrDA BOF detecting section 621a and the IrDA EOF detecting section 622a that sends the flag detection signal to the communications protocol determining section 630a.

The communications protocol determining section 630a receives the flag detection signal. If the received flag detection signal is identified as having been transmitted from the IrSimple BOF detecting section 611a (or IrSimple EOF detecting section 612a), the section 630a determines that the communications device 2 is operating using the IrSimple protocols. On the other hand, if the received flag detection signal is identified as having been transmitted from the IrDA BOF detecting section 621a (or IrDA EOF detecting section 622a), the section 630a determines that the communications device 2 is operating using the IrDA protocols and has returned a wrong response frame using the IrDA protocols.

The communications protocol determining section 630a communicates the decision to the protocol control section 110. Based on the decision, the protocol control section 110 controls the connection routine after the reception of the response, in terms of the protocols used to implement the routine (IrSimple or IrDA). Specifically, if the communications device 2 is determined to be operating using the IrSimple protocols, the connecting of the IrLAP, IrLMP, IrSMP, and OBEX layers are all completed. After the connections, data exchange is carried out using the QoS (Quality of Service) parameters agreed upon through the exchange of the SNRM command and the UA response. On the other hand, if the communications device 2 is determined to be operating using the IrDA protocols, connecting is completed up to the IrLAP layer using the IrDA protocols and continued to establish connections for the IrLMP, TinyTP, and OBEX layers.

### Connection Routine for Communications Device 1a and Communications Device 2

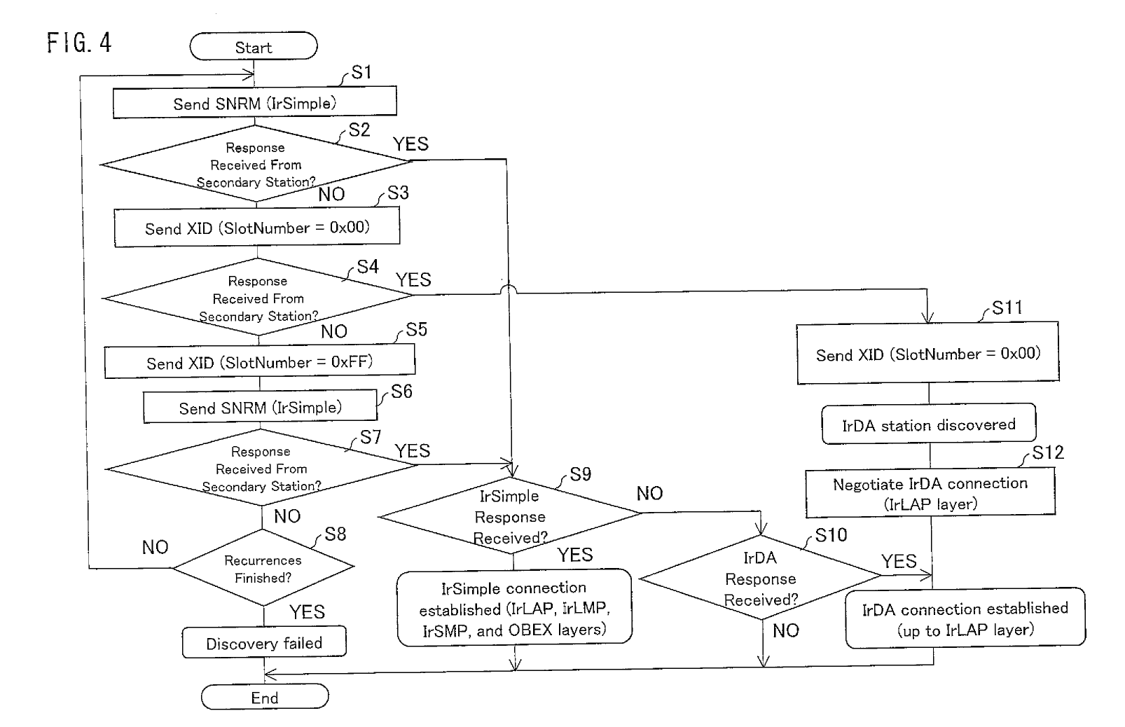

Next, referring to FIG. 4, a routine will be described by which the communications device (primary station) 1a connects to the communications device 2 within the communications range of the communications device 1a. FIG. 4 is a flow chart illustrating a process of the communications device 1a switching between connection routines in accordance with a response from the secondary station.

As the operator of the communications device 1a enters an infrared communications initiate command on the input device 41, the protocol switching section 113 first activates the IrSimple-IrLAP control section 112 and has the connection control section 1121 transmit an SNRM command specified in the IrSimple protocols (step 1). If the communications device 2 supports IrSimple, the communications device 2, acting as a secondary station, responds to the SNRM command by returning an IrSimple UA response.

If the communications device 2 strictly adheres to both the IrDA and IrSimple protocol specifics, the device 2 returns an IrSimple UA response to give priority to connecting using the IrSimple protocols. If the communications device 2 is an illegal response sender device, the device 2 responds to the SNRM command by returning an IrDA UA response.

Next, the IrSimple frame receiving section 610a and the IrDA frame receiving section 620a wait for a response from the secondary station. If there is a response (YES in step 2), the IrSimple BOF detecting section 611a or the IrDA BOF detecting section 621a detects the BOF field of the inbound frame; alternatively, the IrSimple EOF detecting section 612a or the IrDA EOF detecting section 622a detects the EOF field of the inbound frame. Thus, one of the sections 611a, 621a, 612a, and 622a sends a detection signal to the communications protocol determining section 630a. From the detection signal, the communications protocol determining section 630a determines which protocol was used to send the response frame (steps 9 and 10).

On the other hand, if there is no response for a predetermined period (NO in step 2), the protocol switching section 113 activates the IrDA-IrLAP control section 111, replacing the IrSimple-IrLAP control section 112, and has the station discovery control section 1111 transmit an XID command (SlotNumber 0x00) (step 3), to see whether or not there is a secondary station which supports IrDA within the communications range of the communications device 1a. The predetermined period here is, for example, a period ranging from 50 ms (milliseconds) to 85 ms as specified in the IrSimple protocols.

If the communications device 2 supports IrDA, the communications device 2, as the secondary station, responds to the XID command by returning an XID response. In contrast, the communications device 2 is set up, if strictly adhering to both the IrDA and IrSimple protocol specifics, not to respond to the XID command (SlotNumber 0x00), to give priority to connecting using the IrSimple protocols (see non-patent document 6). Hence, if the communications device 2 strictly adheres to both the IrDA and IrSimple protocol specifics, it returns no response frame.

The IrDA frame receiving section 620a waits for a response from the secondary station. If there is a response (YES in step 4), it means that the device 1a has discovered a communications device 2 supporting IrDA. The IrDA-IrLAP control section 111 negotiates a connection using the IrDA protocols (steps 11 to 12). On the other hand, if there is no response for the predetermined period (NO in step 4), the station discovery control section 1111 transmits an XID-End command specified in the IrDA protocols (step 5), notifying secondary stations located within the communications range of the device 1a of the end of the XID command transmissions.

The protocol switching section 113 activates the IrSimple-IrLAP control section 112, replacing the IrDA-IrLAP control section 111, and has the connection control section 1121 transmit an SNRM command specified in the IrSimple protocols (step 6). If the communications device 2 supports IrSimple, the communications device 2, as the secondary station, responds to the SNRM command by returning an IrSimple UA response. On the other hand, if the communications device 2 strictly adheres to both the IrDA and IrSimple protocol specifics, the device 2 returns an IrSimple UA response to give priority to connecting using the IrSimple protocols. If the communications device 2 is an illegal response sender device, the device 2 responds to the SNRM command by returning an IrDA UA response.

Next, the IrSimple frame receiving section 610a and the IrDA frame receiving section 620a wait for a response from the secondary station. If there is a response (YES in step 7), the IrSimple BOF detecting section 611a or the IrDA BOF detecting section 621a detects the BOF field of the inbound frame; alternatively, the IrSimple EOF detecting section 612a or the IrDA EOF detecting section 622a detects the EOF field of the inbound frame. Thus, one of the sections 611a, 621a, 612a, and 622a sends a detection signal to the communications protocol determining section 630a. From the detection signal, the communications protocol determining section 630a determines whether the response frame is a UA response transmitted using the IrSimple protocols or the IrDA protocols (steps 9 and 10).

On the other hand, if there is no response for a predetermined period (NO in step 7), the protocol switching section 113 determines whether or not the recurrences of steps 1 to 7 are finished (step 8). If they are (YES in step 8), the connection routine is ended without discovering a secondary station.

The recurrences may be considered to be finished when the recurrences have reached a specified count or by measuring with the timer 120 the time elapsed since the connection routine was started (for example, the recurrences are allowed only 5 seconds after the start of the connection routine).

If the recurrences are not finished (NO in step 8), the protocol switching section 113 again activates the IrSimple-IrLAP control section 112 and has the connection control section 1121 transmit an SNRM command specified in the IrSimple protocols (step 1).

if there is a response to the SNRM command specified in the IrSimple protocols from the communications device 2 (YES in step 2 or 7), the communications protocol determining section 630a determines from the detection signal whether or not the received response frame is a UA response which complies with IrSimple (step 9). If the response frame is a UA response which complies with IrSimple (YES in step 9), it means that the device 1a has discovered a communications device (secondary station) 2 supporting IrSimple. The communications device 1a then enters a mode in which it connects and communicates using the IrSimple protocols (hereinafter, “IrSimple communications mode”). The decision is communicated to the protocol control section 110, thereby completing the connecting of all the IrLAP, IrLMP, IrSMP, and OBEX layers and also completing the connection routine.

On the other hand, if the response frame is not a UA response which complies with IrSimple (NO in step 9), The section 630a determines whether or not the received response frame is a UA response which complies with IrDA (step 10). If the response frame is a UA response which complies with IrDA (YES in step 10), it means that the device 1a has discovered a communications device (secondary station) 2 supporting IrDA. The decision is communicated to the protocol control section 110, thereby completing connecting up to the IrLAP layer using the IrDA protocols.

If the response frame is not a UA response which complies with IrDA (NO in step 10), the device 1a ends the connection routine without establishing a connection because there is no communications device 2 supporting IrSimple or IrDA.

If there is a response to the IrDA XID command from the communications device 2 (YES in step 4), the station discovery control section 1111 transmits an XID-End command specified in the IrDA protocols (step 11), notifying secondary stations located within the communications range of the device 1a of the end of the XID command transmissions. That means the communications device 1a has discovered a communications device 2 supporting IrDA as a secondary station, thereby entering a mode in which it connects and communicates using the IrDA protocols (hereinafter, “IrDA communications mode”). With the station discovery having been completed, next, a connection routine is carried out for the IrLAP layer using the IrDA protocols (step 12), thereby completing connecting up to the IrLAP layer and also the connection routine.

Next will be described connection routines for the communications device 1a and three types of communications devices (secondary stations) 2. The device 2: (1) supports IrDA, but returns a UA response to a broadcast frame (illegal response sender device); (2) strictly adheres to the IrSimple protocol specifics; or (3) strictly adheres only to the IrDA protocol specifics.

### (1) Communications Device 2 is Illegal Response Sender Device

A connection routine will be described for the communications device 1a and a communications device (illegal response sender device) 2 in reference to FIG. 4.

The SNRM command transmitted by the connection control section 1121 as specified in the IrSimple protocols (step 1) is a broadcast frame, not a legal frame of the IrDA protocols. Nevertheless, the communications device 2 returns a UA response according to the IrDA protocols. Since the communications device 2 has responded (YES in step 2), the communications device 1a determines whether the response frame is a UA response which complies with IrSimple (step 9).

The UA response returned from the communications device 2 complies with IrDA, not IrSimple (NO in step 9). Therefore, the device 1a determines whether the received response frame is a UA response which complies with IrDA (step 10).

Since the received response frame is a UA response which complies with IrDA (YES in step 10), connecting is completed up to the IrLAP layer using the IrDA protocols, and the connection routine is ended. Furthermore, as the connection of the IrLAP layer (not shown) is completed, the upper layer processing section 101 carries out connecting of the IrLMP layer, the TinyTP layer, and the OBEX layer. As the connecting of the layers is completed, the communications device 1a becomes ready to transmit the data held in the storage section 20 to the communications device 2 using the IrDA protocols. With the processing progresses as above, the communications device 1a can communicate with the communications device (illegal response sender device) 2 using the IrDA protocols.

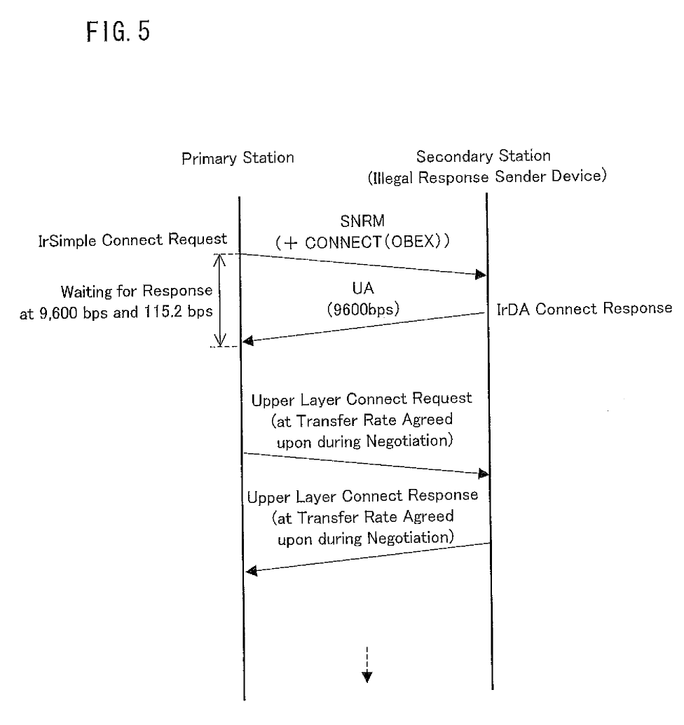

The connection routine for the communications device 1a and the communications device (illegal response sender device) 2 will be described in reference to FIG. 5 which shows a signal sequence followed when the communications device 1a connects to a communications device (illegal response sender device) 2.

As shown in FIG. 5, the primary station transmits an SNRM command specified in the IrSimple protocols and then waits for a UA response from the secondary station at 9,600 bps and 115.2 kbps. The secondary station responds to the SNRM command, transmitting a UA response which complies with IrDA at 9,600 bps. Since the primary station is waiting for a UA response from the secondary station at 9,600 bps and 115.2 kbps, the primary station can receive the UA response coming from the secondary station. The primary station is capable of determining whether or not the UA response from the secondary station is a UA response which complies with IrDA. Therefore, connecting is completed up to the IrLAP layer using the IrDA protocols, and the connecting of the IrLMP, TinyTP, and OBEX layers are implemented.

### (2) Communications Device 2 Strictly Adheres to IrSimple Protocol Specifics

A connection routine will be described for the communications device 1a and a communications device 2 which strictly adheres to the IrSimple protocol specifics in reference to FIG. 4. A connection is established by the same signal sequence as the one described earlier in the Background of the Invention section in connection with FIG. 38.

The communications device 2 responds to the SNRM command transmitted by the connection control section 1121 as specified in the IrSimple protocols (step 1) and returns an IrSimple UA response. Since the communications device 2 has responded (YES in step 2), the communications device 1a determines whether the response frame is a UA response which complies with IrSimple (step 9).

The UA response returned from the communications device 2 complies with IrSimple (YES in step 9). Thus, the communications device 1a has discovered a communications device 2 supporting IrSimple as a secondary station, thereby entering an IrSimple communications mode. That completes the connecting of all the IrLAP, IrLMP, IrSMP, and OBEX layers and also completes the connection routine. With the processing progresses as above, the communications device 1a can communicate with the communications device 2 using the IrSimple protocols.

### (3) Communications Device 2 Strictly Adheres Only to IrDA Protocol Specifics

A connection routine will be described for the communications device 1a and a communications device 2 which strictly adheres only to the IrDA protocol specifics in reference to FIG. 4. A connection is established by the same signal sequence as the one described earlier in the Background of the Invention section in connection with FIG. 43.

The communications device 2 does not respond because the SNRM command transmitted by the connection control section 1121 as specified in the IrSimple protocols (step 1) is a broadcast frame. There is no response from the communications device 2 for a predetermined period (for example, 50 ms to 85 ms as specified in the IrSimple protocols) (NO in step 2). Therefore, in the communications device 1a, the protocol switching section 113 activates the IrDA-IrLAP control section 111, replacing the IrSimple-IrLAP control section 112. Also, the station discovery control section 1111 transmits an XID command (SlotNumber 0x00; step 3) to check whether or not there is a secondary station supporting IrDA within the communications range of the communications device 1a.

The communications device 2, as the secondary station, responds to the XID command by returning an XID response. Since the communications device 2 has responded (YES in step 4), it means that the communications device 1a has discovered a communications device 2 supporting IrDA. The station discovery control section 1111 transmits an XID-End command specified in the IrDA protocols (step 11), notifying secondary stations located within the communications range of the device 1a of the end of the XID command transmissions. With the station discovery having been completed, a connection routine is carried out for the IrLAP layer using the IrDA protocols (step 12), thereby completing connecting up to the IrLAP layer and also the connection routine. With the processing progresses as above, the communications device 1a can communicate with the communications device 2 using the IrDA protocols.

After the station discovery control section 1111 transmits the XID command, if there is no response for a predetermined period (NO in step 4), the station discovery control section 1111 transmits an XID-End command specified in the IrDA protocols (step 5), notifying secondary stations located within the communications range of the device 1a of the end of the XID command transmissions. Subsequently, the protocol switching section 113 activates the IrSimple-IrLAP control section 112, replacing the IrDA-IrLAP control section 111, and has the connection control section 1121 transmit an SNRM command specified in the IrSimple protocols (step 6). In this case, again, if there is no response for a predetermined period (NO in step 7), the protocol switching section 113 determines whether or not the recurrences of steps 1 to 7 are finished (step 8). If they are (YES in step 8), the connection routine is ended without discovering a secondary station.

As described in the foregoing, the communications device 1a of the present embodiment is capable of receiving a response from the communications device 2 and reliably carrying out the connection routine regardless of whether the communications device 2: (1) is an illegal response sender device (it returns an IrDA response when it receives an IrSimple connect request command for the first time); (2) either strictly adheres only to the IrSimple protocol specifics and transmits an IrSimple response or strictly adheres to the IrDA and IrSimple protocol specifics and transmits an IrSimple response to give priority to the IrSimple protocols; or (3) strictly adheres only to the IrDA protocol specifics and transmits an IrDA response.

### Embodiment 2

Embodiment 1 distinguished between communications protocols by the transfer rate of an incoming response. When the channel's transmission quality is poor, the BOF field (or EOF field) in the received frame is sometimes not correctly detectable, making it impossible to determine the correct communications protocol. Accordingly, another embodiment will be described which, in addition to the configuration of embodiment 1, analyzes the frame structure of the received response.

The following will describe the present embodiment in reference to FIGS. 6 to 8, and 4. For convenience, members of the present embodiment that have the same arrangement and function as members of embodiment 1, and that are mentioned in that embodiment are indicated by the same reference numerals and description thereof is omitted.

### Overall Structure of Communications System

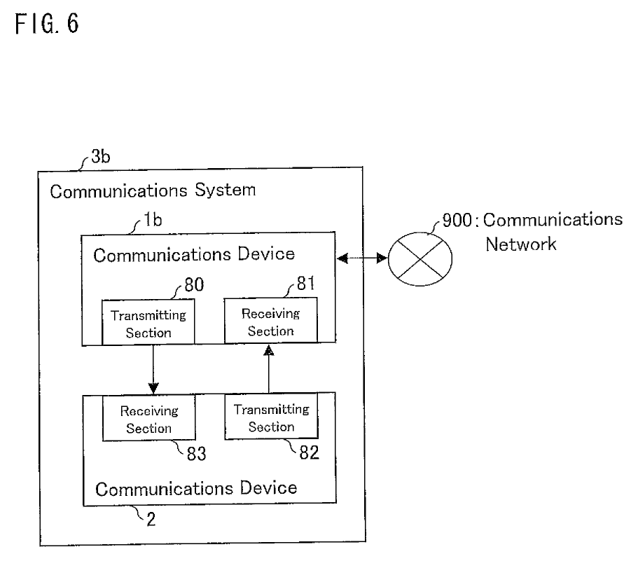

A communications system 3b of the present embodiment will be described in reference to FIG. 6 which is a block diagram illustrating the configuration of the communications system 3b. The system 3b incorporates a communications device 1b which is a communications device of the present embodiment and a communications device 2. Similarly to the communications device 1a, the communications device 1b may be, for example, a digital camera or a mobile phone. The device 1b is capable of communicating with the communications device 2. In addition, the communications device 1b may be capable of communicating with an external communications device (not shown) over the communications network 900.

### Configuration of Communications Device

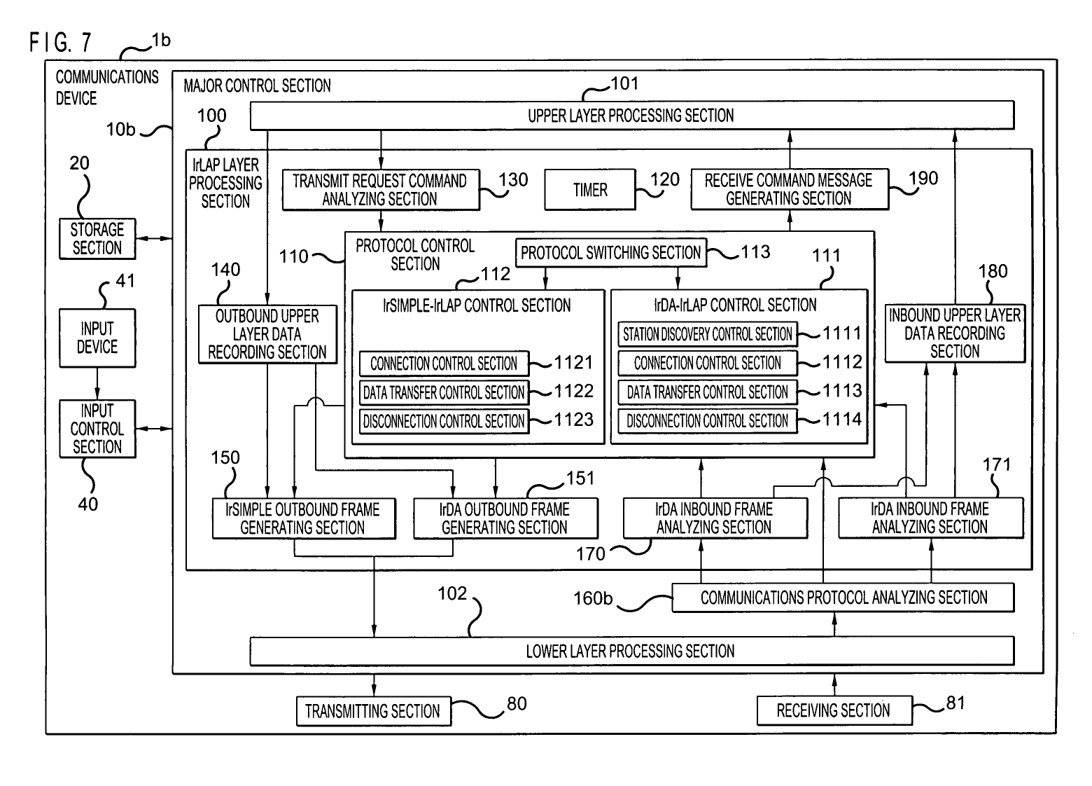

Next will be described the configuration of the communications device 1b in reference to FIG. 7 which is a block diagram illustrating the configuration of the communications device 1b. The communications device 1b includes almost the same members as the communications device 1a of embodiment 1 as shown in FIG. 7: it includes a major control section 10b in place of the major control section 10a. The major control section 10b includes almost the same members as the major control section 10a of embodiment 1: it includes a communications protocol analyzing section 160b in place of the communications protocol analyzing section 10a.

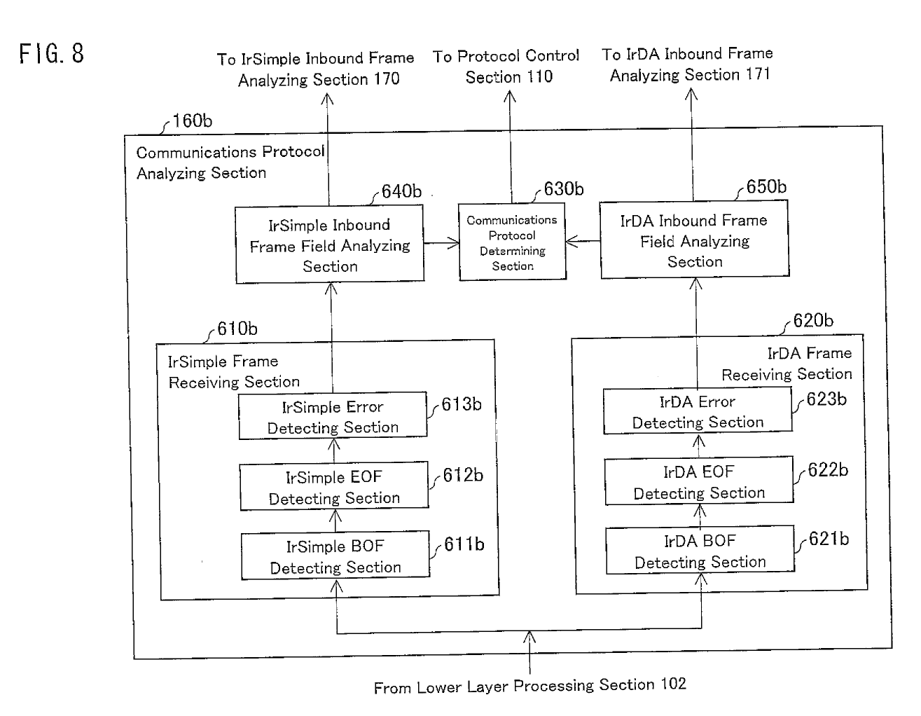

The communications protocol analyzing section 160b will be described in detail in reference to FIG. 8 which is a block diagram illustrating the configuration of the communications protocol analyzing section 160b. Referring to FIG. 8, the communications protocol analyzing section 160b includes an IrSimple frame receiving section 610b, an IrDA frame receiving section 620b, a communications protocol determining section 630b, an IrSimple inbound frame field analyzing section 640b, and an IrDA inbound frame field analyzing section 650b.

After the IrSimple-IrLAP control section 112 transmits an SNRM command (connect request command), the IrSimple frame receiving section 610b becomes ready to receive a response returned at 115.2 kbps. The IrSimple frame receiving section 610b receives an IrSimple frame returned at 115.2 kbps and analyzes it. The frame received by the IrSimple frame receiving section 610b has the format shown in FIG. 49 as described earlier in the Background of the Invention section. In other words, the inbound frame includes a BOF, an IrLAP data, an FCS, and an EOF field. To handle these fields, the IrSimple frame receiving section 610b includes an IrSimple BOF detecting section 611b, an IrSimple EOF detecting section 612b, and an IrSimple error detecting section 613b.

The IrSimple BOF detecting section 611b detects and removes the BOF field from the received frame. Likewise, the IrSimple EOF detecting section 612b detects and removes the EOF field from the received frame. If the BOF field and the EOF field are detected, the IrSimple error detecting section 613b determines from the value in the FCS field of the received frame whether or not the received data contains a transmission error. If no error is detected, the IrSimple error detecting section 613b reads the IrLAP data field and outputs the data readout to the IrSimple inbound frame field analyzing section 640b.

The IrSimple inbound frame field analyzing section 640b analyzes the frame structure of the received data to examine whether the data contains predetermined fields, and communicates a result to the communications protocol determining section 630b. It will be discussed later how the data is examined to determine whether the data contains predetermined fields.

Likewise, the IrDA frame receiving section 620a receives an IrDA frame returned at 9,600 bps and analyzes it. To implement the reception and analysis, the section 620a includes an IrDA BOF detecting section 621b, an IrDA EOF detecting section 622b, and an IrDA error detecting section 623b. The IrDA BOF detecting section 621b detects and removes the BOF field from the received frame. Likewise, the IrDA EOF detecting section 622b detects and removes the EOF field from the received frame.

If the BOF field and the EOF field are detected, the IrDA error detecting section 623b determines from the value in the FCS field of the received frame whether or not the received data contains a transmission error. If no error is detected, the IrDA error detecting section 623b reads the IrLAP data field and outputs the data readout to the IrDA inbound frame field analyzing section 650b.

The IrDA inbound frame field analyzing section 650b analyzes the structure of the received data to examine whether the data contains predetermined fields, and communicates a result to the communications protocol determining section 630b. It will be discussed later how the data is examined to determine whether the data contains predetermined fields.

From the result communicated from the IrSimple inbound frame field analyzing section 640b or the IrDA inbound frame field analyzing section 650b, the communications protocol determining section 630b determines which protocol was used to send the inbound frame and communicates a result to the protocol control section 110. Specifically, if the IrSimple inbound frame field analyzing section 640b informs that the data contains predetermined fields, the section 630b determines that the inbound frame was sent using the IrSimple protocols. On the other hand, if the IrDA inbound frame field analyzing section 650b informs that the data contains predetermined fields, the section 630b determines that the inbound frame was sent using the IrDA protocols.

Now, a method will be described, by way of examples, whereby the IrSimple inbound frame field analyzing section 640b and the IrDA inbound frame field analyzing section 650b examine whether or not the data contains predetermined fields.

As described earlier in the Background of the Invention section, the UA response frame which complies with IrSimple always contains a unique “upper user data” field, whereas the UA response frame which complies with IrDA contains no upper user data field. See FIGS. 40 and 46. So, by examining whether or not there is contained an upper user data field, it can be determined whether the received frame is a UA response frame which complies with IrSimple or a UA response frame which complies with IrDA.

Therefore, the IrSimple inbound frame field analyzing section 640b and the IrDA inbound frame field analyzing section 650b individually examine whether or not the received data contains an upper user data field. If the IrSimple inbound frame field analyzing section 640b detects an upper user data field, the detection is communicated to the communications protocol determining section 630b. On the other hand, if the IrDA inbound frame field analyzing section 650b detects no upper user data field, the failure of detection is communicated to the communications protocol determining section 630b.

If the communications protocol determining section 630b receives the communication from the IrSimple inbound frame field analyzing section 640b, the section 630b determines that the received frame is a UA response frame which complies with IrSimple. On the other hand, if the communications protocol determining section 630b receives the communication from the IrDA inbound frame field analyzing section 650b, the section 630b determines that the received frame is a UA response frame which complies with IrDA.

### Connection Routine for Communications Device 1b and Communications Device 2

Next, referring to FIG. 4, a routine will be described by which the communications device (primary station) 1b connects to a communications device 2 located within the communications range of the communications device 1b. FIG. 4 is a flow chart illustrating a process of the communications device 1b switching between connection routines in accordance with a response from the secondary station.

As the operator of the communications device 1b enters an infrared communications initiate command on the input device 41, the protocol switching section 113 first activates the IrSimple-IrLAP control section 112 and has the connection control section 1121 transmit an SNRM command specified in the IrSimple protocols (step 1).

Next, the IrSimple frame receiving section 610b and the IrDA frame receiving section 620b wait for a response from the secondary station. If there is a response (YES in step 2), the IrSimple BOF detecting section 611b detects the BOF field of the inbound frame, and the IrSimple EOF detecting section 612b detects the EOF field of the inbound frame. The IrSimple error detecting section 613b determines whether the inbound frame contains a transmission error and outputs extracted data to the IrSimple inbound frame field analyzing section 640b. Alternatively, the IrDA BOF detecting section 621b detects the BOF field of the inbound frame, and the IrDA EOF detecting section 622b detects the EOF field of the inbound frame. The IrDA error detecting section 623b determines whether the inbound frame contains a transmission error and outputs extracted data to the IrDA inbound frame field analyzing section 650b.

The IrSimple inbound frame field analyzing section 640b and the IrDA inbound frame field analyzing section 650b individually examine whether or not the received data contains an upper user data field. Results are communicated to the communications protocol determining section 630b. From the results, the communications protocol determining section 630b determines which protocol was used to send the response frame (steps 9 and 10).

On the other hand, if there is no response for a predetermined period (NO in step 2), the protocol switching section 113 activates the IrDA-IrLAP control section 111, replacing the IrSimple-IrLAP control section 112, and has the station discovery control section 1111 transmit an XID command (SlotNumber 0x00) (step 3), to see whether or not there is a secondary station which supports IrDA within the communications range of the communications device 1b. The predetermined period here is, for example, a period ranging from 50 ms to 85 ms as specified in the IrSimple protocols.

If the communications device 2 supports IrDA, the communications device 2, as the secondary station, responds to the XID command by returning an XID response. In addition, the communications device 2 is set up, if strictly adhering to both the IrDA and IrSimple protocol specifics, not to respond to the XID command (SlotNumber 0x00), to give priority to connecting using the IrSimple protocols (see non-patent document 6). Hence, if the communications device 2 strictly adheres to both the IrDA and IrSimple protocol specifics, it returns no response frame.

The IrDA frame receiving section 620b waits for a response from the secondary station. If there is a response (YES in step 4), it means that the device 1b has discovered a communications device 2 supporting IrDA. The IrDA-IrLAP control section 111 negotiates a connection using the IrDA protocols (steps 11 to 12). On the other hand, if there is no response for a predetermined period (NO in step 4), the station discovery control section 1111 transmits an XID-End command specified in the IrDA protocols (step 5), notifying secondary stations located within the communications range of the device 1b of the end of the XID command transmissions.

The protocol switching section 113 activates the IrSimple-IrLAP control section 112, replacing the IrDA-IrLAP control section 111, and has the connection control section 1121 transmit an SNRM command specified in the IrSimple protocols (step 6).

If the communications device 2 supports IrSimple, the communications device 2, as the secondary station, responds to the SNRM command by returning an IrSimple UA response. On the other hand, if the communications device 2 strictly adheres to both the IrDA and IrSimple protocol specifics, the device 2 returns an IrSimple UA response to give priority to connecting using the IrSimple protocols. If the communications device 2 is an illegal response sender device, the device 2 responds to the SNRM command by returning an IrDA UA response.

Next, the IrSimple frame receiving section 610b and the IrDA frame receiving section 620b wait for a response from the secondary station. If there is a response (YES in step 7), the IrSimple BOF detecting section 611b detects the BOF field of the inbound frame, and the IrSimple EOF detecting section 612b detects the EOF field of the inbound frame. The IrSimple error detecting section 613b determines whether the inbound frame contains a transmission error and outputs extracted data to the IrSimple inbound frame field analyzing section 640b. Alternatively, the IrDA BOF detecting section 621b detects the BOF field of the inbound frame, and the IrDA EOF detecting section 622b detects the EOF field of the inbound frame. The IrDA error detecting section 623b determines whether the inbound frame contains a transmission error and outputs extracted data to the IrDA inbound frame field analyzing section 650b.

The IrSimple inbound frame field analyzing section 640b and the IrDA inbound frame field analyzing section 650b individually examine whether or not the received data contains an upper user data field. Results are communicated to the communications protocol determining section 630b. From the results, the communications protocol determining section 630b determines which protocol was used to send the response frame (steps 9 and 10).

On the other hand, if there is no response for a predetermined period (NO in step 7), the protocol switching section 113 determines whether or not the recurrences of steps 1 to 7 are finished (step 8). If they are (YES in step 8), the connection routine is ended without discovering a secondary station. The recurrences may be considered to be finished when the recurrences have reached a specified count or by measuring with the timer 120 the time elapsed since the connection routine was started (for example, the recurrences are allowed only 5 seconds after the start of the connection routine). If the recurrences are not finished (NO in step 8), the protocol switching section 113 again activates the IrSimple-IrLAP control section 112 and has the connection control section 1121 transmit an SNRM command specified in the IrSimple protocols (step 1).

If there is a response to the SNRM command specified in the IrSimple protocols from the communications device 2 (YES in step 2 or 7), the communications protocol determining section 630b determines, from the result communicated from the IrSimple inbound frame field analyzing section 640b or the IrDA inbound frame field analyzing section 650b, whether or not the received response frame is a UA response which complies with IrSimple (step 9). If the response frame is a UA response which complies with IrSimple (YES in step 9), it means that the device 1b has discovered a communications device (secondary station) 2 supporting IrSimple. The communications device 1b then enters an IrSimple communications mode. The decision is communicated to the protocol control section 110, thereby completing the connecting of all the IrLAP, IrLMP, IrSMP, and OBEX layers and also completing the connection routine.

On the other hand, if the response frame is not a UA response which complies with IrSimple (NO in step 9), the section 630b determines whether or not the received response frame is a UA response which complies with IrDA (step 10). If the response frame is a UA response which complies with IrDA (YES in step 10), it means that the device 1b has discovered a communications device (secondary station) 2 supporting IrDA. The decision is communicated to the protocol control section 110, thereby completing connecting up to the IrLAP layer using the IrDA protocols.

If the response frame is not a UA response which complies with IrDA (NO in step 10), the device 1b ends the connection routine without establishing a connection because there is no communications device 2 supporting IrSimple or IrDA.

If there is a response to the IrDA XID command from the communications device 2 (YES in step 4), the station discovery control section 1111 transmits an XID-End command specified in the IrDA protocols (step 11), notifying secondary stations located within the communications range of the device 1b of the end of the XID command transmissions. That means the communications device 1b has discovered a communications device 2 supporting IrDA as a secondary station, thereby entering an IrDA communications mode. With the station discovery having been completed, next, a connection routine is carried out for the IrLAP layer using the IrDA protocols (step 12), thereby completing connecting up to the IrLAP layer and also the connection routine.

When the communications device 1b connects to the communications device (secondary station) 2, it implements the same connection routine as the communications device 1a did in embodiment 1, no matter whether the communications device 2: (1) supports IrDA, but returns a UA response to a broadcast frame (illegal response sender device); (2) strictly adheres to the IrSimple protocol specifics; or (3) strictly adheres only to the IrDA protocol specifics.

As discussed above, in the configuration of the present embodiment, the communications protocol determining section 630b determines a communications protocol from the results communicated from the IrSimple inbound frame field analyzing section 640b and the IrDA inbound frame field analyzing section 650b. In other words, the configuration of the present embodiment includes the features of embodiment 1 and in addition, analyzes the structure of the inbound frame and examines whether the frame contains predetermined fields.

Hence, the present embodiment can detect communications protocols from both the transfer rate and the frame structure analysis, and therefore is more reliable in determining a communications protocol than embodiment 1.

In the present embodiment, the additional frame structure analysis enables a more reliable decision on communications protocols even if the device 1b cannot make a correct decision on communications protocols by relying solely on the transfer rate because of poor channel transmission quality and resultant failure in the detection of the BOF or EOF field in the received frame.

### Embodiment 3

Embodiment 2 included the IrSimple inbound frame field analyzing section 640b and the IrDA inbound frame field analyzing section 650b to analyze the frame structure of the received response. Alternatively, there may be provided only one member for the analysis of the frame structure. The member analyzes the frame structure of an incoming response regardless of whether it was sent using the IrSimple protocols or the IrDA protocols.

The following will describe the present embodiment in reference to FIGS. 9 to 11, and 4. For convenience, members of the present embodiment that have the same arrangement and function as members of embodiments 1 and 2, and that are mentioned in that embodiment are indicated by the same reference numerals and description thereof is omitted.

### Overall Structure of Communications System

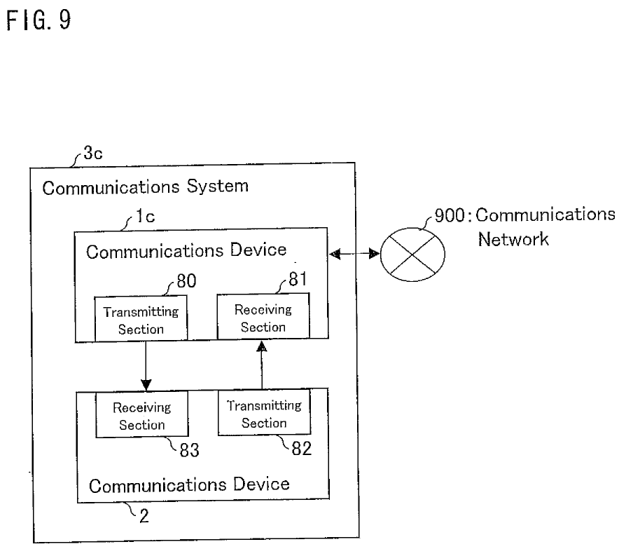

Now, referring to FIG. 9, a communications system 3c will be described which incorporates a communications device of the present embodiment. FIG. 9 is a block diagram illustrating the configuration of the communications system 3c which incorporates a communications device 1c which is a communications device of the present embodiment and a communications device 2. Similarly to the communications device 1a, the communications device 1c may be, for example, a digital camera or a mobile phone. The device 1c is capable of communicating with the communications device 2. In addition, the communications device 1c may be capable of communicating with an external communications device (not shown) over the communications network 900.

### Configuration of Communications Device

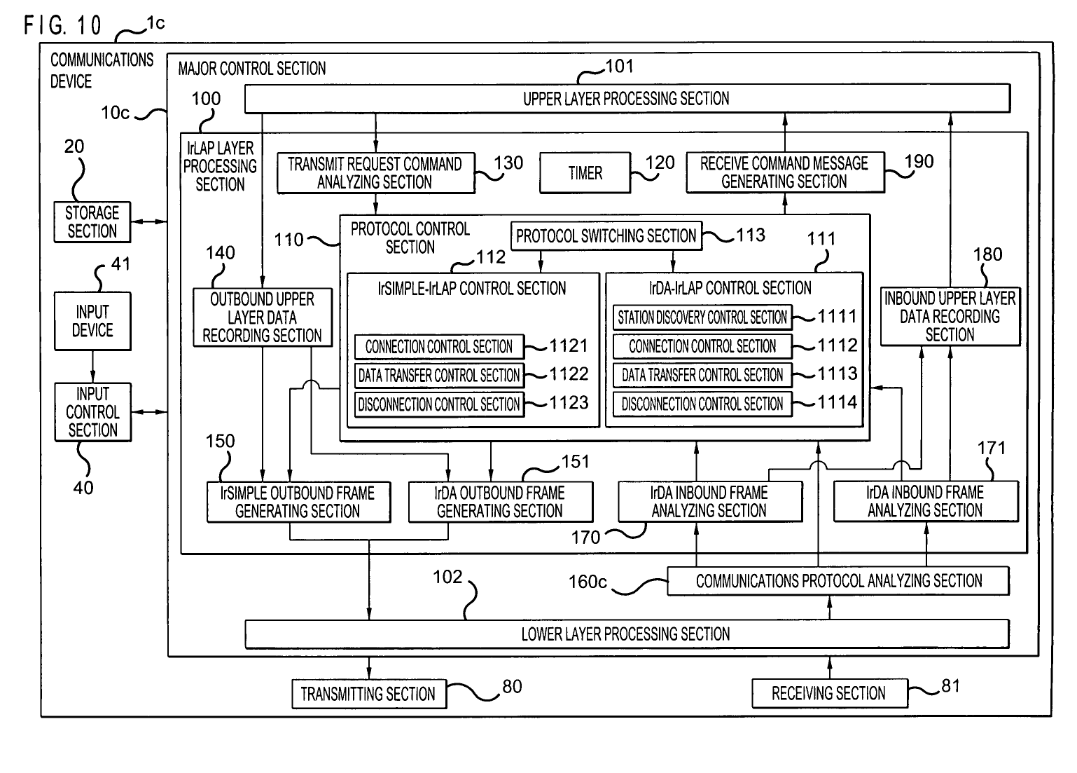

Next will be described the configuration of the communications device 1c in reference to FIG. 10 which is a block diagram illustrating the configuration of the communications device 1c. The communications device 1c includes almost the same members as the communications device 1a of embodiment 1 as shown in FIG. 10: it includes a major control section 10c in place of the major control section 10a. The major control section 10c includes almost the same members as the major control section 10a of embodiment 1: it includes a communications protocol analyzing section 160c in place of the communications protocol analyzing section 160a.

The communications protocol analyzing section 160c will be described in detail in reference to FIG. 11 which is a block diagram illustrating the configuration of the communications protocol analyzing section 160c. Referring to FIG. 11, the communications protocol analyzing section 160c includes an IrSimple frame receiving section 610c, an IrDA frame receiving section 620c, a communications protocol determining section 630c, and an inbound frame structure analyzing section 640c. The inbound frame structure analyzing section 640c includes an inbound frame field analyzing section 641c and an inbound frame output selector section 642c.

After the IrSimple-IrLAP control section 112 transmits an SNRM command (connect request command), the IrSimple frame receiving section 610c becomes ready to receive a response returned at 115.2 kbps. The IrSimple frame receiving section 610c receives an IrSimple frame returned at 115.2 kbps and analyzes it. The frame received by the IrSimple frame receiving section 610c has the format shown in FIG. 49 as described earlier in the Background of the Invention section. In other words, the inbound frame includes a BOF, an IrLAP data, an FCS, and an EOF field. To handle these fields, the IrSimple frame receiving section 610c includes an IrSimple BOF detecting section 611c, an IrSimple EOF detecting section 612c, and an IrSimple error detecting section 613c.

The IrSimple BOF detecting section 611c detects and removes the BOF field from the received frame. Likewise, the IrSimple EOF detecting section 612c detects and removes the EOF field from the received frame. If the BOF field and the EOF field are detected, the IrSimple error detecting section 613c determines from the value in the FCS field of the received frame whether or not the received data contains a transmission error. If no error is detected, the IrSimple error detecting section 613c reads the IrLAP data field and outputs the data readout to the inbound frame field analyzing section 641c.

Likewise, the IrDA frame receiving section 620c receives an IrDA frame returned at 9,600 bps and analyzes it. To implement the reception and analysis, the section 620c includes an IrDA BOF detecting section 621c, an IrDA EOF detecting section 622c, and an IrDA error detecting section 623c. The IrDA BOF detecting section 621c detects and removes the BOF field from the received frame. Likewise, the IrDA EOF detecting section 622c detects and removes the EOF field from the received frame.

If the BOF field and the EOF field are detected, the IrDA error detecting section 623c determines from the value in the FCS field of the received frame whether or not the received data contains a transmission error. If no error is detected, the IrDA error detecting section 623c reads the IrLAP data field and outputs the data readout to the inbound frame field analyzing section 641c.

The inbound frame field analyzing section 641c analyzes the structure of the data forwarded from the IrSimple error detecting section 613c or the IrDA error detecting section 623c to examine whether the data contains predetermined fields, and communicates a result to the communications protocol determining section 630c. The inbound frame field analyzing section 641c simply passes the received data on to the inbound frame output selector section 642c.

The inbound frame field analyzing section 641c examines whether or not the data contains predetermined fields by substantially the same method as the IrSimple inbound frame field analyzing section 640b and the IrDA inbound frame field analyzing section 650b examine whether or not the data contains predetermined fields in embodiment 2. Specifically, the inbound frame field analyzing section 641c examines whether or not the received data contains an upper user data field. If an upper user data field is detected, the detection is communicated to the communications protocol determining section 630c. On the other hand, if no upper user data field is detected, the failure of detection is communicated to the communications protocol determining section 630c.

If the inbound frame field analyzing section 641c informs that an upper user data field is detected, the communications protocol determining section 630c determines that the received frame is a UA response frame which complies with IrSimple. On the other hand, if the inbound frame field analyzing section 641c informs that no upper user data field is detected, the communications protocol determining section 630c determines that the received frame is a UA response frame which complies with IrDA. This information is forwarded to the inbound frame output selector section 642c and the protocol control section 110.

The inbound frame output selector section 642c switches the output destination of the data forwarded from the inbound frame field analyzing section 641c according to the information forwarded from the communications protocol determining section 630c. Specifically, if the information indicates that the response is a UA response frame which complies with IrSimple, the section 642c outputs the received data to the IrSimple inbound frame analyzing section 170. On the other hand, if the information indicates that the response is a UA response frame which complies with IrDA, the section 642c outputs the received data to the IrDA inbound frame analyzing section 171.

### Connection Routine for Communications Device 1c and Communications Device 2

Next, referring to FIG. 4, a routine will be described by which the communications device (primary station) 1c connects to a communications device 2 located within the communications range of the communications device 1c. FIG. 4 is a flow chart illustrating a process of the communications device 1c switching between connection routines in accordance with a response from the secondary station.

As the operator of the communications device 1c enters an infrared communications initiate command on the input device 41, the protocol switching section 113 first activates the IrSimple-IrLAP control section 112 and has the connection control section 1121 transmit the SNRM command specified in the IrSimple protocols (step 1).

Next, the IrSimple frame receiving section 61c and the IrDA frame receiving section 620c wait for a response from the secondary station. If there is a response (YES in step 2), the IrSimple BOF detecting section 611c detects the BOF field of the inbound frame, and the IrSimple EOF detecting section 612c detects the EOF field of the inbound frame. The IrSimple error detecting section 613c determines whether the inbound frame contains a transmission error and outputs extracted data to the inbound frame field analyzing section 641c. Alternatively, the IrDA BOF detecting section 621c detects the EOF field of the inbound frame, and the IrDA EOF detecting section 622c detects the BOF field of the inbound frame. The IrDA error detecting section 623c determines whether the inbound frame contains a transmission error and outputs extracted data to the inbound frame field analyzing section 641c.

The inbound frame field analyzing section 641c examines whether or not the received data contains an upper user data field and communicates a result to the communications protocol determining section 630c. From the result, the communications protocol determining section 630c determines which protocol was used to send the response frame (steps 9 and 10).

On the other hand, if there is no response for a predetermined period (NO in step 2), the protocol switching section 113 activates the IrDA-IrLAP control section 111, replacing the IrSimple-IrLAP control section 112, and has the station discovery control section 1111 transmit an XID command (SlotNumber 0x00) (step 3), to see whether or not there is a secondary station which supports IrDA within the communications range of the communications device 1c. The predetermined period here is, for example, a period ranging from 50 ms to 85 ms as specified in the IrSimple protocols.

If the communications device 2 supports IrDA, the communications device 2, as the secondary station, responds to the XID command by returning an XID response. In addition, the communications device 2 is set up, if strictly adhering to both the IrDA and IrSimple protocol specifics, not to respond to the XID command (SlotNumber 0x00), to give priority to connecting using the IrSimple protocols (see non-patent document 6). Hence, if the communications device 2 strictly adheres to both the IrDA and IrSimple protocol specifics, it returns no response frame.

The IrDA frame receiving section 620c waits for a response from the secondary station. If there is a response (YES in step 4), it means that the device 1c has discovered a communications device 2 supporting IrDA. The IrDA-IrLAP control section 111 negotiates a connection using the IrDA protocols (steps 11 to 12). On the other hand, if there is no response for a predetermined period (NO in step 4), the station discovery control section 1111 transmits an XID-End command specified in the IrDA protocols (step 5), notifying secondary stations located within the communications range of the device 1c of the end of the XID command transmissions.

The protocol switching section 113 activates the IrSimple-IrLAP control section 112, replacing the IrDA-IrLAP control section 111, and has the connection control section 1121 transmit an SNRM command specified in the IrSimple protocols (step 6). If the communications device 2 supports IrSimple, the communications device 2, as the secondary station, responds to the SNRM command by returning an IrSimple UA response. On the other hand, if the communications device 2 strictly adheres to both the IrDA and IrSimple protocol specifics, the device 2 returns an IrSimple UA response to give priority to connecting using the IrSimple protocols. If the communications device 2 is an illegal response sender device, the device 2 responds to the SNRM command by returning an IrDA UA response.

Next, the IrSimple frame receiving section 610c and the IrDA frame receiving section 620c wait for a response from the secondary station. If there is a response (YES in step 7), the IrSimple BOF detecting section 611c detects the BOF field of the inbound frame, and the IrSimple EOF detecting section 612c detects the EOF field of the inbound frame. The IrSimple error detecting section 613c determines whether the inbound frame contains a transmission error and outputs extracted data to the inbound frame field analyzing section 641c. Alternatively, the IrDA BOF detecting section 621c detects the EOF field of the inbound frame, and the IrDA EOF detecting section 622c detects the BOF field of the inbound frame. The IrDA error detecting section 623c determines whether the inbound frame contains a transmission error and outputs extracted data to the inbound frame field analyzing section 641c.

The inbound frame field analyzing section 641c examines whether or not the received data contains an upper user data field and communicates a result to the communications protocol determining section 630c. From the result, the communications protocol determining section 630c determines which protocol was used to send the response frame (steps 9 and 10).

On the other hand, if there is no response for a predetermined period (NO in step 7), the protocol switching section 113 determines whether or not the recurrences of steps 1 to 7 are finished (step 8). If they are (YES in step 8), the connection routine is ended without discovering a secondary station. The recurrences may be considered to be finished when the recurrences have reached a specified count or by measuring with the timer 120 the time elapsed since the connection routine was started (for example, the recurrences are allowed only 5 seconds after the start of the connection routine). If the recurrences are not finished (NO in step 8), the protocol switching section 113 again activates the IrSimple-IrLAP control section 112 and has the connection control section 1121 transmit an SNRM command specified in the IrSimple protocols (step 1).

If there is a response to the SNRM command specified in the IrSimple protocols from the communications device 2 (YES in step 2 or 7), the communications protocol determining section 630c determines, from the result communicated from the inbound frame field analyzing section 641c, whether or not the received response frame is a UA response which complies with IrSimple (step 9). If the response frame is a UA response which complies with IrSimple (YES in step 9), it means that the device 1c has discovered a communications device (secondary station) 2 supporting IrSimple. The communications device 1c then enters an IrSimple communications mode. The decision is communicated to the protocol control section 110, thereby completing the connecting of all the IrLAP, IrLMP, IrSMP, and OBEX layers and also completing the connection routine.

On the other hand, if the response frame is not a UA response which complies with IrSimple (NO in step 9), the section 630c determines whether or not the received response frame is a UA response which complies with IrDA (step 10). If the response frame is a UA response which complies with IrDA (YES in step 10), it means that the device 1c has discovered a communications device (secondary station) 2 supporting IrDA. The decision is communicated to the protocol control section 110, thereby completing connecting up to the IrLAP layer using the IrDA protocols.

If the response frame is not a UA response which complies with IrDA (NO in step 10), the device 1c ends the connection routine without establishing a connection because there is no communications device 2 supporting IrSimple or IrDA.

If there is a response to the IrDA XID command from the communications device 2 (YES in step 4), the station discovery control section 1111 transmits an XID-End command specified in the IrDA protocols (step 11), notifying secondary stations located within the communications range of the device 1c of the end of the XID command transmissions. That means the communications device 1c has discovered a communications device 2 supporting IrDA as a secondary station, thereby entering an IrDA communications mode. With the station discovery having been completed, next, a connection routine is carried out for the IrLAP layer using the IrDA protocols (step 12), thereby completing connecting up to the IrLAP layer and also the connection routine.

When the communications device 1c connects to the communications device (secondary station) 2, it implements the same connection routine as the communications device 1a did in embodiment 1, no matter whether the communications device 2: (1) supports IrDA, but returns a UA response to a broadcast frame (illegal response sender device); (2) strictly adheres to the IrSimple protocol specifics; or (3) strictly adheres only to the IrDA protocol specifics.

As discussed above, the present embodiment can detect communications protocols from both the transfer rate and the frame structure analysis, and therefore is more reliable in determining a communications protocol than embodiment 1.

In the present embodiment, the additional frame structure analysis enables a more reliable decision on communications protocols even if the device 1c cannot make a correct decision on communications protocols by relying solely on the transfer rate because of poor channel transmission quality and resultant failure in the detection of the BOF or EOF field in the received frame.

### Embodiment 4

Embodiment 1 distinguished between communications protocols by the transfer rate of an incoming response. The present embodiment makes the same distinction using circuitry as described below.

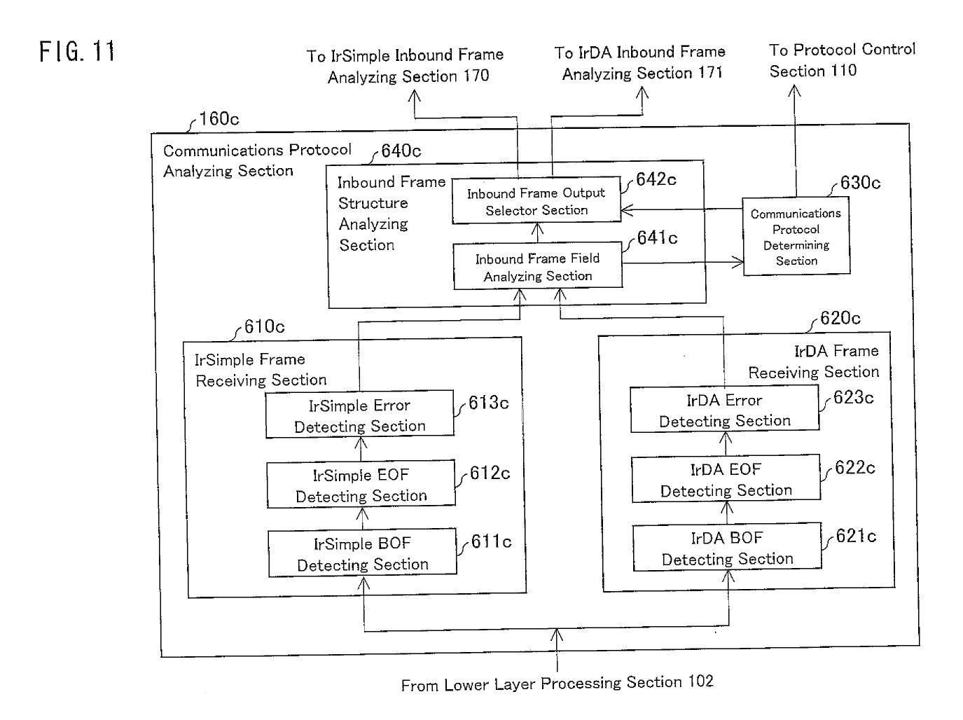

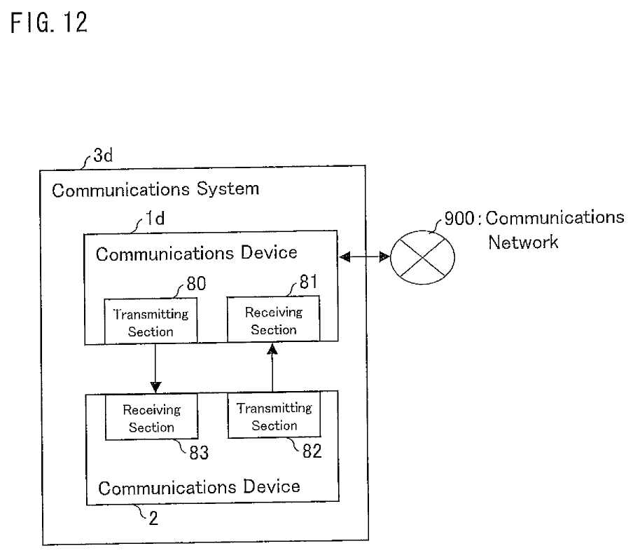

The present embodiment will be described in reference to FIGS. 12 to 16. For convenience, members of the present embodiment that have the same arrangement and function as members of embodiments 1 to 3, and that are mentioned in that embodiment are indicated by the same reference numerals and description thereof is omitted.

### Overall Structure of Communications System

Now, referring to FIG. 12, a communications system 3d will be described which incorporates a communications device of the present embodiment. FIG. 12 is a block diagram illustrating the configuration of the communications system 3d which incorporates a communications device 1d which is a communications device of the present embodiment and a communications device 2. Similarly to the communications device 1a, the communications device 1d may be, for example, a digital camera or a mobile phone. The device 1d is capable of communicating with the communications device 2. The communications device 1d may be capable of communicating with an external communications device (not shown) over the communications network 900.

### Configuration of Communications Device

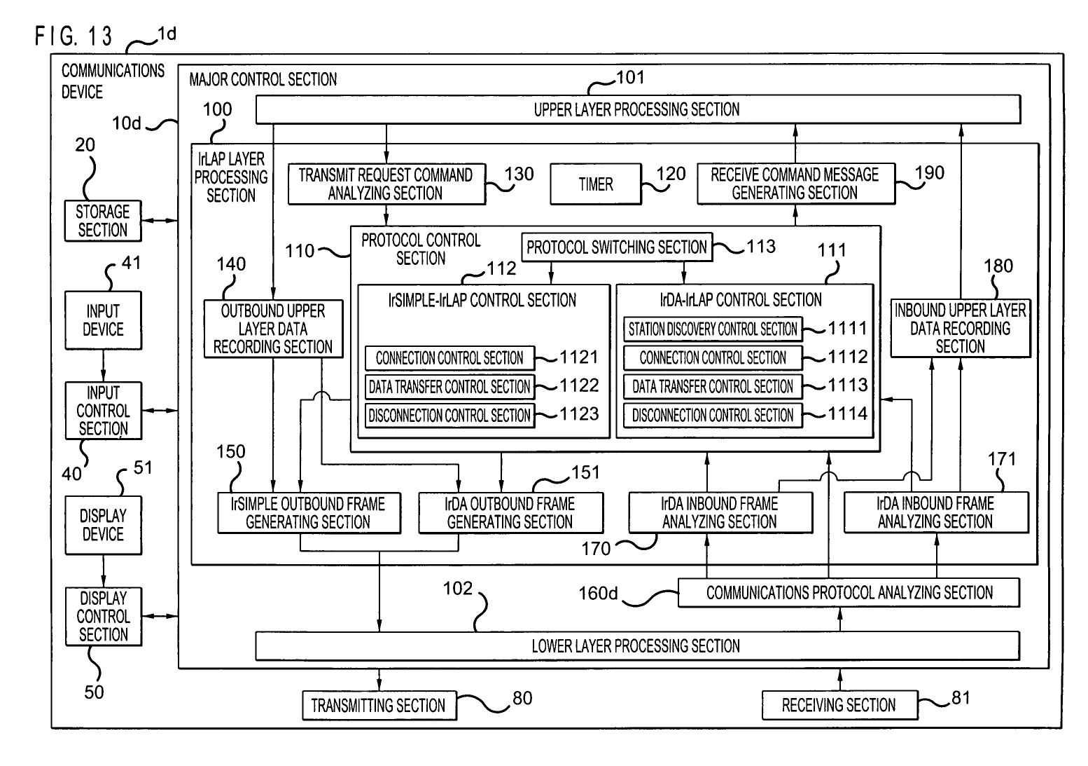

Next will be described the configuration of the communications device 1d in reference to FIG. 13 which is a block diagram illustrating the configuration of the communications device 1d. The communications device 1d includes almost the same members as the communications device 1a of embodiment 1 as shown in FIG. 13: it includes a major control section 10d in place of the major control section 10a. the communications device 1d further includes a display control section 50 and a display device 51.

The display device 51 produces a display from the information transmitted from the display control section 50. The display device 51 is, for example, built around an LCD (liquid crystal display). The display made on the display device 51 may be an operation menu for the operator of the communications device 1d, an image which the operator of the communications device 1d wants to transfer, and an indication of the transfer rate of an inbound frame obtained from a communications protocol analyzing section 160d (will be detailed later).

The display control section 50 controls the display device 51 and transmits information to the display device 51 as instructed by the major control section 10d.

The major control section 10d includes almost the same members as the major control section 10a of embodiment 1: it includes a communications protocol analyzing section 160d in place of the communications protocol analyzing section 160a.

The communications protocol analyzing section 160d determines from an incoming signal from the lower layer processing section 102 whether an inbound frame was sent using IrSimple or IrDA. The section 160d also determines a reception rate and passes received data on to the IrSimple inbound frame analyzing section 170 and the IrDA inbound frame analyzing section 171.

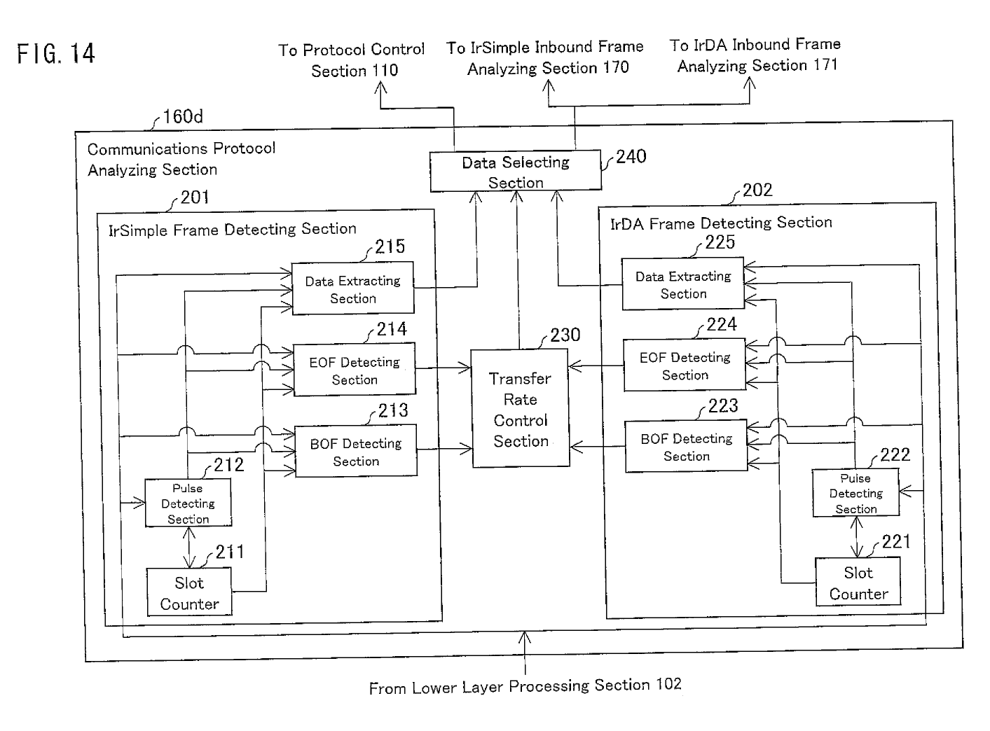

Next, the communications protocol analyzing section 160d will be described in detail in reference to FIG. 14 which is a block diagram illustrating the configuration of the communications protocol analyzing section 160d. The communications protocol analyzing section 160d includes an IrSimple frame detecting section 201, an IrDA frame detecting section 202, a transfer rate control section (transfer rate identifying means) 230, and a data selecting section 240 as shown in FIG. 14.

The IrSimple frame detecting section 201 detects a beginning of frame (BOF) signal in an incoming signal from the lower layer processing section 102 for synchronization and extracts data from that signal. To serve these functions, the IrSimple frame detecting section 201 includes a slot counter 211, a pulse detecting section (second pulse detecting means) 212, a BOF detecting section 213, an EOF detecting section 214, and a data extracting section 215.

The slot counter 211 counts slots at a predetermined cycle. The counter 211 starts counting at a cycle of about 8.6 μs (equal to the slot length at 115.2 kbps) if it is informed by the pulse detecting section 212 that a pulse has been received when the counter reading is 0. The counter 211 sends its reading to the pulse detecting section 212, the BOF detecting section 213, the EOF detecting section 214, and the data extracting section 215.

The pulse detecting section 212 regards each increment of the reading of the slot counter 211 as representing a new slot. The section 212 determines whether or not the incoming signal from the lower layer processing section 102 contains a pulse in each slot and communicates a result to the BOF detecting section 213 and the EOF detecting section 214. In addition, if the section 212 receives an incoming signal from the lower layer processing section 102 when the counter reading is 0, it informs the slot counter 211 that a start bit pulse has been received. The configuration of the pulse detecting section 212 will be detailed later.

The BOF detecting section 213 regards each increment of the reading of the slot counter 211 as representing a new slot and detects a BOF field (containing 0xC0) based on the presence/absence of a pulse transmitted from the pulse detecting section 212. If a BOF is detected, the transfer rate control section 230 is informed of the detection.

The EOF detecting section 214 regards each increment of the reading of the slot counter 211 as representing a new slot and detects an EOF (containing 0xC1) based on the presence/absence of a pulse transmitted from the pulse detecting section 212. If an EOF is detected, the transfer rate control section 230 is informed of the detection.

The data extracting section 215 regards each increment of the reading of the slot counter 211 as representing a new slot and extracts data based on the presence/absence of a pulse transmitted from the pulse detecting section 212. The section 215 then transmits the extracted data to the data selecting section 240.

The IrDA frame detecting section 202 detects a beginning of frame (BOF) signal in an incoming signal from the lower layer processing section 102 for synchronization and extracts data from that signal. To serve these functions, the IrDA frame detecting section 202 includes a slot counter 221, a pulse detecting section (first pulse detecting means) 222, a BOF detecting section 223, an EOF detecting section 224, and a data extracting section 225.

The slot counter 221 counts slots at a predetermined cycle. The counter 221 starts counting at a cycle of about 100 μs (equal to the slot length at 9,600 bps) if it is informed by the pulse detecting section 222 that a pulse has been received when the counter reading is 0. The counter 221 sends its reading to the pulse detecting section 222, the BOF detecting section 223, the EOF detecting section 224, and the data extracting section 225.

The pulse detecting section 222 regards each increment of the reading of the slot counter 221 as representing a new slot. The section 222 determines whether or not the incoming signal from the lower layer processing section 102 contains a pulse in each slot and communicates a result to the BOF detecting section 223 and the EOF detecting section 234. In addition, if the section 222 receives an incoming signal from the lower layer processing section 102 when the counter reading is 0, it informs the slot counter 221 that a start bit pulse has been received. The configuration of the pulse detecting section 222 will be detailed later.

The BOF detecting section 223 regards each increment of the reading of the slot counter 221 as representing a new slot and detects a BOF field (containing 0xC0) based on the presence/absence of a pulse transmitted from the pulse detecting section 222. If a BOF is detected, the transfer rate control section 230 is informed of the detection.

The EOF detecting section 224 regards each increment of the reading of the slot counter 221 as representing a new slot and detects an EOF (containing 0xC1) based on the presence/absence of a pulse transmitted from the pulse detecting section 222. If an EOF is detected, the transfer rate control section 230 is informed of the detection.

The data extracting section 225 regards each increment of the reading of the slot counter 221 as representing a new slot and extracts data based on the presence/absence of a pulse transmitted from the pulse detecting section 222. The section 225 then transmits the extracted data to the data selecting section 240.

The transfer rate control section 230 determines that the transfer rate of the incoming frame is 115.2 kbps if it is informed by the BOF detecting section 213 informs of the detection of a BOF (or if it is informed by the EOF detecting section 214 of the detection of an EOF) and that the transfer rate of the incoming frame is 9,600 bps if it is informed by the BOF detecting section 223 of the detection of a BOF (or if it is informed by the EOF detecting section 224 of the detection of an EOF). The decision is communicated to the data selecting section 240.

The data selecting section 240, if informed by the transfer rate control section 230 of the transfer rate of 115.2 kbps, selectively outputs data from the data extracting section 215 to the IrSimple inbound frame analyzing section 170. On the other hand, if informed by the transfer rate control section 230 of the transfer rate of 9,600 bps, the data selecting section 240 selectively outputs data from the data extracting section 225 to the IrDA inbound frame analyzing section 171. The section 240 also informs the protocol control section 110 of the data selection. Based on the information, the protocol control section 110 controls the connection routine after the reception of the response in accordance with either IrSimple or IrDA.

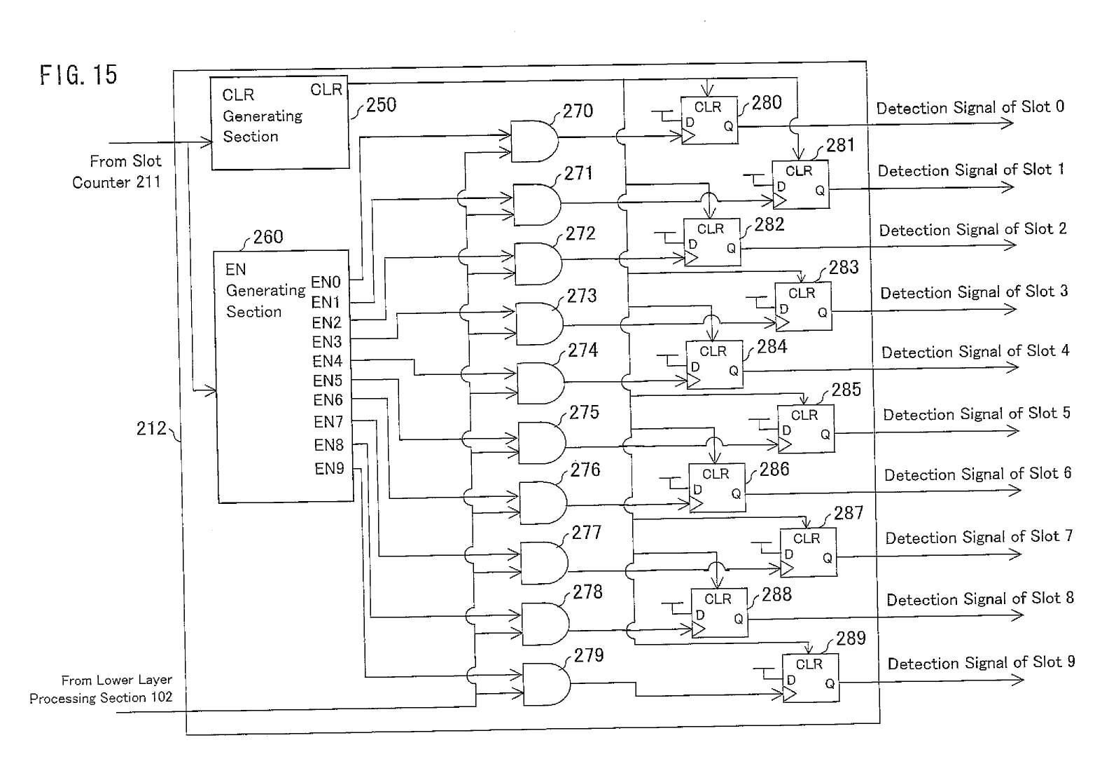

Next will be described the pulse detecting section 212 and the pulse detecting section 222 in detail in reference to FIG. 15 which is a block diagram illustrating the configuration of the pulse detecting section 212. Description of the pulse detecting section 222 is omitted because it has the same configuration as the pulse detecting section 212. As shown in FIG. 15, the pulse detecting section 212 includes a CLR generating section 250, an EN generating section 260, AND gates 270 to 279, and D flip-flops 280 to 289.

The CLR generating section 250 generates a clear signal (hereinafter, “CLR”) which resets the D flip-flops 280 to 289 based on the counter reading obtained from the slot counter 211 and outputs the signals to the D flip-flops 280 to 289. For example, the section 250 generates a CLR when the counter reading reaches 10. This setting reflects the fact that each UART frame is 10-bit long.

The EN generating section 260 regards each increment of the counter reading obtained from the slot counter 211 as representing a new slot, generates signals (EN0 to EN9) which are HIGH only in the associated slots, and outputs the signals respectively to the D flip-flops 280 to 289. For example, when the counter reading is 0, the section 260 generates a HIGH output signal (EN0) only for the AND gate 270 for output to the D flip-flop 280. Thus, the rise of the incoming signal in slot 0 affects only the clock for the D flip-flop 280.

The AND gates 270 to 279 perform logical ANDs between the incoming signal from the lower layer processing section 102 and the output signals (EN0 to EN9) of the EN generating section 260. The results of the operations are fed respectively to the D flip-flops 280 to 289. The rising edges of the incoming signal are output respectively to the D flip-flops 280 to 289 only when the respective output signals EN0 to EN9 are HIGH.

The D flip-flops 280 to 289 are related with the respective slots 0 to 9. The outputs of the D flip-flops 280 to 289 are regarded as signals corresponding respectively to the slots 0 to 9. The D flip-flops 280 to 289 produce HIGH outputs when a rising edge is applied to their clock terminals. Conversely, a HIGH appearing at the output of a D flip-flop indicates that an edge has been detected in the corresponding slot. For example, if the output of the D flip-flop 280 is HIGH, it indicates that a pulse has been detected in slot 0.

FIG. 15 assumes that the incoming signal from the lower layer processing section 102 are positive logic pulses. The signal can however be negative logic pulses. When that is the case, for example, the incoming signal may be inverted or otherwise converted to positive logic pulses before being fed to the D flip-flops 280 to 289.

The pulse detecting section 212 and the pulse detecting section 222 are by no means limited to the configuration explained above. They may be made of members with equivalent functions. In addition, the members may be software-implemented.

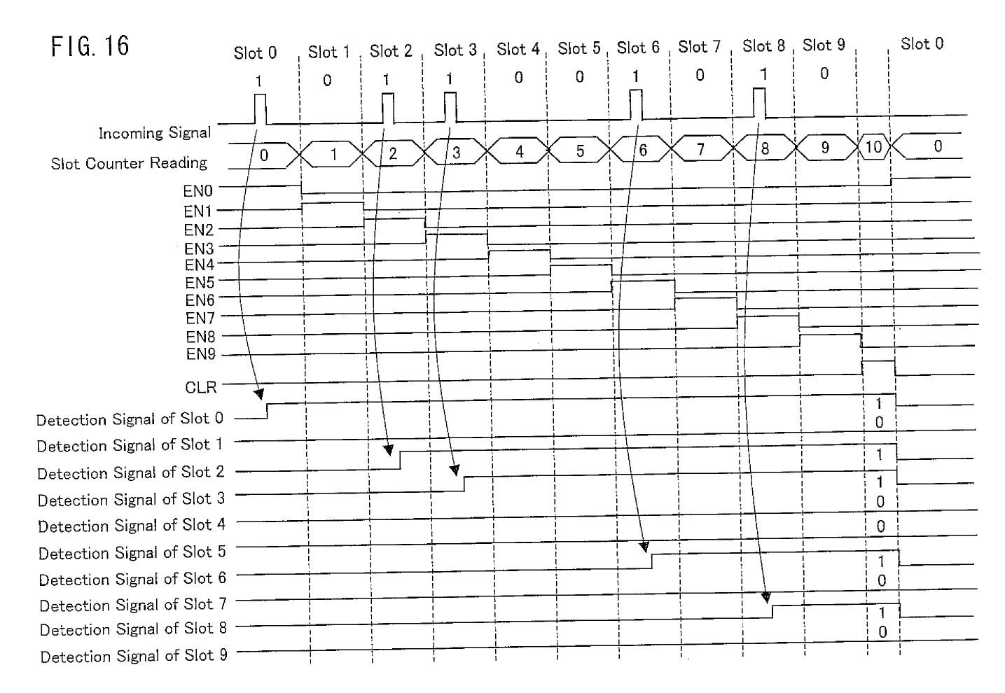

Next will be described in detail the pulse detecting section 212 detecting a pulse in each slot from an incoming signal by way of examples in reference to FIG. 16. FIG. 16 is a timing chart showing the pulse detecting section 212 detecting a pulse in each slot.

The example shown in FIG. 16 assumes that the incoming signal is “1011001010.”

First, as the slot counter 211 is informed by the pulse detecting section 212 that a pulse has been received, it starts counting at a predetermined cycle (initial reading=0). The EN generating section 260 regards each increment of the counter reading as representing a new slot and generates signals (EN0 to EN9) which are HIGH only in the associated slots. The CLR generating section 250 generates a CLR signal when the counter reading reaches 10.

Performing logical ANDs between each rising edge of the incoming signal and the signals EN0 to EN9 produces clock signals for the D flip-flops which go HIGH in the corresponding slots. The slot-specific pulse detection signals stay HIGH until the slot counter reading reaches 10. Thus, the incoming data 1011001010 is detectable from the output signals of the D flip-flops 280 to 289 when the slot counter reading reaches 10.

The description above of an example of the pulse detection by the pulse detecting section 212 applies also to the pulse detection by the pulse detecting section 222.

As described in the foregoing, embodiment 4 correctly determines the transfer rate of the inbound frame owing to the inclusion of the IrSimple frame detecting section 201, the IrDA frame detecting section 202, and the transfer rate control section 230.

The display device 51 may be informed, via the major control section 10d, of the transfer rate of the frame currently being received by the transfer rate control section 230. For example, the display device 51 may produce such a display that the operator of the communications device 1d can recognize that the device 1d was waiting for 115.2-kbps incoming frames, but it received 9,600-bps frames. As another example, if the device 1d detected a 9,600-bps BOF, is receiving subsequent 9,600-bps frames, and unexpectedly detects a 115.2-kbps EOF before detecting a 9,600-bps EOF, the display device 51 may display that situation so that the operator of the communications device 1d can recognize that the device 1d has failed to receive the data at 9,600 bps.

As described in the foregoing, the device 1d, since configured as in the present embodiment, is capable of reliably receiving a response from the communications device 2 by the provision of circuitry which distinguishes between communications protocols in accordance with the transfer rate of the incoming response.

### Embodiment 5

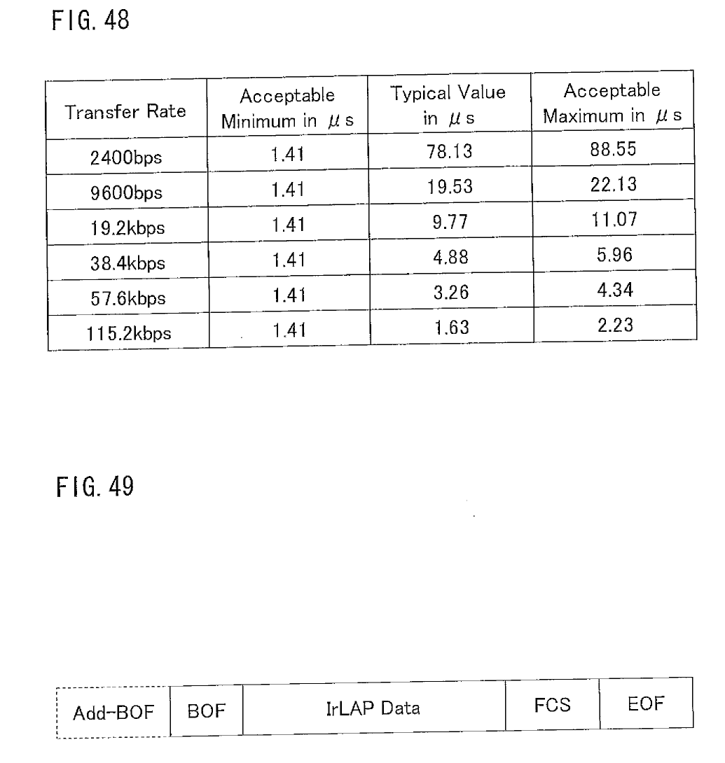

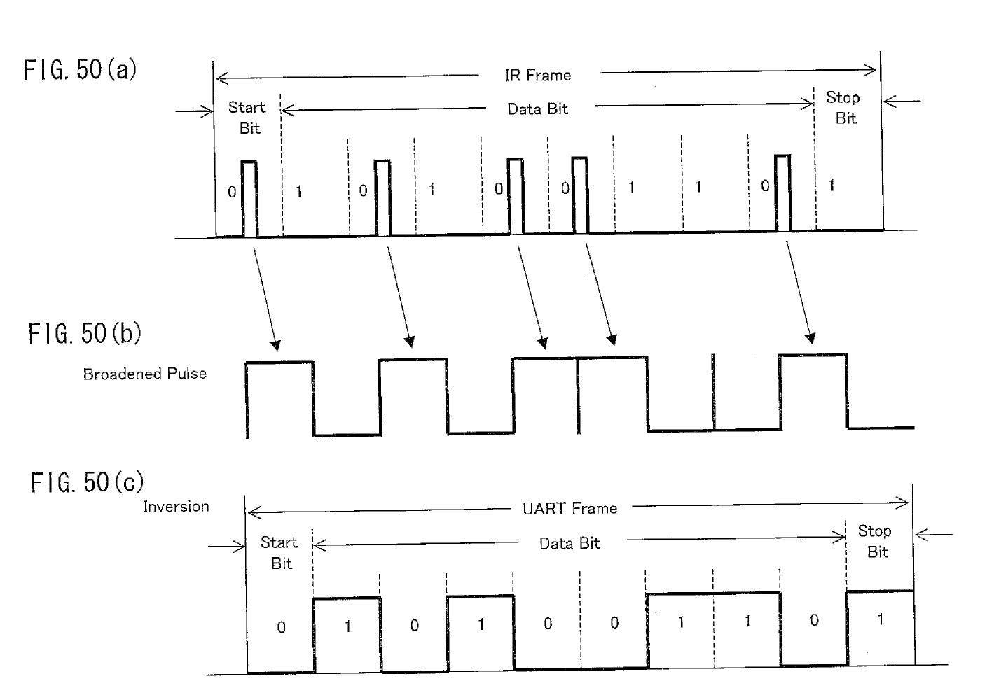

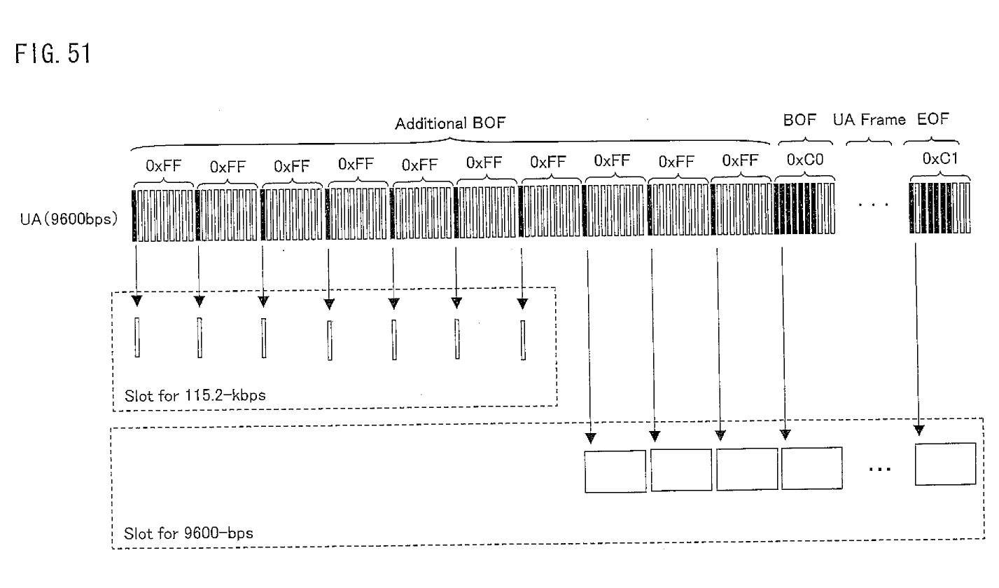

Embodiment 4 detected the rising edge of an incoming pulse regardless of its width. As described earlier in the Background of the Invention section, however, the acceptable minimum pulse width in IrDA-SIR is 1.41 μs at either of the transfer rates (see FIG. 48). That means any pulse narrower than 1.41 μs (hereinafter, “short pulse”) is likely to be a non-IrDA-SIR frame. The pulse could be, for example, noise like an electromagnetic wave which occurs when external disturbing light hits the receiving section 81. The short pulse noise is generally better removed as much as possible to improve communications quality. That requires a mechanism which does not pick up any pulses narrower than 1.41 μs as rising edges. Accordingly, the following embodiment has all the features of embodiment 4 and in addition, a mechanism which removes “short pulses.”

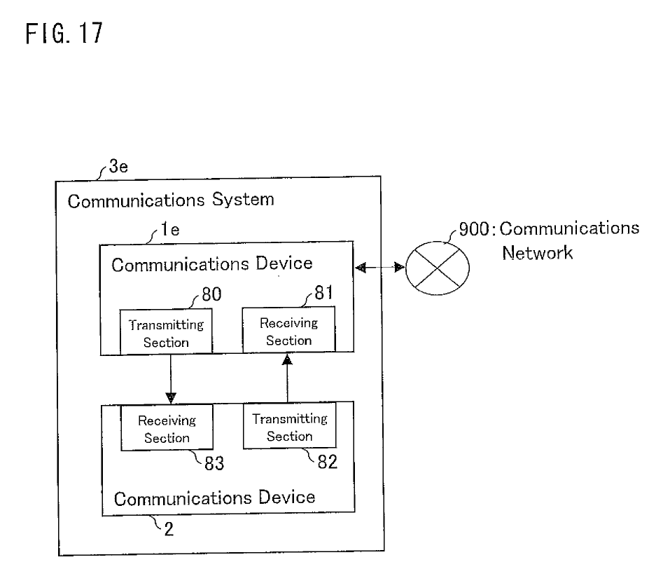

The following will describe the present embodiment in reference to FIGS. 17 to 22. For convenience, members of the present embodiment that have the same arrangement and function as members of embodiments 1 to 4, and that are mentioned in that embodiment are indicated by the same reference numerals and description thereof is omitted.

### Overall Structure of Communications System

Now, referring to FIG. 17, a communications system 3e will be described which incorporates a communications device of the present embodiment. FIG. 17 is a block diagram illustrating the configuration of the communications system 3e which incorporates a communications device 1e which is a communications device of the present embodiment and a communications device 2. Similarly to the communications device 1a, the communications device 1e may be, for example, a digital camera or a mobile phone. The device 1e is capable of communicating with the communications device 2. The communications device 1e may be capable of communicating with an external communications device (not shown) over the communications network 900.

### Configuration of Communications Device

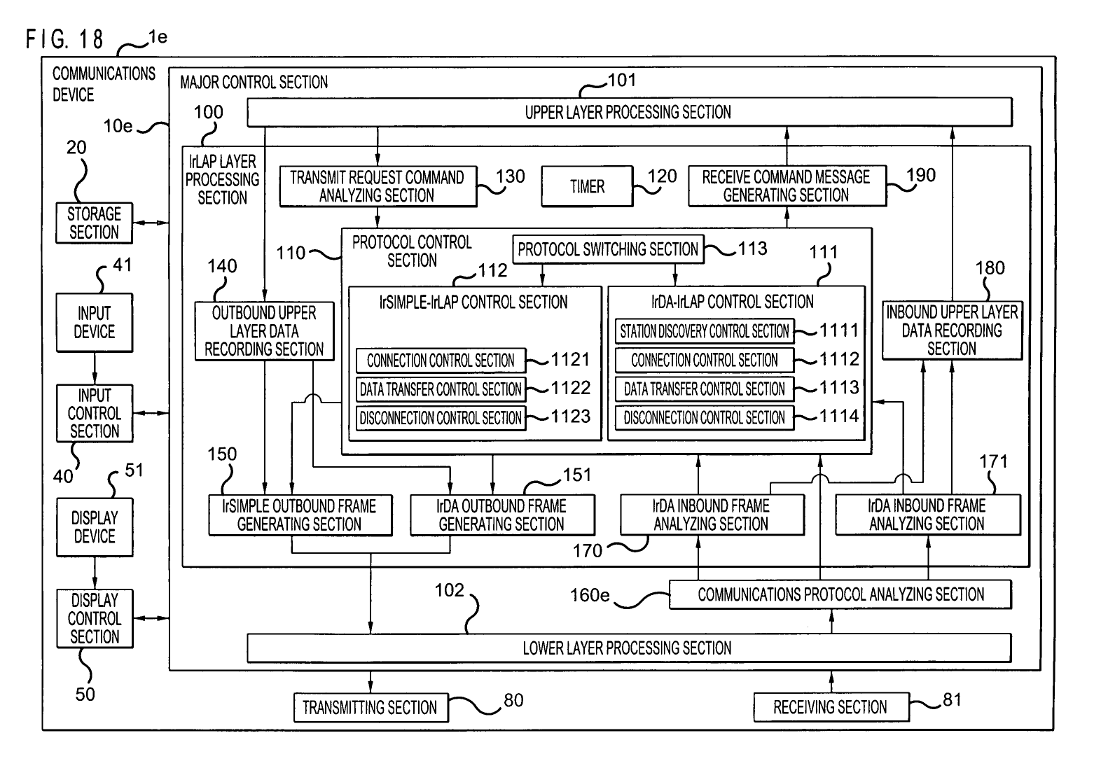

Next will be described the configuration of the communications device 1e in reference to FIG. 18 which is a block diagram illustrating the configuration of the communications device 1e. The communications device 1e includes almost the same members as the communications device 1d of embodiment 4 as shown in FIG. 18: it includes a major control section 10e in place of the major control section 10d. The major control section 10e includes almost the same members as the major control section 10a of embodiment 1: it includes a communications protocol analyzing section 160e in place of the communications protocol analyzing section 160a.

The communications protocol analyzing section 160e determines from an incoming signal from the lower layer processing section 102 whether the incoming frame is an IrSimple or an IrDA frame. The section 160e determines a reception rate and passes incoming data to the IrSimple inbound frame analyzing section 170 and the IrDA inbound frame analyzing section 171.

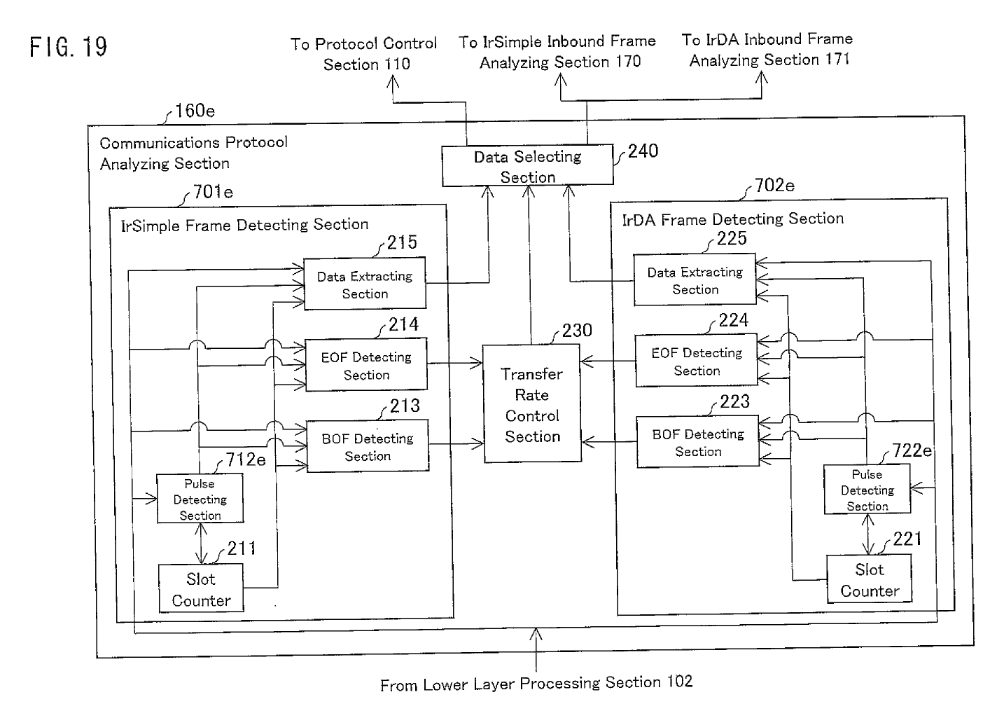

Next, the communications protocol analyzing section 160e will be described in detail in reference to FIG. 19 which is a block diagram illustrating the configuration of the communications protocol analyzing section 160e. As shown in FIG. 19, the communications protocol analyzing section 10e includes almost the same members as the communications protocol analyzing section 160d of embodiment 4: it includes an IrSimple frame detecting section 701e and an IrDA frame detecting section 702e respectively replacing the IrSimple frame detecting section 201 and the IrDA frame detecting section 202.

The IrSimple frame detecting section 701e includes almost the same members as the IrSimple frame detecting section 201: it includes a pulse detecting section (second pulse detecting means) 712e in place of pulse detecting section 212.

The IrDA frame detecting section 702e includes almost the same members as the IrDA frame detecting section 202: it includes a pulse detecting section (first pulse detecting means) 722e in place of the pulse detecting section 222.

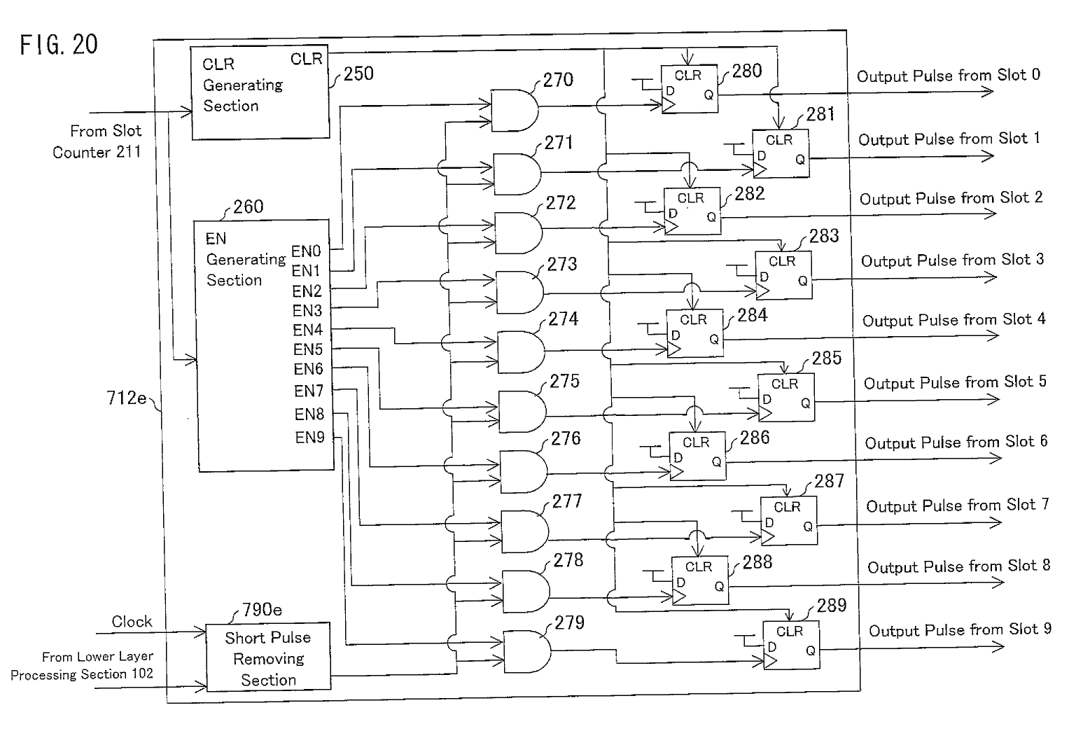

Next will be described the pulse detecting section 712e and the pulse detecting section 722e in detail in reference to FIG. 20 which is a block diagram illustrating the configuration of the pulse detecting section 712e. Description of the pulse detecting section 722e is omitted because it has the same configuration as the pulse detecting section 712e. As shown in FIG. 20, the pulse detecting section 712e includes almost the same members as the pulse detecting section 212 of embodiment 4; it also includes a short pulse removing section 790e.

The short pulse removing section 790e removes pulses with widths shorter than a predetermined value so that the short pulses do not reach subsequent stages. Accordingly, the subsequently located AND gates 270 to 279 perform logical ANDs between the incoming signal, minus the short pulses, and the output signals (EN0 to EN9) of the EN generating section 260, thereby feeding the results to the respective D flip-flops 280 to 289. Thus, no rising edges of the short pulses are output to the D flip-flops 280 to 289.

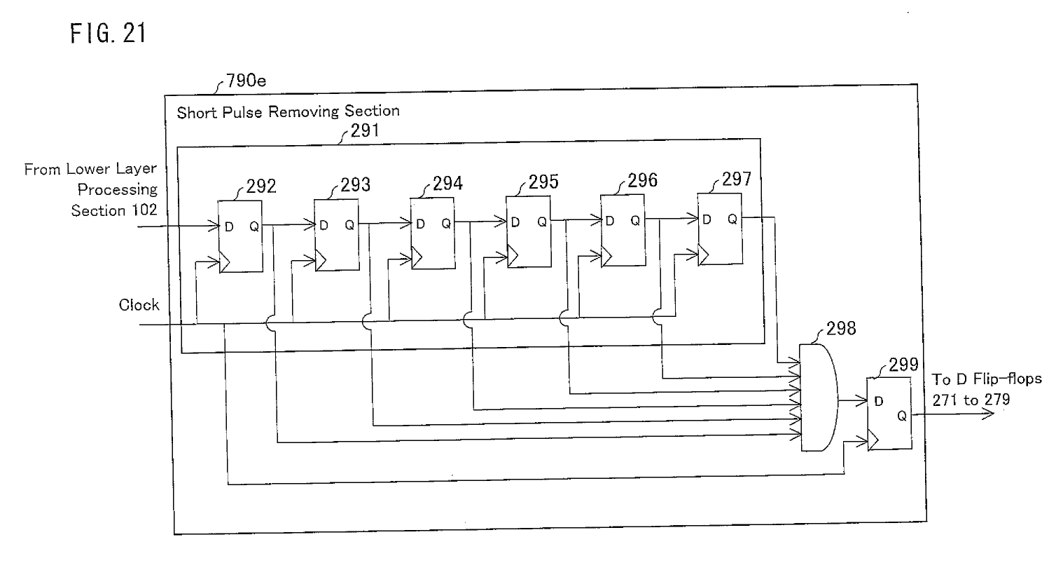

Next, the short pulse removing section 790e will be described in detail in reference to FIG. 21 which is a block diagram illustrating the configuration of the short pulse removing section 790e. As shown in FIG. 21, the short pulse removing section 790e includes a shift register 291, an AND gate 298, and a D flip-flop 299.

The shift register 291 contains 6-staged D flip-flops 292 to 297. An incoming signal from the lower layer processing section 102 is fed to, and latched by, the D flip-flop 292 according to the clock (for example, at 5 MHz). The signal is then passed on to the succeeding D flip-flop 293 on an immediately following rise of the clock. Next, the signal is latched by the D flip-flop 293 and then passed on to the succeeding D flip-flop 294 on an immediately following rise of the clock. Next, the signal is latched by the D flip-flop 294 and then passed on to the succeeding D flip-flop 295 on an immediately following rise of the clock. Next, the signal is latched by the D flip-flop 295 and then passed on to the succeeding D flip-flop 296 on an immediately following rise of the clock. Next, the signal is latched by the D flip-flop 296 and then passed on to the succeeding D flip-flop 297 on an immediately following rise of the clock.

The AND gate 298 performs logical ANDs among the output signals of the D flip-flops 292 to 297. The results of the operations are fed to the D flip-flop 299.

The output of the D flip-flop 299 carries no short pulses or their effects. The clock input to the D flip-flops 292 to 297 may be skewed, which could result in different output timings among the D flip-flops 292 to 297. That in turn may cause spike noise to appear on the output of the AND gate 298. The D flip-flop 299 removes the spike noise, preventing it from propagating further.

The short pulse removing section 790e is by no means limited to the configuration explained above. It may be made of members with equivalent functions. In addition, the members may be software-implemented.

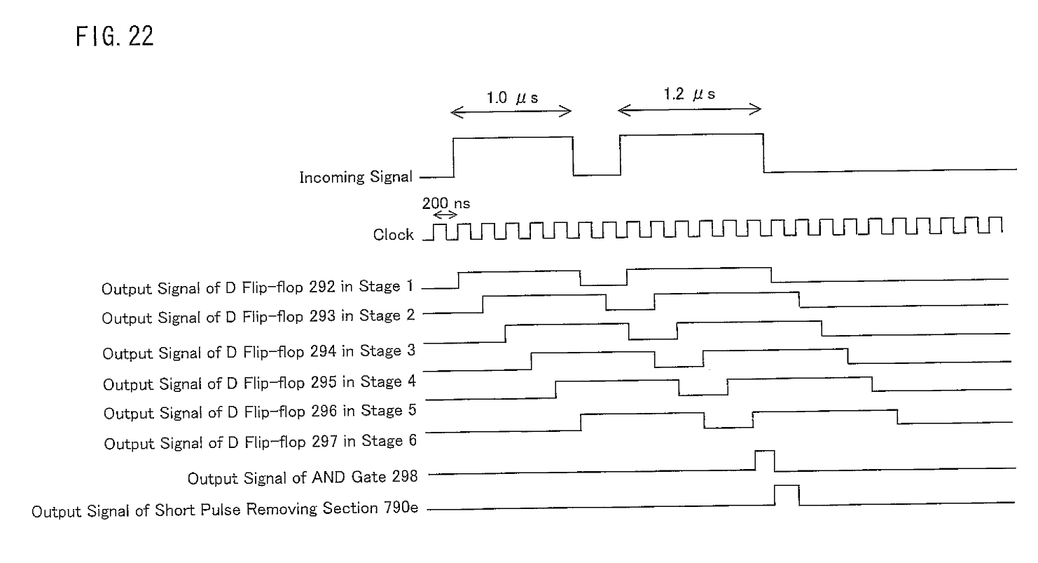

Next will be described in detail the short pulse removing section 790e removing short pulses from an incoming signal by way of examples and in reference to FIG. 22. FIG. 22 is a timing chart showing the short pulse removing section 790e removing short pulses (narrower than 1.2 μs). FIG. 22 shows an example in which the short pulse removing section 790e is receiving two incoming pulses: a pulse with a width of 1.0 μs followed by a pulse with a width of 1.2 μs.

Inputting of the 1.0-μs wide pulse will be described first. As the incoming 1.0-μs wide pulse is fed to the shift register 291, the D flip-flops 292 to 297 generate six 1.0-μs wide pulses each of which is delayed by one clock cycle from the preceding one. if the clock frequency is 5 MHz, one clock cycle (measured from one to the next) is 200 ns (nanoseconds). That means each of the six pulses is delayed by 200 ns from the preceding one. The outputs of the D flip-flops 292 to 297 are fed to the AND gate 298. The AND gate 298 outputs results of performing logical ANDs among the six pulses. If none of the clock inputs to the D flip-flops 292 to 297 are skewed, the six 1.0-μs wide pulses are fed to the AND gate 298 at 200-ns intervals. At any moment, not all the six pulses are HIGH. As a result, the AND gate 298 outputs no HIGH signal. The incoming 1.0-μs wide pulse is thus removed.

Next will be described inputting of the 1.2-μs wide pulse. As the incoming 1.2-μs wide pulse is fed to the shift register 291, the D flip-flops 292 to 297 generate six 1.2-μs wide pulses each of which, as in the previous case, is delayed by one clock cycle, or 200 ns, from the preceding one.

The outputs of the D flip-flops 292 to 297 are fed to the AND gate 298. The AND gate 298 outputs results of performing logical ANDs among the six pulses. If none of the clock inputs to the D flip-flops 292 to 297 are skewed, the six 1.2-μs wide pulses are fed to the AND gate 298 at 200-ns intervals. In this case, the six pulses can be simultaneously HIGH when the output of the AND gate 298 goes HIGH. The incoming 1.2-μs wide pulse is thus not removed and passed on to a subsequent stage.

The short pulse removing section 790c hence removes pulses with relatively short widths (narrower than 1.2 μs), allowing none of them to reach subsequent stages. In contrast, the section 790e does not remove pulses with relatively long widths (1.2 μs or wider), allowing them to reach subsequent stages.

The short pulse removing section 790e was described as including the shift register 291 with the 6-staged D flip-flops 292 to 297 and using a 5-MHz clock frequency. The configuration was intended merely to set the pulse width threshold to 1.2 μs and by no means the only possibility. One may set the pulse width threshold to any value by changing the number of D flip-flops provided in the shift register 291 and the clock frequency as necessary.

As described above, noise is removed by not detecting pulses shorter than 1.41 μs as rising edges. That in turn improves communications quality. The present embodiment thus detects pulses more accurately and distinguishes between communications protocols more reliably than embodiment 4. Therefore, the present embodiment reliably receives the response from the communications device 2 and carries out the connection routine.

### Embodiment 6

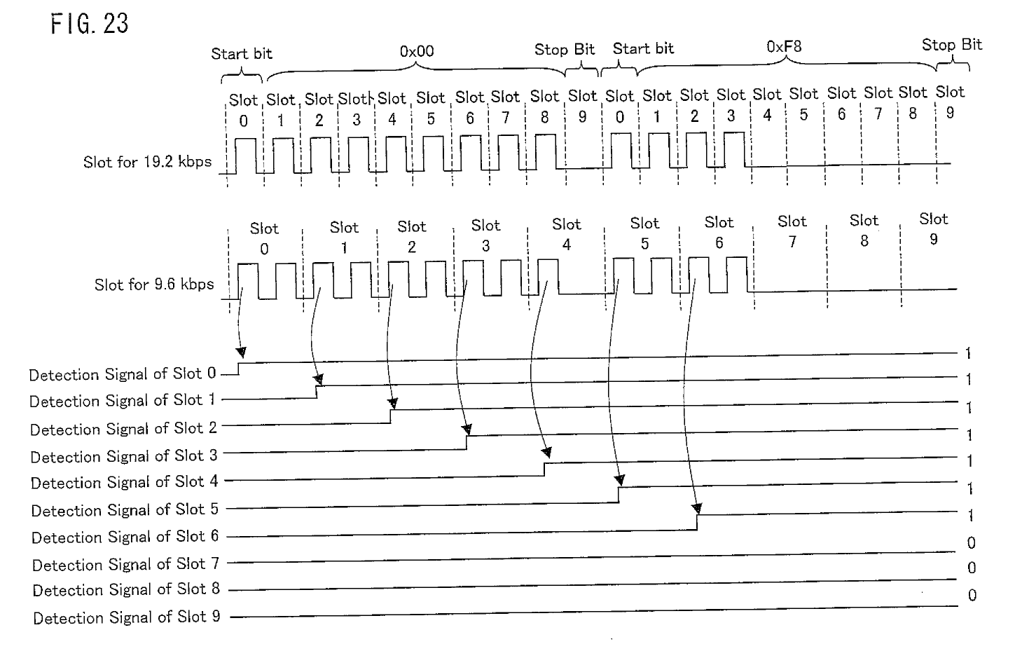

In embodiment 4, the pulse detecting section 212 and the pulse detecting section 222 detected the rising edge of an incoming pulse only once in each slot. If two or more pulses exist in a single slot, the rising edge of the first pulse is detected, but the rising edge of the second pulse is not detected. That could lead to an error in signal detection. Referring to FIG. 23, the following will describe, by way of examples, a signal detection error which could occur when two or more pulses exist in a single slot. FIG. 23 is a timing chart of an IrDA frame detecting section 202 which is receiving signals transferred at 19,200 bps although it is set to receive signals at 9,600 bps.

FIG. 23 shows an example in which the 19,200-bps signal is “0x00” followed by “0xF8.”

A start bit and a stop bit are added to each bit string, and the entire strings are inverted to obtain 111111110 and 1111000000. Each slot contains two pulses if a 19,200-bps signal is received with simple 9,600-bps slot settings. The pulse detecting section 222, however, is capable of detecting pulses using only the rising edge of each first pulse. The pulse detecting section 222 hence detects a bit string 1111111000. The bit string is converted to a UART signal and stripped of its start and stop bits to obtain 00000011, that is, 0xC0. Since 0xC0 represents a BOF, the section 222 detects a BOF by error.

To eliminate these detection errors, another embodiment will be described which has all the features of embodiment 4 and also is capable of detecting inbound frame frequencies.

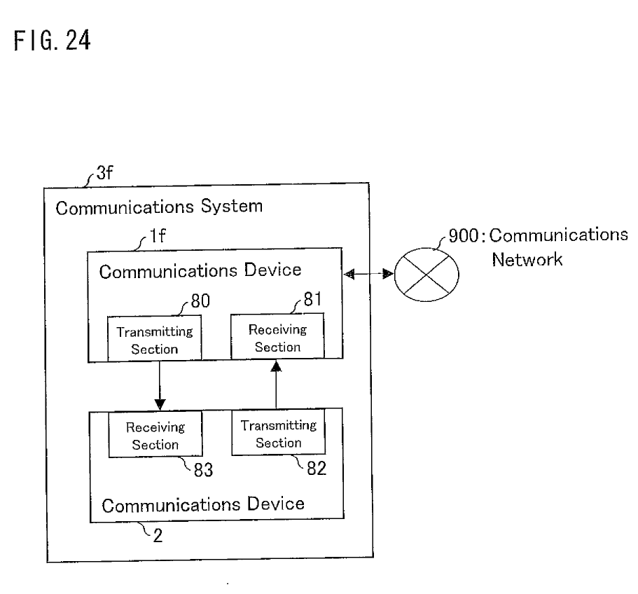

The following will describe the present embodiment in reference to FIGS. 24 to 28. For convenience, members of the present embodiment that have the same arrangement and function as members of embodiments 1 to 5, and that are mentioned in that embodiment are indicated by the same reference numerals and description thereof is omitted.

### Overall Structure of Communications System

Now, referring to FIG. 24, a communications system 3f will be described which incorporates a communications device of the present embodiment. FIG. 24 is a block diagram illustrating the configuration of the communications system 3f which incorporates a communications device 1f which is a communications device of the present embodiment and a communications device 2. Similarly to the communications device 1a, the communications device 1f may be, for example, a digital camera or a mobile phone. The device 1f is capable of communicating with the communications device 2. The communications device 1f may be capable of communicating with an external communications device (not shown) over the communications network 900.

### Configuration of Communications Device

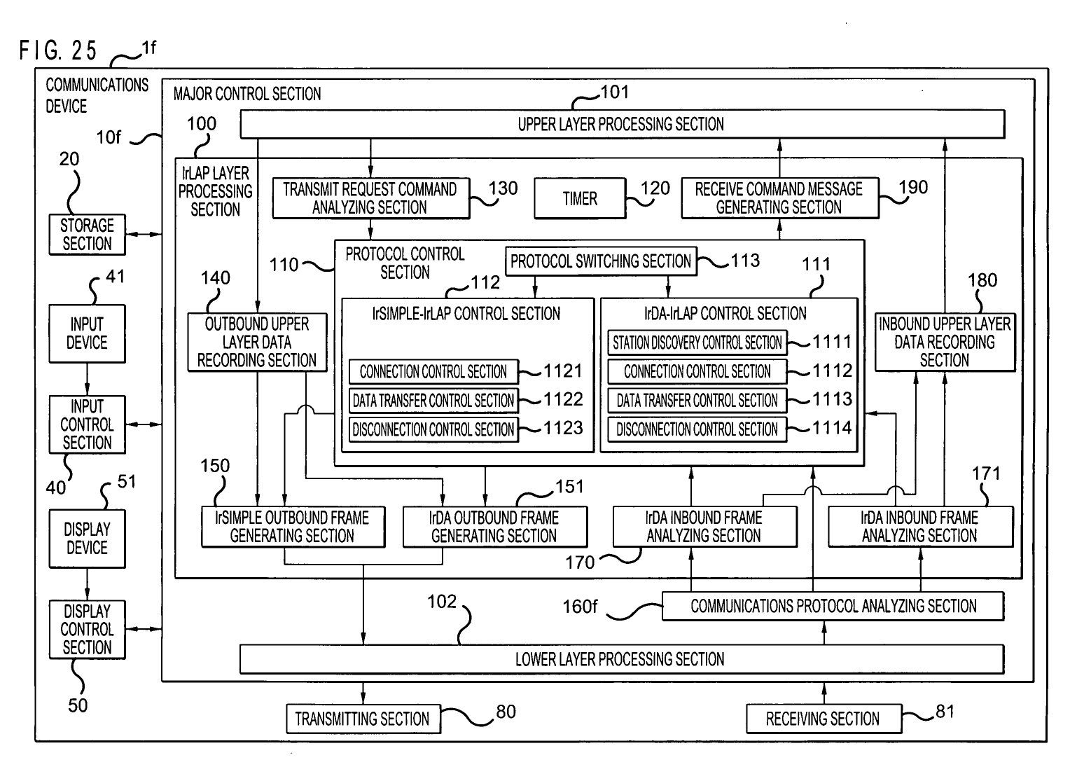

Next will be described the configuration of the communications device 1f in reference to FIG. 25 which is a block diagram illustrating the configuration of the communications device 1f. The communications device 1f includes almost the same members as the communications device 1d of embodiment 4 as shown in FIG. 25: it includes a major control section 10f in place of the major control section 10d. The major control section 10f includes almost the same members as the major control section 10d of embodiment 4: it includes a communications protocol analyzing section 160f in place of the communications protocol analyzing section 160d.

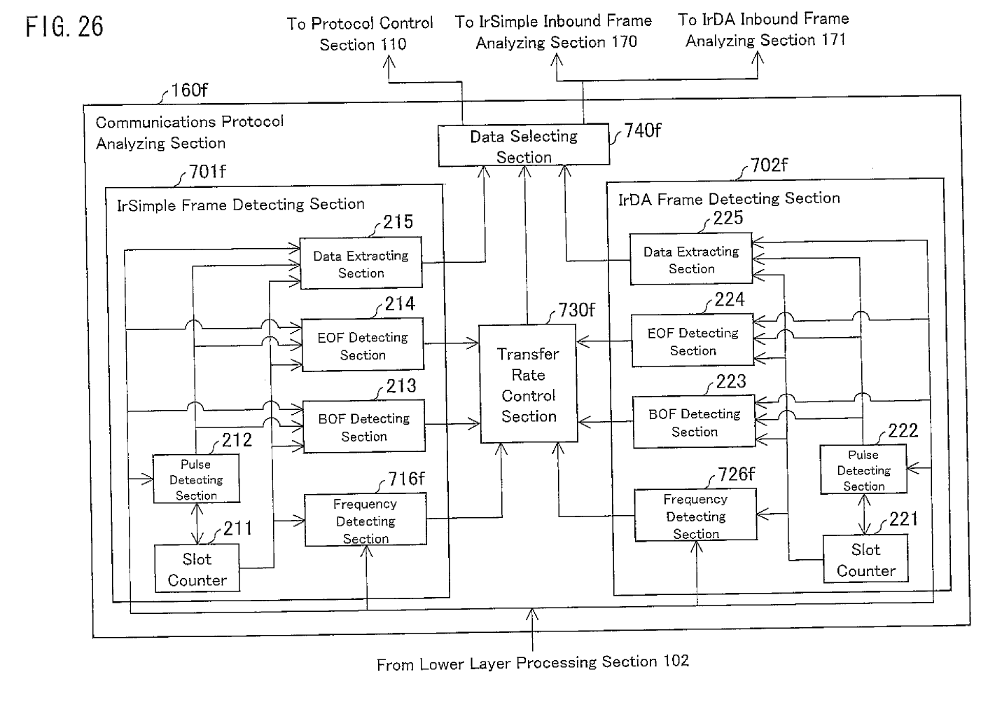

The communications protocol analyzing section 160f will be described in detail in reference to FIG. 26 which is a block diagram illustrating the configuration of the communications protocol analyzing section 160f. As shown in FIG. 26, the communications protocol analyzing section 160f includes almost the same members as the communications protocol analyzing section 160d of embodiment 4: it includes an IrSimple frame detecting section 701f, an IrDA frame detecting section 702f, a transfer rate control section (transfer rate identifying means) 730f, and a data selecting section 740f in place of the IrSimple frame detecting section 201, the IrDA frame detecting section 202, the transfer rate control section 230, and the data selecting section 240 respectively.

Still referring to FIG. 26, the IrSimple frame detecting section 701f includes almost the same members as the IrSimple frame detecting section 201 of embodiment 4; it also includes a frequency detecting section (second frequency detecting means) 716f.

The frequency detecting section 716f regards each increment of the reading of the slot counter 211 as representing a new slot. The section 716f determines whether or not the incoming signal from the lower layer processing section 102 has two or more pulses in one slot and communicates a result to the transfer rate control section 730f.

If the transfer rate control section 730f is informed by the frequency detecting section 716f that two or more pulses have been detected, it thereafter does not react to any information from the BOF detecting section 213 (or EOF detecting section 214), that is, avoids to determine that the transfer rate of the incoming frame is 115.2 kbps. On the other hand, if the transfer rate control section 730f is first informed by the BOF detecting section 213 (or EOF detecting section 214), therefore determining that the transfer rate of the incoming frame is 115.2 kbps, and subsequently informed by the frequency detecting section 716f, the section 730f determines to suspend the 115.2-kbps reception when it is informed by the frequency detecting section 716f. The suspension is communicated to the data selecting section 740f. Thereafter, the transfer rate control section 730f waits for another result of detection from the BOF detecting section 213 (or EOF detecting section 214).

Likewise, the IrDA frame detecting section 702f includes almost the same members as the IrDA frame detecting section 202 of embodiment 4; it further includes a frequency detecting section (first frequency detecting means) 726f.

Similarly to the frequency detecting section 716f, the frequency detecting section 726f regards each increment of the reading of the slot counter 221 as representing a new slot. The section 726f determines whether or not the incoming signal from the lower layer processing section 102 has two or more pulses in one slot and communicates a result to the transfer rate control section 730f.

If the transfer rate control section 730f is informed by the frequency detecting section 726f that two or more pulses have been detected, it thereafter does not react to any information from the BOF detecting section 223 (or EOF detecting section 224), that is, avoids to determine that the transfer rate of the incoming frame is 9,600 bps. On the other hand, if the transfer rate control section 730f is first informed by the BOF detecting section 223 (or EOF detecting section 224), therefore determining that the transfer rate of the incoming frame is 9,600 bps, and subsequently informed by the frequency detecting section 726f, the section 730f determines, in response to the information from the frequency detecting section 726f, to suspend the 9,600-bps reception and communicates the suspension to the data selecting section 740f. Thereafter, the transfer rate control section 730f waits for another result of detection from the BOF detecting section 223 (or EOF detecting section 224).

The data selecting section 740f, if informed by the transfer rate control section 730f of the transfer rate of 115.2 kbps, selectively outputs data from the data extracting section 215 to the IrSimple inbound frame analyzing section 170. On the other hand, if informed by the transfer rate control section 730f of the transfer rate of 9,600 bps, the data selecting section 740f selectively outputs data from the data extracting section 225 to the IrDA inbound frame analyzing section 171. In addition, if informed of the suspension by the transfer rate control section 730f, the data selecting section 740f suspends data output and informs the protocol control section 110 of the data selection. Based on the information, the protocol control section 110 controls the connection routine after the reception of the response in accordance with either IrSimple or IrDA.

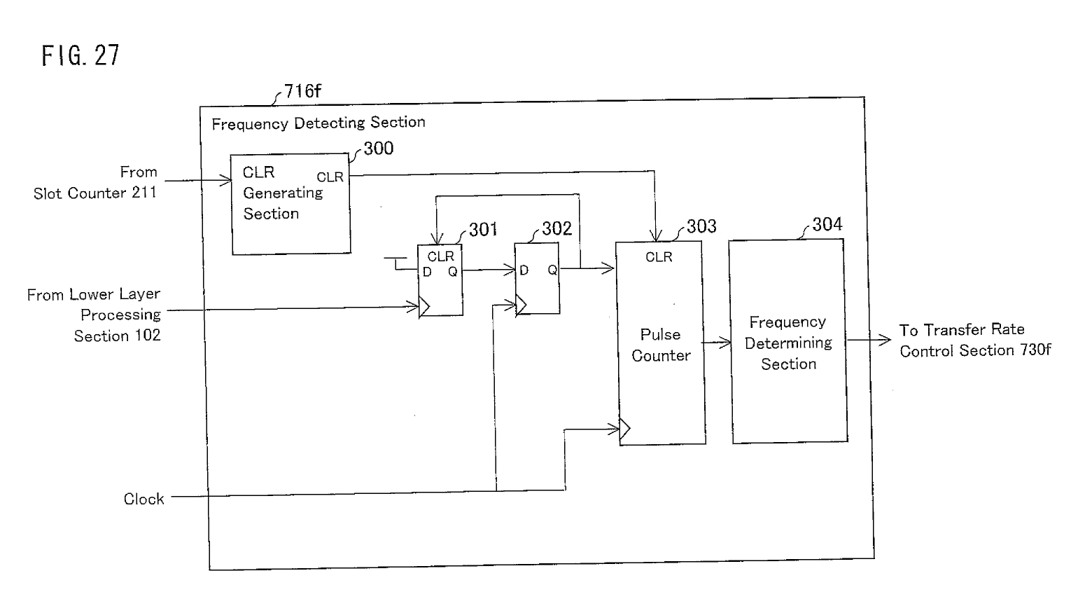

Next will be described the frequency detecting section 716f and the frequency detecting section 726f in detail in reference to FIG. 27 which is a block diagram illustrating the configuration of the frequency detecting section 716f. Description of the frequency detecting section 726f is omitted because it has the same configuration as the frequency detecting section 716f. As shown in FIG. 27, the frequency detecting section 716f includes a CLR generating section 300, a D flip-flop 301, a D flip-flop 302, a pulse counter 303, and a frequency determining section 304.

Every time the slot counter reading changes, the CLR generating section 300 generates a CLR signal from the counter reading obtained from the slot counter 211 for output to the pulse counter 303. The pulse counter 303 is reset by the CLR signal.

The D flip-flop 301 is clocked by the incoming signal from the lower layer processing section 102. When it detects a rise of the incoming signal, its output goes HIGH. The output of the succeeding D flip-flop 302 is fed to the CLR of the D flip-flop 301. As the CLR input goes HIGH, the output of the D flip-flop 301 goes LOW.

The D flip-flop 302 outputs pulses having a width equal to one clock cycle for output to the pulse counter 303.

The pulse counter 303 increments by 1 every time the input from the D flip-flop 302 goes HIGH. The reading is output to the frequency determining section 304. Upon an input from the CLR generating section 300, the counter 303 is reset.

The frequency determining section 304 determines whether or not the output of the pulse counter 303 is less than 2. If the output of the pulse counter 303 is greater than or equal to 2, it indicates that the slot contains two or more pulses. The frequency determining section 304 thus determines that the signal is being received at a higher transfer rate than expected and communicates the information to the transfer rate control section 730f.

The frequency detecting section 716f and the frequency detecting section 726f are by no means limited to the configuration explained above. They may be made of members with equivalent functions. In addition, the members may be software-implemented.

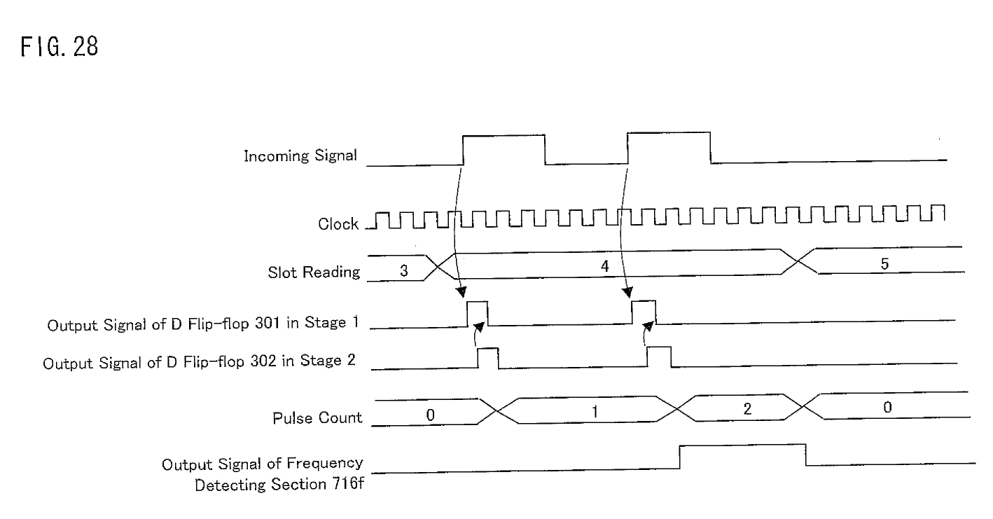

Next will be described in detail by way of examples the frequency detecting section 716f and the frequency detecting section 726f detecting that data is being received at a higher frequency than the frequency given by an expected transfer rate. See FIG. 28 which is a timing chart showing the frequency detecting section 716f and the frequency detecting section 726f detecting that data is being received at a higher frequency than the frequency given by an expected transfer rate when there are two pulses in each slot.

Suppose, as shown in FIG. 28, that two pulses are received when the reading of the slot counter 211 is 4. As the D flip-flop 301 in stage 1 detects the rising edge of the first pulse, it produces a HIGH output. That causes the D flip-flop 302 in stage 2 to produce a HIGH output on the rise of the next pulse. That HIGH output causes a CLR signal to be fed to the D flip-flop 301 in stage 1; the D flip-flop 301 in stage 1 produces a LOW output. That in turn causes the D flip-flop 302 in stage 2 to produce a LOW output on the rise of the next pulse. In this manner, the D flip-flop 302 in stage 2 outputs one clock pulse to the pulse counter 303 every time an incoming pulse is received. The same description applies when the D flip-flop 301 detects the rising edge of the second pulse.

The pulse counter 303 then increments by 1 every time the output of the D flip-flop 302 goes HIGH. The output of the D flip-flop 302 goes HIGH twice while the slot counter reading is 4. Also, no reset signal is supplied from the CLR generating section 300 to the pulse counter 303 while the reading of the slot counter 211 is 4. Therefore, the reading of the pulse counter 303 is 2 after the second pulse is received. Since the reading of the pulse counter 303 is greater than or equal to 2, the frequency determining section 304 determines that the communications device 1d is receiving data at a higher frequency than the frequency given by the expected transfer rate.

The frequency detecting section 716f and the frequency detecting section 726f detect that data is being received at a higher frequency than the frequency given by an expected transfer rate in this manner. That enables suspension of the reception at that transfer rate or other control of the reception.

As described in the foregoing, the detection of the incoming frame frequency enables the detection of the presence of two or more pulses in a single slot. That prevents reception at a wrong transfer rate. Hence, the present embodiment receives pulses more accurately and distinguishes between communications protocols more reliably than embodiment 4. The present embodiment reliably receives the response from the communications device 2 and carries out the connection routine.

### Embodiment 7

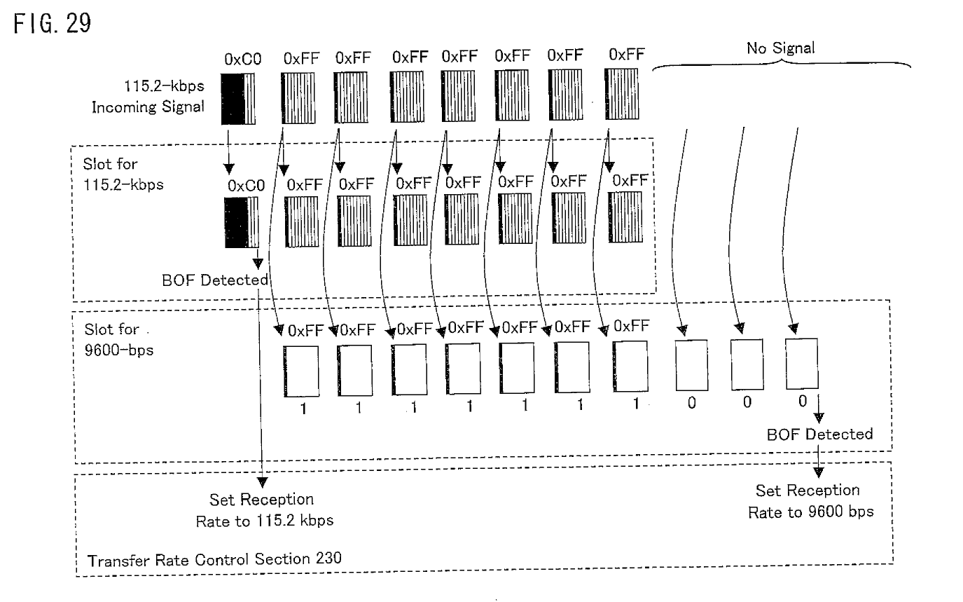

In embodiment 4, after the frame reception rate is determined, the transfer rate control section 230 could still detect a BOF at another transfer rate by error. Referring to FIG. 29, it will be described by way of examples how a BOF could be detected at another transfer rate after the transfer rate is determined. FIG. 29 illustrates the IrDA frame detecting section 202 recognizing by error a signal received at 115.2 kbps as a 9,600-bps BOF.

FIG. 29 shows an example where a 0xC0 is transmitted at 115.2 kbps which is followed by seven successive transmissions of a 0xFF and then a period of no signal. It could happen that no signals are exchanged at all for a period because the physical format for IrDA-SIR is asynchronous and there is no specification on the transfer interval between each 1-byte outbound data item.

First, the BOF detecting section 213 receives a 0xC0 using a 115.2-kbps slot to detect a BOF and communicates a result to the transfer rate control section 230. Informed by the BOF detecting section 213 of the detection of a BOF, the transfer rate control section 230 determines that the transfer rate of the incoming frame is 115.2 kbps.

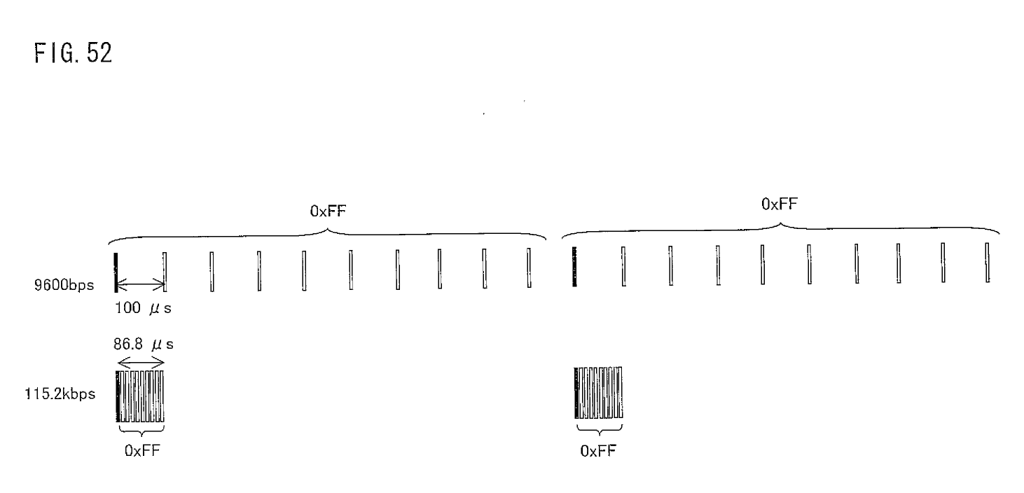

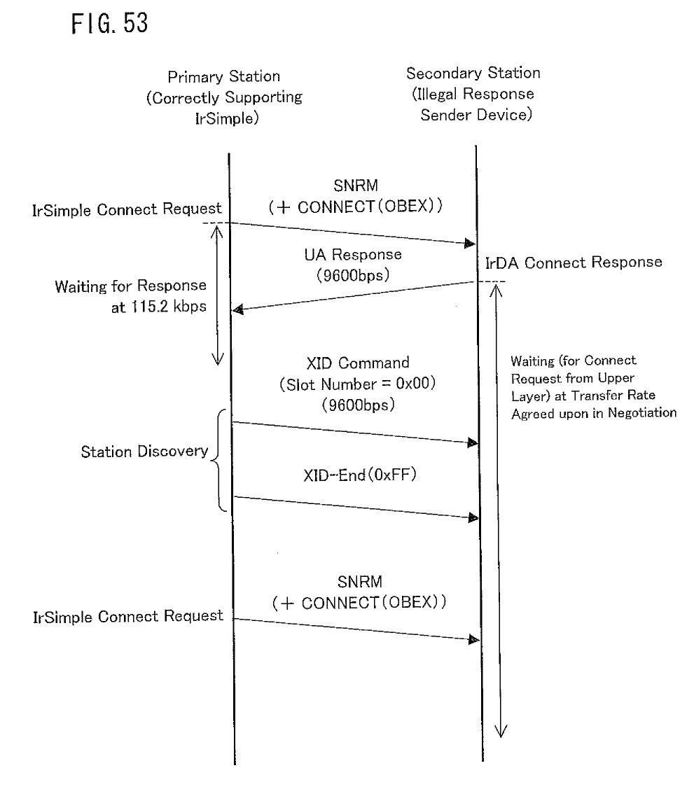

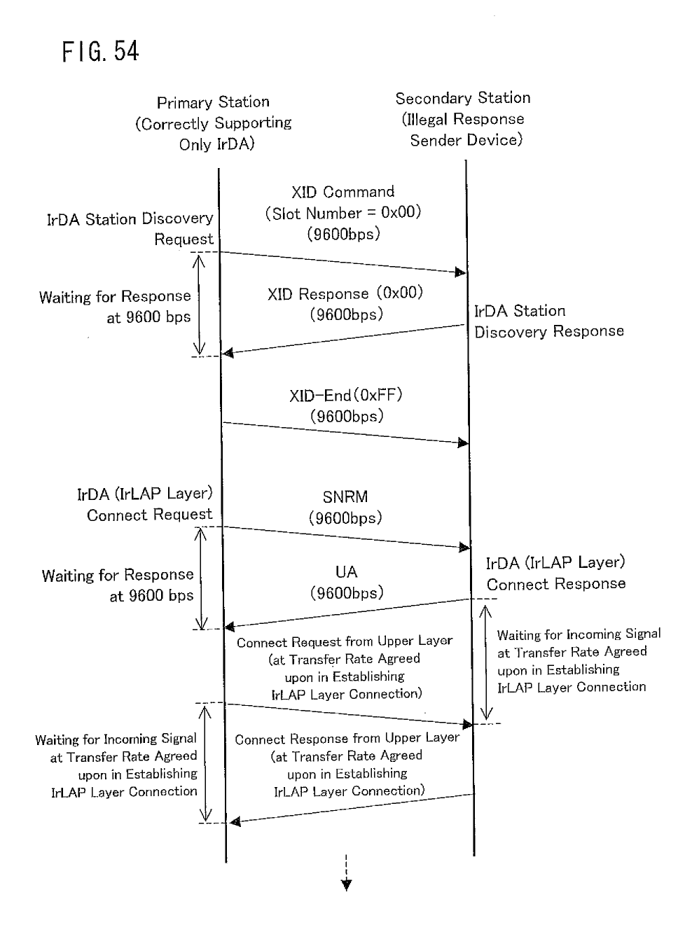

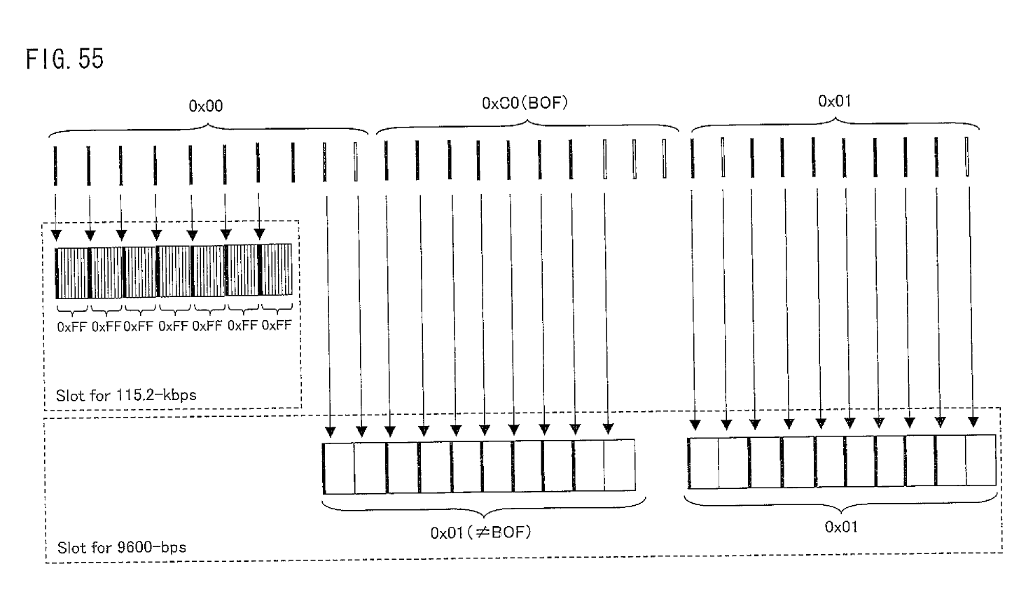

A start bit and a stop bit are added to a 0xFF, a bit string which is transmitted next, The result is inverted, and only the start bit is output as a pulse. As described earlier in the Background of the Invention section, the transfer interval for 1 bit at 9,600 bps is longer than the transfer interval for 10 bits at 115.2 kbps (see FIG. 52). Therefore, if the bit string 1000000000 transmitted at 115.2 kbps is received at 9,600 bps, the bit string is recognized as a 1.

Thus, if the BOF detecting section 223 receives, using 9,600-bps slots, seven successive 0xFFs transmitted at 115.2 kbps, which is followed by a period equivalent to three no-signal slots, the section 223 recognizes the incoming bit string as 1111111000. Since 1111111000 is the value for a BOF, the BOF detecting section 223 regards that it has detected a BOF and communicates the result to the transfer rate control section 230. Informed by the BOF detecting section 223 of the detection of a BOF, the transfer rate control section 230 determines that the transfer rate of the incoming frame is 9,600 bps.

Detecting the transfer rate as 9,600 bps by error while data is being received at 115.2 kbps as above makes it impossible to correctly receive the succeeding data which is transmitted at 115.2 kbps.

Another embodiment will be described below which, to prevent such a detection by error, allows no switching of transfer rate while the device is receiving data at a predetermined transfer rate unlike embodiment 4.

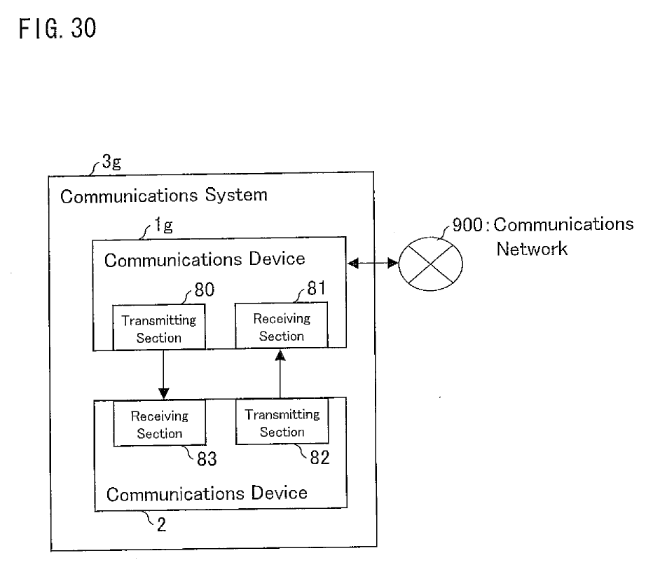

The following will describe the present embodiment in reference to FIGS. 30 to 32. For convenience, members of the present embodiment that have the same arrangement and function as members of embodiments 1 to 6, and that are mentioned in that embodiment are indicated by the same reference numerals and description thereof is omitted.

### Overall Structure of Communications System

Now, referring to FIG. 30, a communications system 3g will be described which incorporates a communications device of the present embodiment. FIG. 30 is a block diagram illustrating the configuration of the communications system 3g which incorporates a communications device 1g which is a communications device of the present embodiment and a communications device 2. Similarly to the communications device 1a, the communications device 1g may be, for example, a digital camera or a mobile phone. The device 1g is capable of communicating with the communications device 2. The communications device 1g may be capable of communicating with an external communications device (not shown) over the communications network 900.

### Configuration of Communications Device

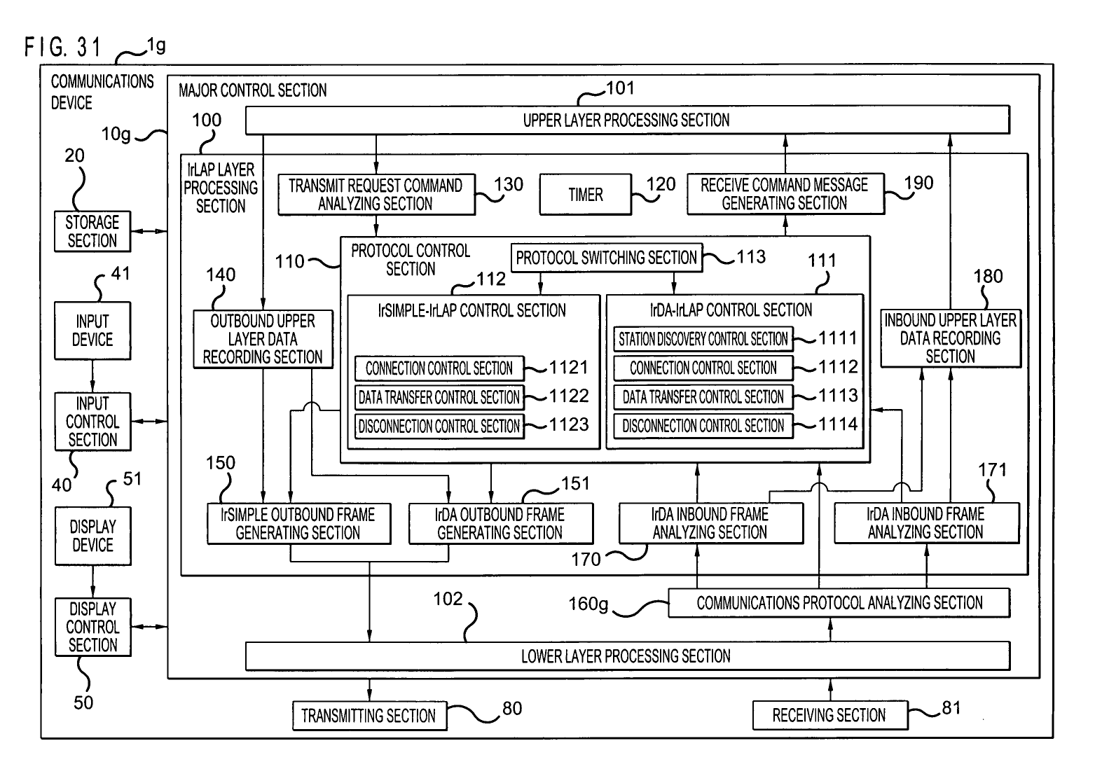

Next will be described the configuration of the communications device 1g in reference to FIG. 31 which is a block diagram illustrating the configuration of the communications device 1g. The communications device 1g includes almost the same members as the communications device 1d of embodiment 4 as shown in FIG. 31: it includes a major control section 10g in place of the major control section 10d. The major control section 10g includes almost the same members as the major control section 10d of embodiment 4: it includes a communications protocol analyzing section 160g in place of the communications protocol analyzing section 160d.

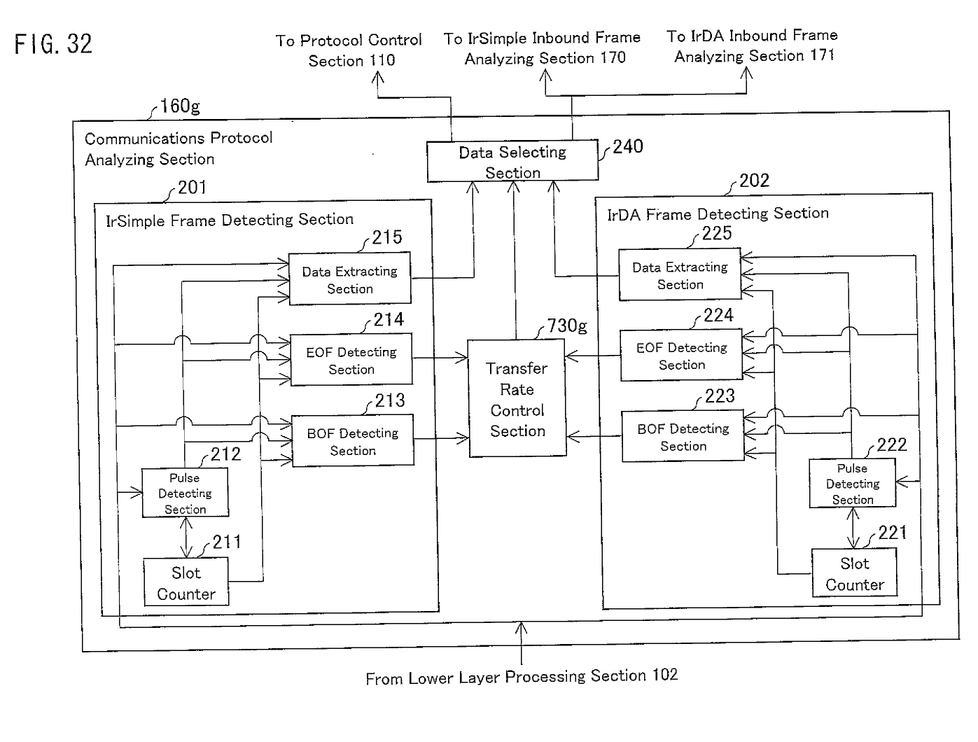

The communications protocol analyzing section 160g will be described in detail in reference to FIG. 32 which is a block diagram illustrating the configuration of the communications protocol analyzing section 160g. As shown in FIG. 32, the communications protocol analyzing section 160g includes almost the same members as the communications protocol analyzing section 160d of embodiment 4: it includes a transfer rate control section (transfer rate identifying means) 730g in place of the transfer rate control section 230.

The transfer rate control section 730g determines that the transfer rate of the incoming frame is 115.2 kbps if it is informed by the BOF detecting section 213 of the detection of a BOF and determines that the transfer rate of the incoming frame is 9,600 bps if it is informed by the BOF detecting section 223 of the detection of a BOF. The decision is communicated to the data selecting section 240. After determining that the transfer rate of the incoming frame is 115.2 kbps, the section 730g does not react to a message from the BOF detecting section 223 as to detection of a BOF, that is, avoids to determine that the transfer rate of the incoming frame is 9,600 bps until it is informed of a detection of an EOF by the EOF detecting section 214.

On the other hand, after determining that the transfer rate of the incoming frame is 9,600 bps, the section 730g does not react to a message from the BOF detecting section 213 as to detection of a BOF, that is, avoids to determine that the transfer rate of the incoming frame is 115.2 kbps until it is informed of a detection of an EOF by the EOF detecting section 224. Accordingly, the reception rate is not changed even if the BOF detecting section 223 recognizes a BOF by error while data is being received at 115.2 kbps.

There can be a case where after the transfer rate control section 730g determines that the transfer rate of the incoming frame is 115.2 kbps, the EOF detecting section 214 fails to detect an EOF and sends no message to the section 730g. In a case like this, the transfer rate control section 730g may be forcibly reset after a predetermined period elapses, so that the section 730g can again react to both a message from the BOF detecting section 213 and a message from the BOF detecting section 223. The elapsing of the predetermined period may be determined by measuring time after the reception of the BOF detection message with the timer 120.

As described in the foregoing, while data is being received at a detected transfer rate, no data is received at other transfer rates. Hence, for example, the detection of a transfer rate of 9,600 bps made by error while data is being received at 115.2 kbps does not interrupt the correct reception of succeedingly incoming data at 115.2 kbps. Hence, the present embodiment receives the response more accurately and distinguishes between communications protocols more reliably than embodiment 4. Therefore, the present embodiment reliably receives the response from the communications device 2 and carries out the connection routine.

### Embodiment 8

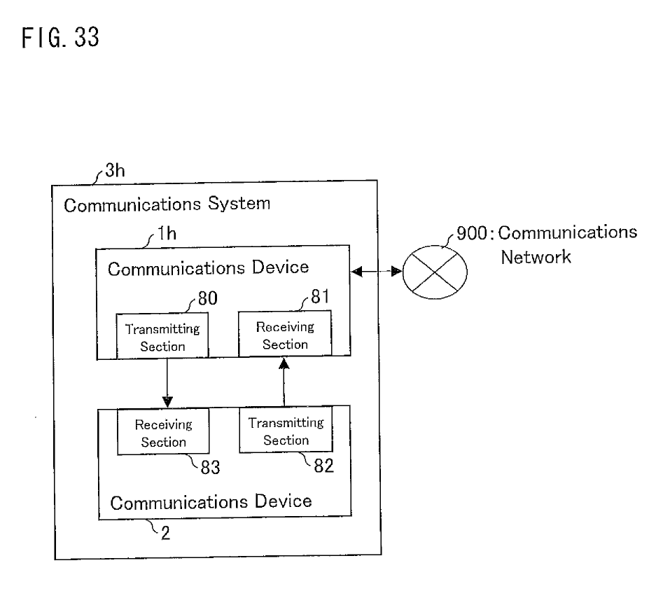

Embodiments 1 to 7 concerned communications systems which supported a plurality of communications protocols under which secondary stations could send a response at different transfer rates. In the present embodiment, a communications system will be described which supports a plurality of communications protocols under which secondary stations send a response at the same transfer rate. The present embodiment will be described below in reference to FIGS. 33 to 35. For convenience, members of the present embodiment that have the same arrangement and function as members of embodiments 1 to 7, and that are mentioned in that embodiment are indicated by the same reference numerals and description thereof is omitted.

### Overall Structure of Communications System

Now, referring to FIG. 33, a communications system 3h will be described which incorporates a communications device of the present embodiment. FIG. 33 is a block diagram illustrating the configuration of the communications system 3h which incorporates a communications device 1h which is a communications device of the present embodiment and a communications device 2. Similarly to the communications device 1a, the communications device 1h may be, for example, a digital camera or a mobile phone. The device 1h is capable of communicating with the communications device 2. The communications device 1h may be capable of communicating with an external communications device (not shown) over the communications network 900.

### Configuration of Communications Device

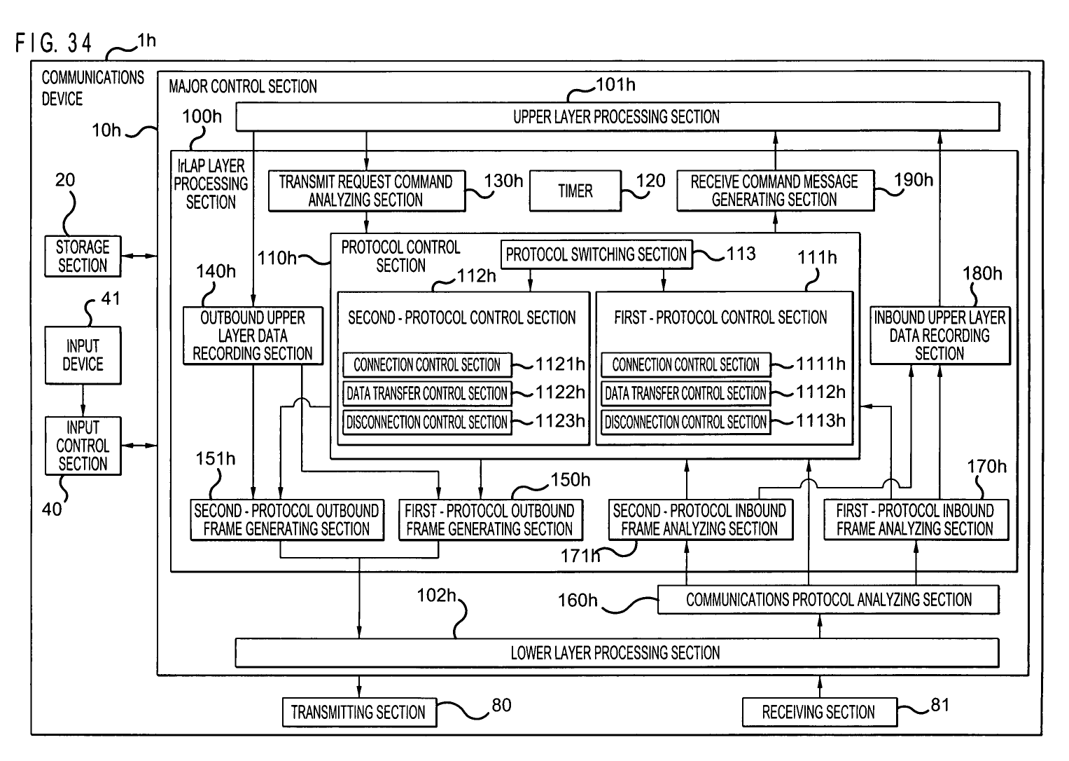

Next will be described the configuration of the communications device 1h in reference to FIG. 34 which is a block diagram illustrating the configuration of the communications device 1h. The communications device 1h includes almost the same members as the communications device 1a of embodiment 1 as shown in FIG. 34: it includes a major control section 10h in place of the major control section 10a. The major control section 10h includes an IrLAP layer processing section 100h, an upper layer processing section 100h, a lower layer processing section 102h, and a communications protocol analyzing section 160h.

The IrLAP layer processing section 100h includes a protocol control section 110h, a timer 120, a transmit request command analyzing section 130h, an outbound upper layer data recording section 140h, a first-protocol outbound frame generating section 150h, a second-protocol outbound frame generating section 151h, a first-protocol inbound frame analyzing section 170h, a second-protocol inbound frame analyzing section 171h, an inbound upper layer data recording section 180h, and a receive command message generating section 190h.

The protocol control section 110h controls the protocol for the IrLAP layer and to this end, includes a first-protocol control section 111h, a second-protocol control section 112h, and a protocol switching section 113h.

The first-protocol control section 111h performs communications using the first protocol and to this end, includes a connection control section 1111h, a data transfer control section 1112h, and a disconnection control section 1113h. The connection control section 1111h implements a connection routine using the first protocol. The data transfer control section 1112h implements a data transfer using the first protocol. The disconnection control section 1113h implements a disconnection routine using the first protocol. In the first-protocol control section 111h, the connection control section 1111h implements a connection routine to connect. To transfer data, the data transfer control section 1112h implements a data transfer. To disconnect, the disconnection control section 1113h implements a disconnection routine.

The second-protocol control section 112h performs communications using the second protocol and to this end, includes a connection control section 1121h, a data transfer control section 1122h, and a disconnection control section 1123h. The connection control section 1121h implements a connection routine using the second protocol. The data transfer control section 1122h implements a data transfer using the second protocol. The disconnection control section 1123h implements a disconnection routine using the second protocol. In the second-protocol control section 112h, the connection control section 1121h implements a connection routine to connect. To transfer data, the data transfer control section 1122h implements a data transfer. To disconnect, the disconnection control section 1123h implements a disconnection routine.

The protocol switching section 113h switches between the first-protocol control section 111h and the second-protocol control section 112h. Specifically, in an attempt to establish a connection to the communications device 2, the switching function of the protocol switching section 113h enables the IrLAP layer processing section 100h to behave as follows. The section 100h first attempts to connect using the second protocol and if the communications device 2 does not respond, attempts to connect using the first protocol. If the communications device 2 does not respond again, the section 10h attempts again to connect using the second protocol. The process is repeated.

When the protocol control section 110h is informed by the communications protocol analyzing section 160h (will be detailed later) of a reception of a first-protocol response while the second-protocol control section 112h is carrying out the connection routine, the section 110h terminates the connection routine being carried out by the second-protocol control section 112h and carries out a connection routine using the first protocol, to establish a connection using the first protocol.

Likewise, when the protocol control section 110h is informed by the communications protocol analyzing section 160h of a reception of a second-protocol response while the first-protocol control section 111h is carrying out the connection routine, the section 110h terminates the connection routine being carried out by the first-protocol control section 111h and completes the connection routine being carried out using the second protocol, to establish a connection using the second protocol.

FIG. 34 shows a configuration where two protocol control sections are included: the first-protocol control section 111h and the second-protocol control section 112h. However, if two or more sets of communications protocols are used selectively in the same layer for communications, there may be provided individual protocol control sections to handle the different sets of communications protocols.

The transmit request command analyzing section 130h analyzes a transmit request command from the upper layer. The transmit request command here is a connect request, a data transfer request, and a disconnect request. The result of the analysis is forwarded to the protocol control section 130h.

The outbound upper layer data recording section 140h records outbound data from the upper layer processing section 101h. The recorded data is supplied to the first-protocol outbound frame generating section 150h or the second-protocol outbound frame generating section 151h where it is incorporated into an outbound frame.

The first-protocol outbound frame generating section 150h generates an outbound frame which will be passed down to the lower layer in accordance with the frame format specified by the first protocol. The section 150h does so by arranging the data fed from the outbound upper layer data recording section 140h as instructed by the protocol control section 110h so that the resultant data can fit into the predetermined first-protocol frame format. An error detection code (ex. CRC) is also added to the outbound frame so that the secondary station can perform error detection. An error correction code may also added to the outbound frame.

The second-protocol outbound frame generating section 151h generates an outbound frame which will be passed down to the lower layer in accordance with the frame format specified by the second protocol. The section 151h does so by arranging the data fed from the outbound upper layer data recording section 140h as instructed by the protocol control section 110h so that the resultant data can fit into the predetermined second-protocol frame format. An error detection code (ex. CRC) is also added to the outbound frame so that the secondary station can perform error detection. An error correction code may also added to the outbound frame.

FIG. 34 shows a configuration where two outbound frame generating sections are included: the first-protocol outbound frame generating section 150h and the second-protocol outbound frame generating section 151h. However, if different sets of communications protocols are used for communications, there may be provided individual outbound frame generating sections to handle the different sets of communications protocols.

The first-protocol inbound frame analyzing section 170h analyzes an inbound frame fed from the communications protocol analyzing section 160h according to the first-protocol frame format and forwards the result of the analysis to the protocol control section 110h. The section 170h also records the upper layer data extracted from the inbound frame into the inbound upper layer data recording section 180h. The upper layer data may be recorded into the inbound upper layer data recording section 180h via the protocol control section 110h.

The second-protocol inbound frame analyzing section 171h analyzes the inbound frame fed from the communications protocol analyzing section 160h according to the second-protocol frame format and forwards the result of the analysis to the protocol control section 110h. The section 171h also records the upper layer data extracted from the inbound frame into the inbound upper layer data recording section 180h. The upper layer data may be recorded into the inbound upper layer data recording section 180h via the protocol control section 110h.

FIG. 34 shows a configuration where two inbound frame analyzing sections are included: the first-protocol inbound frame analyzing section 170h and the second-protocol inbound frame analyzing section 171h. However, if different sets of communications protocols are used for communications, there may be provided individual inbound frame analyzing sections to handle the different sets of communications protocols.

The inbound upper layer data recording section 180h records the upper layer data extracted by either the first-protocol inbound frame analyzing section 170h or the second-protocol inbound frame analyzing section 171h. The recorded data is passed on to the upper layer.

The receive command message generating section 190h generates a receive command in response to a receive command message generate request from the protocol control section 110h and passes the command to the upper layer. The receive command here is a connect request receive command, a data transfer request receive command, or a disconnect request receive command.

The upper layer processing section 101h carries out processes in the layers above the IrLAP layer based on the data from the inbound upper layer data recording section 180h and the receive command from the receive command message generating section 190h.

The lower layer processing section 102h carries out processes in the layers below the IrLAP layer based on the outbound frame from the first-protocol outbound frame generating section 150h and the second-protocol outbound frame generating section 151h.

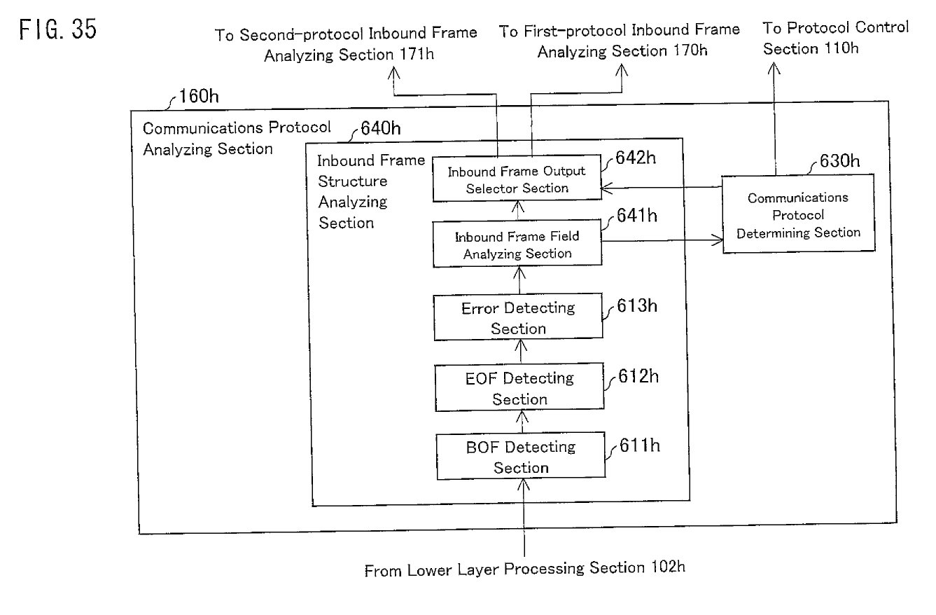

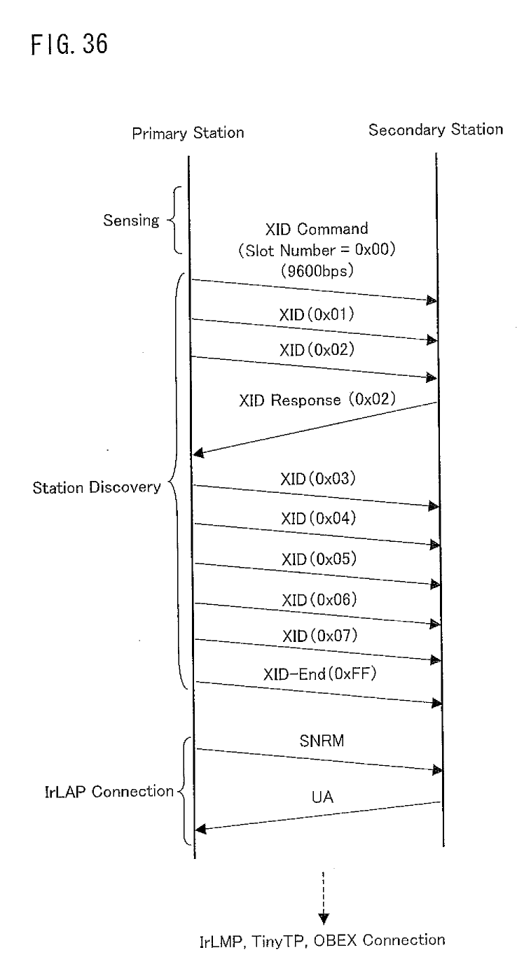

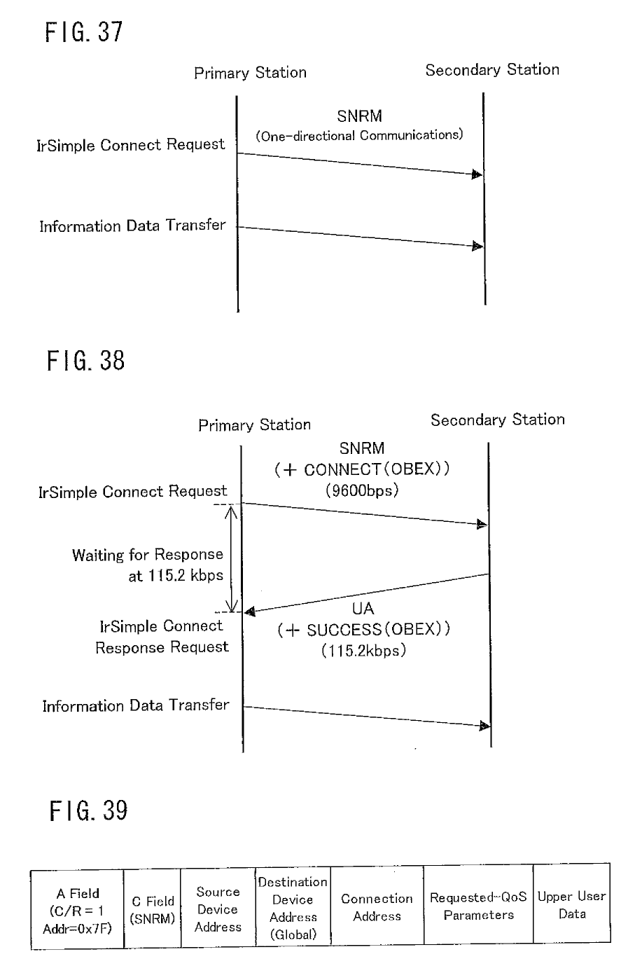

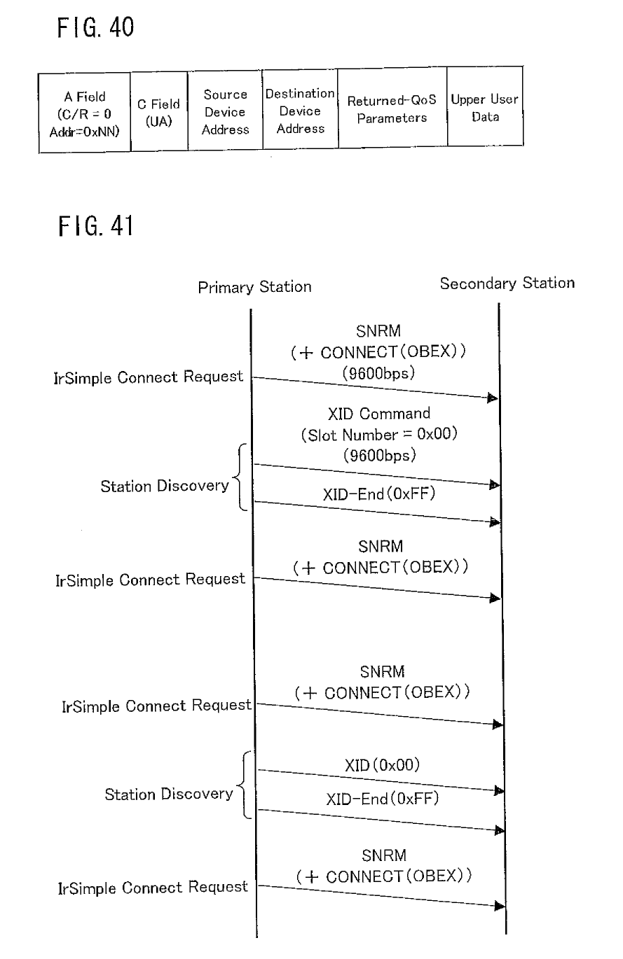

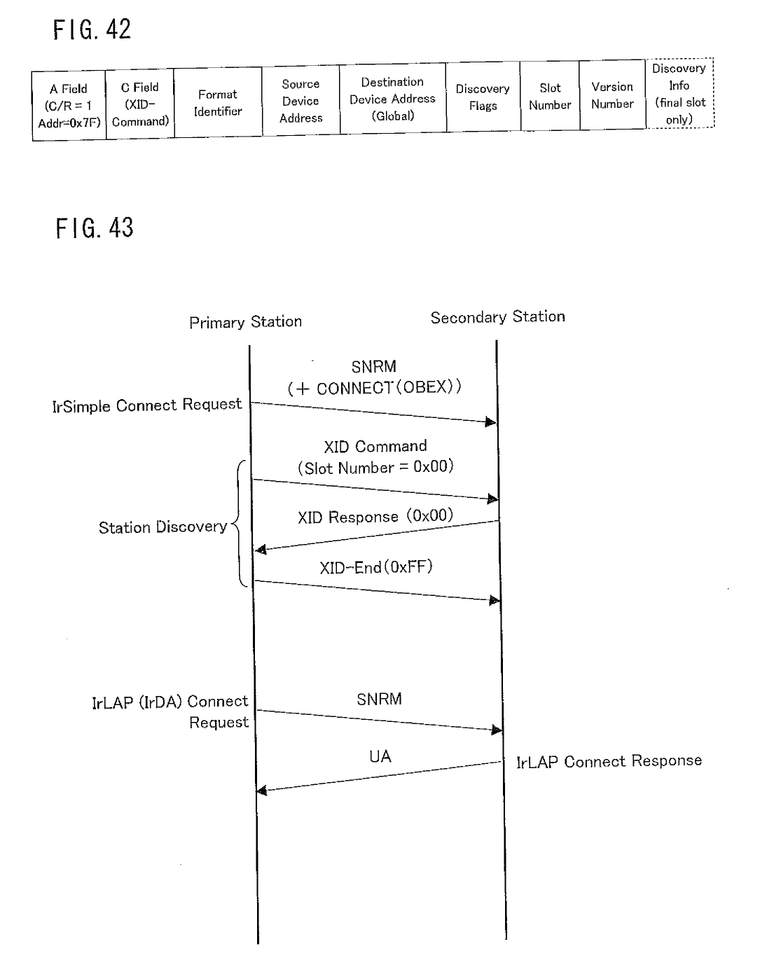

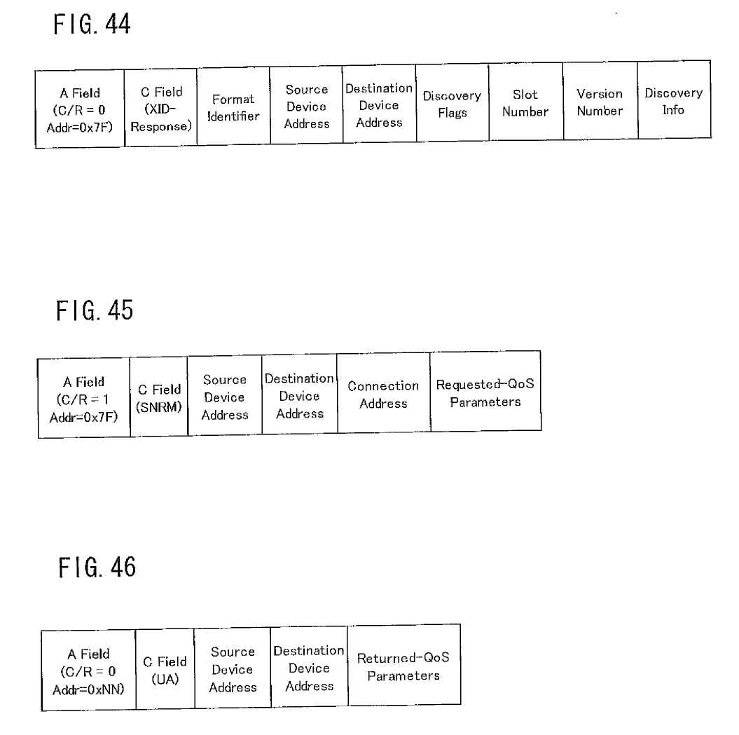

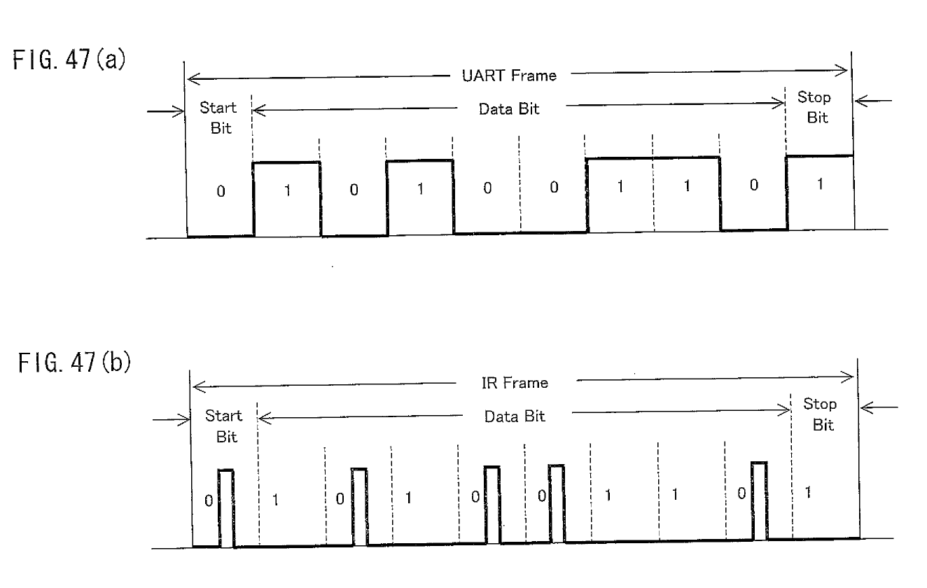

Next, the communications protocol analyzing section 160h will be described in detail in reference to FIG. 35 which is a block diagram illustrating the configuration of the communications protocol analyzing section 160h. As shown in FIG. 35, the communications protocol analyzing section 160h includes a communications protocol determining section 630h and an inbound frame structure analyzing section 640h.

After the second-protocol control section 112h transmits a connect request command, the inbound frame structure analyzing section 640h receives a response returned from the secondary station and analyzes it. The frame received by the inbound frame structure analyzing section 640h has the format shown in FIG. 49 as described earlier in the Background of the Invention section. In other words, the inbound frame includes a BOF, an IrLAP data, an FCS, and an EOF field. To handle these fields, the inbound frame structure analyzing section 640h includes a BOF detecting section 611h, an EOF detecting section 612h, an error detecting section 613h, an inbound frame field analyzing section 641h, and an inbound frame output selector section 642h.

The BOF detecting section 611h detects and removes the BOF field from the received frame. Likewise, the EOF detecting section 612h detects and removes the BOF field from the received frame. If the BOF field and the EOF field are detected, the error detecting section 613h determines from the value in the FCS field of the received frame whether or not the received data contains a transmission error. If no error is detected, the error detecting section 613h reads the IrLAP data field and outputs the data readout to the inbound frame field analyzing section 641h.

The inbound frame field analyzing section 641h analyzes the structure of the data forwarded from the error detecting section 613h and examines whether the data contains predetermined fields, and communicates the result to the communications protocol determining section 630h. The inbound frame field analyzing section 641h simply passes the received data on to the inbound frame output selector section 642h.

If the inbound frame field analyzing section 641h informs that the predetermined fields are detected, the communications protocol determining section 630h determines, based on the detection, whether the received frame is a response frame which complies with the first protocol or the second protocol. This information is forwarded to the inbound frame output selector section 642h and the protocol control section 110h.

The inbound frame output selector section 642h switches the output destination of the received data forwarded from the inbound frame field analyzing section 641h according to the information forwarded from the communications protocol determining section 630h. Specifically, if the information indicates that the response is a frame which complies with the first protocol, the section 642h outputs the received data to the first-protocol inbound frame analyzing section 170h. On the other hand, if the information indicates that the response is a frame which complies with the second protocol, the section 642h outputs the received data to the second-protocol inbound frame analyzing section 171h.

As described in the foregoing, the present embodiment reliably receives the response from the secondary station if a first and a second response, transmitted at the same transfer rate, have different frame structures.

### Variation Examples

The communications device defined in the specification and the communications device which is the secondary station may be, for example, mobile phones, PDAs, PCs, televisions, digital cameras, or printers provided that the devices are capable of infrared communications.

For example, the communications device defined in the specification is suitable for use as a mobile phone which transmits emails and images received from another mobile phone over a mobile phone network to a secondary station by infrared. The communications device in accordance with the present invention is, for example, suitable for use as an image capturing device, such as a digital camera which transmits captured images to a secondary station by infrared. The communications device in accordance with the present invention may transmit/receive content, such as text, audio, images, video, and any combination thereof. The content is by no means limited to any particular formats.

Throughout the embodiments above, the communications devices 1a, 1b, 1c, 1d, 1e, 1f, 1g, and 1h were described to operate as primary stations. The communications devices 1a, 1b, 1c, 1d, 1e, 1f, 1g, and 1h may have functionality to operate also as a secondary station.

Throughout the embodiments above, the communications devices 1a, 1b, 1c, 1d, 1e, 1f, and 1g were described to support IrDA as the first protocol and IrSimple as the second protocol. The devices may support other protocols. The communications device in accordance with the present invention is suitable for use as a communications device which supports a plurality of communications protocols with different transfer rates and as a communications device which supports a plurality of communications protocols with different response frame structures.

The embodiments explained above may be described also as follows.

[1] The communications scheme in accordance with the present invention may be adapted as follows. The scheme is compliant with a plurality of communications protocols. A first communications protocol is used if the communications device receives a response frame compliant with the second communications protocol from an opposite station after transmitting a connect, a station discovery, or a connect/station discovery request frame compliant with the first communications protocol. On the other hand, a second communications protocol is used if the communications device receives a response frame compliant with the second communications protocol from an opposite station after transmitting a connect, a station discovery, or a connect/station discovery request frame compliant with the second communications protocol. The communications device, after transmitting the request frame compliant with the second communications protocol, becomes ready to receive the response frame returned from the opposite station, no matter whether the response frame is compliant with the first communications protocol or the second communications protocol. Upon reception, the device analyzes the response frame to determine whether it is compliant with the first communications protocol or the second communications protocol.

[2] The communications scheme in accordance with the present invention may be adapted further as follows. The analysis as to whether the received response frame is compliant with the first communications protocol or the second communications protocol is done by detecting the transfer rate of the response frame returned from the opposite station if the transfer rate differs depending on whether the response frame complies with the first communications protocol or the second communications protocol.

[3] The communications scheme in accordance with the present invention may be adapted further as follows. The analysis as to whether the received response frame is compliant with the first communications protocol or the second communications protocol is done by detecting the structure of the response frame returned from the opposite station if the structure differs depending on whether the response frame complies with the first communications protocol or the second communications protocol.

[4] The communications scheme in accordance with the present invention may be adapted further as follows. If the analysis as to whether the received response frame is compliant with the first communications protocol or the second communications protocol shows that the received response frame complies with the first communications protocol, a connect or a data exchange routine is initiated in the same or upper layer using the first communications protocol. If the analysis shows that the received response frame complies with the second communications protocol, a connect or a data exchange routine is initiated in the same or upper layer using the second communications protocol.

[5] The communications scheme in accordance with the present invention may be adapted further as follows. The first communications protocol is the IrDA protocols, and the second communications protocol is the IrSimple protocols.

[6] The communications circuit in accordance with the present invention may be adapted as follows. The circuit supports a communications scheme that is compliant with a predetermined protocol. Inbound pulse detecting circuits are activated simultaneously for different transfer rates. If one of the detecting circuits detects data representing a predetermined beginning of frame using slots set up for a plurality of predetermined transfer rates, the communications circuit is tuned for the transfer rate for which that detecting circuit is enabled.

[7] The communications circuit in accordance with the present invention may be further adapted as follows. There is provided means for, if a transfer rate detecting circuit enabled for another transfer rate receives data representing a predetermined beginning of frame before the particular transfer rate detecting circuit which has detected the data representing the beginning of frame receives data representing a predetermined end of frame, communicating that to the outside

[8] The communications circuit in accordance with the present invention may be further adapted as follows. The predetermined transfer rates may be 9,600 bps and 115.2 kbps.

[9] The communications circuit in accordance with the present invention may be further adapted as follows. There is provided means for communicating to the outside the transfer rate at which the data representing the predetermined beginning of frame has been detected.

[10] The communications circuit in accordance with the present invention may be further adapted as follows. If the incoming pulse is wider than a predetermined value, the pulse is considered legal.

[11] The communications circuit in accordance with the present invention may be further adapted as follows. If two or more pulses are detected in a single slot, detection of a beginning of frame by the communications circuit, if any, is ignored.

[12] The communications circuit in accordance with the present invention may be further adapted as follows. If the transfer rate for which the communications circuit having detected the predetermined beginning of frame data is enabled is equal to the predetermined transfer rate, the communications circuit is tuned for the transfer rate and stay tuned that way until reset externally.

Finally, the major control sections 10, 10a, 10b, 10c, 10d, 10e, 10f, 10g, and 10h may be implemented by hardware or software executed by CPU as mentioned earlier. For software implementation, the communications devices 1a, 1b, 1c, 1d, 1e, 1f, 1g, and 1h include, among other components, a CPU executing instructions of control programs to implement the functions, ROM containing the programs, RAM into which the programs are loaded, and a storage device (storage medium) such as memory containing the programs and various data. The objective of the present invention can be achieved also by mounting to the communications devices 1a, 1b, 1c, 1d, 1e, 1f, 1g, and 1h a computer-readable storage medium containing control program code (executable programs, intermediate code programs, or source programs) for the communications devices 1a, 1b, 1c, 1d, 1e, 1f, 1g, and 1h, which is software realizing the aforementioned functions, in order for the computer (or CPU, MPU) in the communications devices 1a, 1b, 1c, 1d, 1e, 1f, 1g, and 1h to retrieve and execute the program code contained in the storage medium.

The storage medium may be, for example, a tape, such as a magnetic tape or a cassette tape; a magnetic disk, such as a Floppy® disk or a hard disk, or an optical disc, such as CD-ROM/MO/MD/DVD/CD-R; a card, such as an IC card (memory card) or an optical card; or a semiconductor memory, such as a mask ROM/EPROM/EEPROM/flash ROM.

The communications devices 1a, 1b, 1c, 1d, 1e, 1f, 1g, and 1h may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, a wired line, such as IEEE 1394, USB, electric power line, cable TV line, telephone line, or ADSL; or wireless, such as IrDA or other infrared, Bluetooth®, 802.11 wireless, HDR, mobile radio, satellite line, or a terrestrial digital network. The present invention encompasses a carrier wave or data signal transmission in which the program code is embodied electronically.

The communications device in accordance with the present invention includes all the features of the configuration above and may be further adapted so that the first pulse detecting means and the second pulse detecting means detect only pulses that have a pulse width greater than or equal to a predetermined value dictated by a transfer rate.

According to the configuration above, furthermore, the device does not detect pulses with a width less than the predetermined value from the incoming signal. Therefore, the device does not detect noise with short pulse widths, for example, electromagnetic waves generated when external disturbing light is received. The predetermined value here is an acceptable minimum value of the pulse width dictated by the transfer rate. For example, when the transfer rate is 9,600 bps, the acceptable minimum is 1.41 μs.

Thus, the first and second predetermined frames are detectable from pulses which do not include noise with short pulse widths. That enables more accurate detection of the first and second predetermined frames. Therefore, the transfer rate of the incoming signal can be determined more accurately.

The communications device is hence capable of reliably identifying the transfer rate of the signal transmitted from the opposite station.

The communications device in accordance with the present invention may be adapted so that: the first transfer rate detecting means includes first frequency detecting means for detecting two or more pulses in an interval by which the incoming signal is divided into a first predetermined interval; the second transfer rate detecting means includes second frequency detecting means for detecting two or more pulses in an interval by which the incoming signal is divided into a second predetermined interval; if the first frequency detecting means detects two or more pulses, and thereafter the first transfer rate detecting means detects a first predetermined frame, the transfer rate identifying means maintains the transfer rate of the incoming signal at a value determined before the first frequency detecting means detects the two or more pulses; and if the second frequency detecting means detects two or more pulses, and thereafter the second transfer rate detecting means detects a second predetermined frame, the transfer rate identifying means maintains the transfer rate of the incoming signal at a value determined before the second frequency detecting means detects the two or more pulses.

According to the configuration above, furthermore, the device detects the presence of, if any, two or more pulses in a predetermined period, that is, in a single slot, from an incoming signal. The predetermined period is dictated by the transfer rate. For example, when the transfer rate is 115.2 kbps, the period is about 8.6 μs. When the transfer rate is 9,600 bps, the period is about 100 μs. The predetermined period may be referred to as the slot length.

Two or more pulses could be found to be present in a predetermined period if while the primary station is receiving a signal using slots in accordance with a transfer rate, the primary station receives a signal at a rate higher than the transfer rate. Letting the primary station continue to receive the signal at a rate lower than the actual transfer rate may cause the primary station to detect by error a predetermined frame corresponding to the slower transfer rate.

By detecting the presence of two or more pulses in a predetermined period, the primary station recognizes that it is receiving the signal at a lower transfer rate than the actual transfer rate. Thus, the device prevents itself from receiving the signal at lower transfer rates than the actual transfer rate.

The communications device is hence capable of preventing itself from receiving incoming signals from the opposite station at lower transfer rates than the actual transfer rate of the signals.

The communications device in accordance with the present invention includes all the features of the configuration above and may be further adapted so that: if the first transfer rate detecting means detects a first predetermined frame, the transfer rate identifying means sends a first message indicating that a first incoming signal has been received; and if the second transfer rate detecting means detects a second predetermined frame, the transfer rate identifying means sends a second message indicating that a second incoming signal has been received.

According to the configuration above, furthermore, if the first predetermined frame is detected, the device sends a first message indicating that a first incoming signal has been received; if the second predetermined frame is detected, the device sends a second message indicating that a second incoming signal has been received.

By the first or second message, the communications apparatus or operator to which the message was sent can identify the transfer rate of the signal being received.

Therefore, the communications apparatus or the operator to which the message was sent can carry out data communications while monitoring connection between the primary station and the secondary station. Furthermore, the communications apparatus or the operator can verify the transfer rate at which the stations are connected to each other.

The communications device in accordance with the present invention includes all the features of the configuration above and may be further adapted so that: if the transfer rate identifying means determines that the incoming signal has a transfer rate equal to the first transfer rate, and thereafter the second transfer rate detecting means detects a second predetermined frame, the transfer rate identifying means sends a third message indicating that a second incoming signal has been received; and if the transfer rate identifying means determines that the incoming signal has a transfer rate equal to the second transfer rate, and thereafter the first transfer rate detecting means detects a first predetermined frame, the transfer rate identifying means sends a fourth message indicating that a first incoming signal has been received.

According to the configuration above, furthermore, if the transfer rate of the incoming signal is determined to be equal to the first transfer rate, and thereafter the second predetermined frame is detected, a third message is sent which indicates that a signal with the second transfer rate has been received. In addition, if the transfer rate of the incoming signal is determined to be equal to the second transfer rate, and thereafter the first predetermined frame is detected, a fourth message is sent which indicates that a signal with the first transfer rate has been received.

By the third or fourth message, the communications apparatus or the operator to which the message was sent can recognize that while the communications apparatus or the operator is receiving data from the opposite station at a currently determined transfer rate, the communications apparatus or the operator has been received a signal at another transfer rate. Therefore, for example, if a third message is sent while the device is receiving data at the first transfer rate in the first place, it recognizes that the data reception at the first transfer rate could have possibly failed halfway.

Therefore, the device can suggest to the communications apparatus or the operator that the data reception could have possibly failed halfway.

The communications device in accordance with the present invention includes all the features of the configuration above and may be further adapted so that: if the transfer rate identifying means determines that the incoming signal has a transfer rate equal to the first transfer rate, and thereafter the second transfer rate detecting means detects a second predetermined frame, the transfer rate identifying means maintains the transfer rate of the incoming signal equal to the first transfer rate; and if the transfer rate identifying means determines that the incoming signal has a transfer rate equal to the second transfer rate, and thereafter the first transfer rate detecting means detects a first predetermined frame, the transfer rate identifying means maintains the transfer rate of the incoming signal equal to the second transfer rate.

According to the configuration above, furthermore, even if the transfer rate of the incoming signal is determined to be equal to the first transfer rate, and thereafter the second predetermined frame is detected, the transfer rate of the incoming signal is not determined to be equal to the second transfer rate and maintained equal to the first transfer rate. Even if the transfer rate of the incoming signal is determined to be equal to the second transfer rate, and thereafter the first predetermined frame is detected, the transfer rate of the incoming signal is not determined to be equal to the first transfer rate and maintained equal to the second transfer rate.

Thus, even if the transfer rate of the incoming signal is determined to be equal to the first transfer rate, and thereafter the second predetermined frame is detected by error, the transfer rate of the incoming signal is not determined to be equal to the second transfer rate. In addition, even if the transfer rate of the incoming signal is determined to be equal to the second transfer rate, and thereafter the first predetermined frame is detected by error, the transfer rate of the incoming signal is not determined to be equal to the first transfer rate.

The communications device is hence capable of preventing itself from starting data communications with the opposite station at a wrong transfer rate while receiving data at a currently determined transfer rate. The device is thus capable of continue the data communications at the current determined transfer rate.

The communications device in accordance with the present invention includes all the features of the configuration above and may be further adapted so that: if the transfer rate identifying means determines that the incoming signal has a transfer rate equal to the first transfer rate, and thereafter the second transfer rate detecting means detects a second predetermined frame, the transfer rate identifying means determines, in response to an external command, that the incoming signal has a transfer rate equal to the second transfer rate; and if the transfer rate identifying means determines that the incoming signal has a transfer rate equal to the second transfer rate, and thereafter the first transfer rate detecting means detects a first predetermined frame, the transfer rate identifying means determines, in response to an external command, that the incoming signal has a transfer rate equal to the first transfer rate.

According to the configuration above, furthermore, if the transfer rate of the incoming signal is determined to be equal to the first transfer rate, and thereafter the second predetermined frame is detected, the transfer rate of the incoming signal is determined to be equal to the second transfer rate in response to an predetermined external command. In addition, if the transfer rate of the incoming signal is determined to be equal to the second transfer rate, and thereafter the first predetermined frame is detected, the transfer rate of the incoming signal is determined to be equal to the first transfer rate in response to a predetermined external command. Here, the external command is, for example, a reset signal sent after a predetermined period has elapsed

Therefore, if the transfer rate of the incoming signal is determined to be equal to the first transfer rate, and thereafter the second predetermined frame is correctly detected, the device switches to the second transfer rate in response to the predetermined external command so that it can receive the signal. In addition, if the transfer rate of the incoming signal is determined to be equal to the second transfer rate, and thereafter the first predetermined frame is correctly detected, the device switches to the first transfer rate in response to the predetermined external command so that it can receive the signal.

The communications device is hence capable of preventing itself from maintaining the data communications at the currently determined transfer rate. The device starts data communications with the opposite station at another transfer rate in response to the predetermined external command. The device reliably performs data communications with the opposite station.

The communications device in accordance with the present invention may be adapted so that it further includes: first-protocol control means for connecting using a first protocol; second-protocol control means for connecting using a second protocol; and protocol control means for if the transfer rate identifying means determines that the incoming signal has a transfer rate equal to the first transfer rate, connecting to an opposite station using the first-protocol control means, and if the transfer rate identifying means determines that the incoming signal has a transfer rate equal to the second transfer rate, connecting to an opposite station using the second-protocol control means.

According to the configuration above, if the first predetermined frame is detected, the incoming signal is determined to have been transmitted at the first transfer rate, and the opposite station is determined to be supporting the first protocol; the device carries out a connection routine using the first protocol. In contrast, if the second predetermined frame is detected, the incoming signal is determined to have been transmitted at the second transfer rate, and the opposite station is determined to be supporting the second protocol; the device carries out a connection routine using the second protocol.

Thus, when the incoming signal has different first and second transfer rates, the device reliably receives the signal from the opposite station regardless whether the signal from the opposite station corresponds to the first transfer rate or the second transfer rate.

The communications device and method are hence capable of reliably connecting to the opposite station. Especially, when the communications device is a primary station, the device and method are capable of reliably connecting to the opposite station at the first protocol with the illegal response sender device as the secondary station.

The communications device in accordance with the present invention includes all the features of the configuration above and may be further adapted so that: the communications device is a primary station which communicates with a secondary station, wherein when the incoming signal carries either a first response to a first-connection-routine command transmitted from the first-protocol control means or a second response to a second-connection-routine command transmitted from the second-protocol control means, the protocol control means connects to the secondary station using the first-protocol control means if the transfer rate identifying means determines that the incoming signal has a transfer rate equal to the first transfer rate and connects to the secondary station using the second-protocol control means if the transfer rate identifying means determines that the incoming signal has a transfer rate equal to the second transfer rate.

According to the configuration above, the primary station simultaneously waits for a response signal from the secondary station at the transfer rate for the first response and a response signal from the secondary station at the transfer rate for the second response so that the signal can be received no matter which protocol (first or second) the secondary station uses in transmitting a response. The device detects pulses from the incoming response signal at both the transfer rates to try to detect a predetermined frame from the detected pulses.

If the first predetermined frame is detected, the response is determined to have been transmitted at the transfer rate for the first response, and the secondary station is determined to be supporting the first protocol; the device carries out a connection routine using the first protocol. In contrast, if the second predetermined frame is detected, the response is determined to have been transmitted at the transfer rate for the second response, and the secondary station is determined to be supporting the second protocol; the device carries out a connection routine using the second protocol.

Even when the transfer rate for the first response differs from the transfer rate for the second response, the primary station can reliably receive the response no matter which protocol (first or second) the secondary station uses in sending the response.

Hence, the primary station is capable of receiving the response from the secondary station and reliably implementing the connection routine in any of the following cases: (a) the secondary station strictly supports the first protocol and issues a response that is compliant with the first protocol; (b) the secondary station strictly supports the second protocol and issues a response that is compliant with the second protocol; (c) the secondary station strictly supports the first and second protocols and issues a response that is compliant with the second protocol to give priority to the second protocol; (d) the secondary station returns a response that is compliant with the first protocol when it first receives the second-connection-routine command (illegal response sender device).

Therefore, the primary station reliably connects to the secondary station. Especially, the communications device reliably connects to illegal response sender devices using the first protocol.

The communications device in accordance with the present invention includes all the features of the configuration above and may be further adapted so that: the first transfer rate is 9,600 bps; and the second transfer rate is 115.2 kbps.

According to the configuration above, furthermore, the communications device is capable of receiving the incoming signal from the opposite station no matter which (9,600 bps or 115.2 kbps) the transfer rate of the incoming signal is. The device then analyzes the signal received at both the transfer rates to detect a predetermined frame.

If the first predetermined frame is detected, the device determines that the transfer rate of the incoming signal is 9,600 bps. In contrast, if the second predetermined frame is detected, the device determines that the transfer rate of the incoming signal is 115.2 kbps.

Thus, the communications device reliably receives the incoming signal at no matter which transfer rate (9,600 bps or 115.2 kbps) the signal is transmitted from the opposite station.

Therefore, the communications device is capable of reliably communicating data with the opposite station. Especially, when the communications device is a primary station, the device reliably communicates data with an illegal response sender device as the secondary station using the first protocol.

The communications device in accordance with the present invention includes all the features of the configuration above and may be further adapted so that: the first protocol is IrDA (Infrared Data Association) protocols; and the second protocol is IrSimple protocols.

According to the configuration above, furthermore, the communications device is capable of receiving a frame a suitable transfer rate regardless whether the frame is transmitted from the opposite station using the IrDA protocols or the IrSimple protocols, so that the device can connect to the opposite station no matter which, IrDA or IrSimple, the opposite station is supporting. The device then analyzes the incoming signal at a suitable transfer rate to try to detect a predetermined frame.

If the first predetermined frame is detected, the transfer rate of the incoming signal is identified as the transfer rate for an IrDA frame, the secondary station is determined to be supporting IrDA, and a connection routine is carried out using IrDA. In contrast, if the second predetermined frame is detected, the transfer rate of the incoming signal is identified as the transfer rate for an IrSimple frame, the secondary station is determined to be supporting IrSimple, and a connection routine is carried out using IrSimple.

Hence, the communications device as a primary station is capable of receiving a response from the secondary station and reliably carrying out the connection routine in, for example, any of the following case: (a) the secondary station strictly supports IrDA and issues an IrDA-compliant response; (b) the secondary station strictly supports IrSimple and issues an IrSimple-compliant response; (c) the secondary station strictly supports IrDA and IrSimple and issues an IrSimple response to give priority to IrSimple; (d) the secondary station returns an IrDA-compliant response when it first receives an IrSimple connect request command (illegal response sender device).

Therefore, the communications device reliably connects to the opposite station. Especially, the communications device as a primary station reliably connects to illegal response sender device as the secondary station using IrDA.

Furthermore, the present invention is applicable to a communications system of two communications apparatuses, one of the communications apparatuses including a communications device and using the communications device to communicate with the other communications apparatus.

Hence, the communications device as a primary station is capable of receiving a frame from the secondary station and reliably carrying out the connection routine in any of the following cases:

(a) the secondary station strictly supports the first protocol and issues a first response; (b) the secondary station strictly supports the second protocol and issues the second response; (c) the secondary station strictly supports the first and second protocols and issues a second response to give priority to the second protocol; (d) the secondary station returns a first response when it first receives a second connect request command (illegal response sender device).

Therefore, in the communications system, the primary station reliably connects to the secondary station.

The embodiments and examples described in Description of the Embodiments are for illustrative purposes only and by no means limit the scope of the present invention. Variations are not to be regarded as a departure from the spirit and scope of the invention, and all such modifications as would be obvious to one skilled in the art are intended to be included within the scope of the claims below.

What is claimed is:

1. A communications device, comprising:
first pulse detecting means for detecting a pulse in an incoming signal at a first interval which is associated with a first transfer rate;
first transfer rate detecting means for detecting a first predetermined frame based on the pulses detected by the first pulse detecting means;
second pulse detecting means for detecting a pulse in the incoming signal at a second interval which is associated with a second transfer rate that is different from the first transfer rate;
second transfer rate detecting means for detecting a second predetermined frame based on the pulses detected by the second pulse detecting means; and
transfer rate identifying means for determining that the incoming signal has a transfer rate equal to the first transfer rate if the first transfer rate detecting means detects a first predetermined frame and that the incoming signal has a transfer rate equal to the second transfer rate if the second transfer rate detecting means detects a second predetermined frame.

2. The communications device of claim 1, wherein the first pulse detecting means and the second pulse detecting means detect only pulses that have a pulse width greater than or equal to a predetermined value dictated by a transfer rate.

3. The communications device of claim 1, wherein:
the first transfer rate detecting means includes first frequency detecting means for detecting two or more pulses in an interval by which the incoming signal is divided into a first predetermined interval;
the second transfer rate detecting means includes second frequency detecting means for detecting two or more pulses in an interval by which the incoming signal is divided into a second predetermined interval;
if the first frequency detecting means detects two or more pulses, and thereafter the first transfer rate detecting means detects a first predetermined frame, the transfer rate identifying means maintains the transfer rate of the incoming signal at a value determined before the first frequency detecting means detects the two or more pulses; and
if the second frequency detecting means detects two or more pulses, and thereafter the second transfer rate detecting means detects a second predetermined frame, the transfer rate identifying means maintains the transfer rate of the incoming signal at a value determined before the second frequency detecting means detects the two or more pulses.

4. The communications device of claim 1, wherein:
if the first transfer rate detecting means detects a first predetermined frame, the transfer rate identifying means sends a first message indicating that a first incoming signal has been received; and
if the second transfer rate detecting means detects a second predetermined frame, the transfer rate identifying means sends a second message indicating that a second incoming signal has been received.

5. The communications device of claim 1, wherein:
if the transfer rate identifying means determines that the incoming signal has a transfer rate equal to the first transfer rate, and thereafter the second transfer rate detecting means detects a second predetermined frame, the transfer rate identifying means sends a third message indicating that a second incoming signal has been received; and
if the transfer rate identifying means determines that the incoming signal has a transfer rate equal to the second transfer rate, and thereafter the first transfer rate detecting means detects a first predetermined frame, the transfer rate identifying means sends a fourth message indicating that a first incoming signal has been received.

6. The communications device of claim 1, wherein:
if the transfer rate identifying means determines that the incoming signal has a transfer rate equal to the first transfer rate, and thereafter the second transfer rate detecting means detects a second predetermined frame, the transfer rate identifying means maintains the transfer rate of the incoming signal equal to the first transfer rate; and
if the transfer rate identifying means determines that the incoming signal has a transfer rate equal to the second transfer rate, and thereafter the first transfer rate detecting means detects a first predetermined frame, the transfer rate identifying means maintains the transfer rate of the incoming signal equal to the second transfer rate.

7. The communications device of claim 1, wherein:
if the transfer rate identifying means determines that the incoming signal has a transfer rate equal to the first transfer rate, and thereafter the second transfer rate detecting means detects a second predetermined frame, the transfer rate identifying means determines, in response to an external command, that the incoming signal has a transfer rate equal to the second transfer rate; and
if the transfer rate identifying means determines that the incoming signal has a transfer rate equal to the second transfer rate, and thereafter the first transfer rate detecting means detects a first predetermined frame, the transfer rate identifying means determines, in response to an external command, that the incoming signal has a transfer rate equal to the first transfer rate.

8. The communications device of claim 1, further comprising:
first-protocol control means for connecting using a first protocol;
second-protocol control means for connecting using a second protocol; and
protocol control means for if the transfer rate identifying means determines that the incoming signal has a transfer rate equal to the first transfer rate, connecting to an opposite station using the first-protocol control means, and if the transfer rate identifying means determines that the incoming signal has a transfer rate equal to the second transfer rate, connecting to an opposite station using the second-protocol control means.

9. The communications device of claim 8, said communications device being a primary station which communicates with a secondary station, wherein when the incoming signal carries either a first response to a first-connection-routine command transmitted from the first-protocol control means or a second response to a second-connection-routine command transmitted from the second-protocol control means, the protocol control means connects to the secondary station using the first-protocol control means if the transfer rate identifying means determines that the incoming signal has a transfer rate equal to the first transfer rate and connects to the secondary station using the second-protocol control means if the transfer rate identifying means determines that the incoming signal has a transfer rate equal to the second transfer rate.

10. The communications device of claim 1, wherein:
the first transfer rate is 9,600 bps; and
the second transfer rate is 115.2 kbps.

11. The communications device of claim 8, wherein:
the first protocol is IrDA (Infrared Data Association) protocols; and
the second protocol is IrSimple protocols.

12. A communications method, comprising:
the first pulse detecting step of detecting a pulse in an incoming signal at a first interval which is associated with a first transfer rate;
the first transfer rate detecting step of detecting a first predetermined frame based on the pulses detected in the first pulse detecting step;
the second pulse detecting step of detecting a pulse in the incoming signal at a second interval which is associated with a second transfer rate that is different from the first transfer rate;
the second transfer rate detecting step of detecting a second predetermined frame based on the pulses detected in the second pulse detecting step; and
the transfer rate identifying step of determining that the incoming signal has a transfer rate equal to the first transfer rate if the first transfer rate detecting step detects a first predetermined frame and that the incoming signal has a transfer rate equal to the second transfer rate if the second transfer rate detecting step detects a second predetermined frame.

13. A communications circuit for operating a communications device,
said communications device including: first pulse detecting means for detecting a pulse in an incoming signal at a first interval which is associated with a first transfer rate; first transfer rate detecting means for detecting a first predetermined frame based on the pulses detected by the first pulse detecting means; second pulse detecting means for detecting a pulse in the incoming signal at a second interval which is associated with a second transfer rate that is different from the first transfer rate; second transfer rate detecting means for detecting a second predetermined frame based on the pulses detected by the second pulse detecting means; and transfer rate identifying means for determining that the incoming signal has a transfer rate equal to the first transfer rate if the first transfer rate detecting means detects a first predetermined frame and that the incoming signal has a transfer rate equal to the second transfer rate if the second transfer rate detecting means detects a second predetermined frame,
said circuit functioning as each of said means.
